(19) United States
(12) Patent Application Publication
(10) Pub. No.: US 2023/0368283 A1
(43) Pub. Date: Nov. 16, 2023

(54) METHOD AND SYSTEM FOR ONLINE AUCTIONS

(71) Applicant: Kevin Sunlin Wang, Flushing, NY (US)

(72) Inventor: Kevin Sunlin Wang, Flushing, NY (US)

(21) Appl. No.: 18/227,240

(22) Filed: Jul. 27, 2023

Related U.S. Application Data
(62) Division of application No. 16/186,460, filed on Nov. 9, 2018, now abandoned.
Application No. 16/186,460 is a continuation-in-part of application No. 15/717,594, filed on Sep. 27, 2017.
Application No. 15/717,594 is a continuation-in-part of application No. 14/967,301, filed on Dec. 12, 2015.
(60) Provisional application No. 62/403,546, filed on Oct. 3, 2016.
(60) Provisional application No. 62/246,987, filed on Oct. 27, 2015.
(60) Provisional application No. 62/584,061, filed on Nov. 9, 2017.
(60) Provisional application No. 62/623,945, filed on Jan. 30, 2018.

(30) Foreign Application Priority Data
Sep. 27, 2018 (WO) PCT/US18/53245

(51) Int. Cl. G06Q 30/08; G06Q 20/12; G06Q 20/10; G06Q 20/40

(52) U.S. Cl. CPC G06Q 30/08; G06Q 20/12; G06Q 20/102; G06Q 20/405

(57) ABSTRACT

Disclosed is system and method for sealed bid online auctions according to a set of predetermined rules. The system designates a winning bid rank for the winning bid and a designated bid rank for a designated bid relative to the winning bid. A commitment may be associated with a bid, and may be associated with consideration which is allocated to one or more auction participants or one or more non-auction participants. A payment amount associated with the amount of the winning bid is calculated in accordance with one or more sets of predetermined rules. Calculation of the payment amount may be based on at least one of the fee or an adjustment based the amount of the winning bid and the amount of the designated bid. The fee may be paid by one or more auction or non-auction participants.

### CROSS-REFERENCE TO RELATED APPLICATIONS

The present application is a divisional of U.S. patent application Ser. No. 16/186,460, filed on Nov. 9, 2018 and titled METHOD AND SYSTEM FOR ONLINE AUCTIONS, which claims priority to U.S. patent application Ser. No. 15/717,594, filed on Sep. 27, 2017 and titled SYSTEM AND METHOD FOR REVERSE SEALED BID AUCTIONS, which claims priority to U.S. Provisional Patent Application No. 62/403,546, filed on Oct. 3, 2016 and titled SYSTEM AND METHOD OF SEALED-BID AUCTION, and is a continuation-in-part of U.S. Non-Provisional patent application Ser. No. 14/967,301, filed on Dec. 12, 2015 and titled METHOD AND SYSTEM FOR SEALED BID AUCTIONS, which claims priority to U.S. Provisional Patent Application No. 62/246,987, filed on Oct. 27, 2015 and titled METHOD AND SYSTEM FOR SEALED BID AUCTIONS, which preceding applications are hereby incorporated by reference herein in their entireties.

Priority application Ser. No. 16/186,460 is also a continuation-in-part of and claims priority to international application number PCT/US18/53245, filed Sep. 27, 2018 and titled METHOD AND SYSTEM FOR ONLINE AUCTIONS, and claims priority to U.S. Provisional Patent Application No. 62/584,061, filed on Nov. 9, 2017 and titled METHOD AND SYSTEM FOR SEALED BID AUCTIONS, as well as U.S. Provisional Patent Application No. 62/623,945, filed on Jan. 30, 2018 and titled METHOD AND SYSTEM FOR SEALED BID AUCTIONS, which preceding applications are all hereby incorporated by reference herein in their entireties.

### FIELD OF THE INVENTION

The present disclosure relates to methods and systems for sealed bid online auctions, sealed bid online reverse auctions, and combinations of on-line sealed bid auctions and offline open bid auctions. More particularly, the present invention relates to various improved systems and methods for preventing a variety of indecent or illegal bidding activities in such auctions, and balancing the needs of sellers, buyers, and service providers using various winning bid amount recalculation methods and price-protection fees associated therewith.

### BACKGROUND

In traditional sealed bid auctions, the bidders are not privy to the values of any bids until the auction closes, which helps avoid various problems associated with open auctions, most notably, indecent bidding activities. Unlike open auctions (i.e., where two or three bidders may be sufficient to keep raising or lowering the price of an auctioned subject as they try to overbid or underbid one another), in sealed bid auctions, the bidders are unaware of what all other bidders are bidding. Therefore, the bidders will strategically submit bids they feel would be an appropriate amount for buying or providing the desired goods/services without the benefit of knowing what any of the other bidders are bidding for buying or selling the same goods/services.

As a result of technological developments, auctioneers today are capable of offering both live (e.g., in-person) and online auctions to meet the distinct needs of customers both near and far. Today, technology allows bidders to participate in one or more auctions, sometimes simultaneously, without the need to be physically present at the auction(s). Online auctions are popular as the internet provides a user-friendly, convenient platform for the exchange of properties of value between interested parties. Online auctions can be conducted through mobile applications and websites, which are accessible to anyone with an internet connection at any location.

Open and sealed bid auctions are both practiced in the art. In open auctions, bids are broadcast to participants. Open auctions may be of ascending-bid (English) or descending-bid (Dutch) model. In an ascending-bid auction model, properties of value are offered up for bidding, and the winner is the last bidder that offers the highest price after a certain amount of time. The descending-bid auction is an auction model where the property of value begins at a higher asking price, which is lowered by the auctioneer until the bidder accepts. One of the major advantages of open auctions is that the bidders see each other's bids, which makes the auction transparent to all participants. However, there are many negative impacts associated with transparency in open auctions.

While popular and successful, online auctions are not without shortfalls and deficiencies. For example, fairness is a major issue in all auctions. Deficiencies that accompany online open auctions may include, but are not limited to, “bid shielding,” “bid shading,” “shill bidding,” “bid sniping,” “collusion,” etc., in which indecent bidders may be involved. Such deficiencies may occur because bid amounts are open and can be easily manipulated by indecent bidders who abuse auction procedures and/or collude with one another to engage in the above indecent or illegal activities.

“Bid shielding” occurs when a high value bid is withdrawn at the last minute of the auction to allow a lower bid to be accepted. “Bid shilling” introduces an artificially high bid in order to increase the price to force the bona fide bidders to pay more for the good(s) or service(s) they want to buy. “Bid shading” occurs when a bidder knowingly places a bid that is below or above what he/she believes the auctioned property is actually worth to mislead other bidders on the actual price of the item. “Bid sniping” is last minute bidding with the intent of preventing other bidders from responding and outbidding the price. Software is available to aid in the practice, and in particular, software which can assist multiple bidders at the same time. “Bid sniping” applies mainly on sites having a fixed bid close time. “Collusion” not only occurs when there is illegal or unauthorized cooperation between buyers who agree to not bid against each other, allowing the price to stay low, but also among vendors who bid on each other's items to deceptively increase prices the winning buyer will pay. “Collusion” may also lead to “bid shielding,” “shill bidding,” “bid shading,” etc., which occurs frequently in online auctions.

In order to win an open bid ascending online auction with all of these inherent deficiencies, bona fide bidders often have to closely monitor the auction to make sure they will not be outbid, especially in the last seconds of the auction. The entire auction procedure becomes very time consuming and psychologically stressful if the bona fide bidder is the subject of “bid sniping.” Bidders often find themselves frustrated over the time and effort they put into the auction only to fail because of “bid sniping” or some other type of indecent bidding.

Shill bidding is a particular problem in Internet auctions as most existing fraud detection techniques cannot guarantee real-time detection. Indecent bidders are hard to detect on the Internet because it is very difficult to identify the difference between indecent and bona fide bidders, especially due to the use of “fake IDs”, which is an internet centric problem due to the ease with which such fake IDs are used. Additionally, as existing online auctions typically have a fixed bidding close time, “bid sniping” occurs frequently within any open bid online auction where a bidder can legally bid anytime between the first second through the last second of the auction. It is very hard to identify who is a bona fide bidder and who is an indecent bidder if the “bid sniping” occurs in the last second of the auction. Many open auction online websites claim to have measures to detect and remove indecent bidders. Although there are measures in place to attempt to prevent fraudulent or unfair activities in online auctions, current systems and methods are ineffective. For example, relying on users to report suspicious bidding activity is generally too slow and involves too many variables to create favorable results for bona fide bidders. User-reporting also involves investigations which may take more time than can be accorded bidders as an auction may end before various issues (which often require consideration of numerous variables in determining whether a user is abusing the system) are resolved. Additionally, bona fide bidders may not have enough evidence to show that another user is cheating. Even with laws that impose fines or jail time for illegal or fraudulent bidding, the anonymity provided by the internet and the cover it provides for indecent bidders to use fake IDs allows for a massive amount of fraudulent activity. In sealed bid auctions, bidders place their bids in the first phase of the auction, but their bid values remain closed and invisible to other bidders until they are opened in a second phase. Even in the second phase, the values of bids may remained sealed and the winning bid amount may be revealed.

Sealed bid auctions may vary in terms of the particular bid which is declared the winner. For example, sealed bid first-price and sealed bid second-price auction methods are known in the art. The traditional form of sealed bid auctions is a first-price auction in which the highest bid wins the auction. In such auctions, bidders who are buyers may face several problems. For example, “winner's curse” is a common issue not only in open bid first-price auctions, but also in sealed bid auctions. “Winner's curse” often occurs when the winning bid amount in an auction exceeds the intrinsic value of the auctioned subject. It is especially true for buyers and/or winners who have limited knowledge of the auctioned subject, and who may overpay due to this lack of knowledge and/or experience, causing them to do an improper market valuation of the auctioned subject. In order to overcome this deficiency (“winner's curse”), a second form of sealed bid auction known as the sealed second-price auction (Vickrey) has been used. In a sealed bid second-price auction (Vickrey), the winning bidder (e.g., the bidder who bids the highest) does not pay his/her highest winning bid price. Instead, the winning bidder pays the second-highest price (e.g., the amount of the second highest bid) for the auctioned subject. This means the bidder who places the highest bid for the property will win the auction, but will only be required to pay an amount equal to the second-highest bid placed for an item, which is naturally lower than the highest winning bid and may potentially reflect or be closer to the real value of the auctioned property. This type of auction may be attractive to bidders because it may reduce “winner's curse” since some bidders may place their bids with less concern that they will overpay for the property.

However, a sealed bid second-price auction has inherent deficiencies as bidders may artificially increase their bids without consideration of the real value of the auctioned item. Since the winning bidder only pays a second-highest bid amount, indecent bidders often use this tactic to win the auction. This may discourage bona fide bidders who would like to bid the real perceived value of the property from participating in the auction, because it is very hard for bona fide bidders who bid realistic amounts to win against indecent bidders who artificially inflate the price they bid. Another shortfall of this method is remorse of the second-highest bidder, who does not win the auction, but whose price is used as a real value of the item (to the benefit of the winning bidder) without any sort of reward for the second-highest bidder.

The sealed bid second-price method thus has an inherent logical flaw, as the winner does not actually pay the price that the winner bid. Instead, the winner pays the price bid by another bidder (the second-highest bid amount), and the bidder with the second-highest bid amount gets nothing. This method is unfair to bona fide bidders who submit reasonable bid amounts because another indecent bidder may submit a bid with an artificially high amount in order to win the auction. Furthermore, a bidder who submits the second-highest bid amount may come to believe he is merely a tool for providing reasonable prices without receiving anything in return. For example, suppose a particular type of stamp is a collectible which often appears in online auction platforms. If there are four total bidders, three of the bidders may be bona fide stamp collectors who submit realistic bid amounts that reflect market values of $25, $30, and $35, respectively, for a single stamp. If the fourth bidder submits a bid of $100 in the auction, under a prior art auction method, not only will the fourth bidder win the auction, but the fourth bidder will also only be required to pay the second-highest bid amount of $35. This amount is significantly lower than the original $100 winning bid price. Under this prior art auction method, it is more advantageous to bid an artificially high amount that can always win an auction against a bona fide bidder, but subsequently only pay the second-highest price. Due to such a deficiency, the sealed second-highest bid amount auction is not popular in auction practices. Available systems and methods in the prior art do not remedy ongoing deficiencies in online auctions. Such deficiencies are also present with existing sealed bid reverse online auctions.

Additionally, uncertainty associated with existing sealed bid auctions may dissuade many bidders from even participating in these types of auctions because they will not know how their bids compare to the bids of other bidders. Thus, existing sealed bid auctions have a problem with attracting a sufficient number of bidders to help ensure a reasonable price for the good/service. Because the bids are sealed, bidders have no incentive to resubmit bids based on other bids. Another deficiency with traditional sealed bid auctions is a bidder's fear that he/she may significantly over-bid and win the auction, or under-bid and win the reverse sealed bid auction (and be obligated to provide the auctioned good/service for too low a price).

From the standpoint of the person auctioning the auction subject, a low number of bids raises the question of whether or not the bids will produce a reasonable and fair price for the goods/services. A buyer in a reverse auction desires a larger number of bidder-sellers as this increases the probability of obtaining a sufficiently low, fair, and reasonable bid. A buyer wants to obtain the auctioned subject at a low price, but also generally desires good quality of service. Therefore, a buyer in a reverse auction does not want a winning seller who experiences “winner's remorse” for fear that the quality of the goods/services, and/or the safe delivery or provision thereof, will be inadequate if the winning seller realizes he/she bid significantly below market value. Similarly, a seller auctioning a product or service desires a large number of bidder-buyers as this increases the probability of obtaining a sufficiently high bid. While all auctions provide inherent risk, these practical realities can diminish participation in existing sealed bid auctions and sealed bid reverse auctions, and by extension, their likelihood of success.

In an open auction, two or more colluding bidders may unfairly or illegally preserve a high bid or a low bid depending on the type of auction. Although a live auction on-site does not allow a bidder to withdraw a bid, an open online auction may allow bidders to withdraw bids at any time as a general or routine practice. Thus, two colluding people who place higher or lower bids may withdraw, allowing a third colluding bidder-buyer to win the auction at a lower price, forcing the seller to sell at this low price (or allow the third colluding bidder-seller to win a reverse auction at a higher price, forcing the buyer to pay an artificially elevated price for the good or service).

Current on-line auctions offer no effective solutions for these specific on-line or internet-centric auction problems in which auctions are much more easily manipulated by indecent bidders through “bid shielding,” “bid shading,” “shill bidding,” “bid sniping,” and “collusion” because of the anonymous nature of the internet, and due to the ease with which indecent bidders can create fake profiles, use false identities, communicate with one another remotely, and manipulate systems. For example, shill bidding is easier in internet auctions because a seller can easily act as his own shill without colluding with other participants. A seller of an auction subject can simply use a fake account, fake identifying information (e.g., fake ID), and/or an alternate user-name to post a bid with the intent of inducing bona fide bidders to bid higher. By contrast, in off-line live auctions, a seller cannot act as his own shill because he would need to present in-person, and would likely be recognized, either by bidders present at the auction, by auction house employees, or by security. Instead, in off-line live auctions, the seller would need to collude with other bidders to act as shill bidders on his behalf. Shills are an internet centric problem in Internet auctions due at least to this fake ID issue. Other instances of indecent bidders include people hacking into a server running an auction, or being allowed access thereto by a colluding auctioneer to see, for example, the bidding amounts. Such indecent bidders may have access to confidential information associated with the auction, including the amounts of any submitted bids at the time the hacker logs into the system, which is a serious security issue as such unauthorized access can lead to bid submissions favoring one or more of the colluding parties.

Another reason why use of fake IDs is an internet centric problem is that even potential bona-fide bidders may be unwilling to initially give out much personal information (e.g., full name, address, social security number, and/or bank account information, etc.) simply to participate in an online auction they've never tried. Thus, on-line auctions may generally refrain from such verification for fear of scaring away potential bidders, which makes it even easier for non-bona fide bidders to avoid detection. Such fraudulent activity takes away or reduces the ability of bonafide bidders to bid based on their perceived true value of the auction subject, and improperly changes the real value of the auction subject (as determined by the auction). Identifying the true value or real value of the auction subject is one of the challenging issues in the online auctions field.

Fraudulent online auction practices are extremely hard to detect, and attempts to do so have proven unsuccessful. It is not easy to identify the difference between indecent and bona fide bidders. While many open auction online websites claim to have measures to detect and remove indecent abusers to prevent fraudulent or unfair activities in online auctions, such systems and methods are highly ineffective. As a result, in certain instances, one or more sellers, bidders, and/or auctioneers are able to fraudulently attempt to shift an outcome of an auction in their favor. Thus, subject matter which solves this Internet-centric problem of indecent or fraudulent bidders online by technological means is desperately needed in the art. Applicant's present invention provides such a technical solution to this technical problem through online auction protocols that function to deter indecent bidders rather than detect them, whereby incentives of indecent bidders are eliminated while bona fide bidders are incentivized. Applicant's technical solution provides a solution which, when implemented in sealed bid online auctions and sealed bid online reverse auctions, does not create the other types of problems discussed above with respect to previously proffered solutions. By incorporating a risk of losing money through applicable fees associated with bidding and bidding amounts, and creating a level of uncertainty in the outcome along with a risk of significant potential loss for vendors, bidders, or auction participants in a computerized auction environment, indecent bidders are deterred from bidding. Additionally, Applicant's present invention not only deters indecent bidders, it also attracts bona fide bidders (including inexperienced bona fide bidders who might otherwise refrain from participating in a sealed bid auction for fear of bidding due to a lack of knowledge about the value of the auction subject) without incurring the problems discussed above with respect to sealed bid auctions known in the art (e.g., sealed bid first-price, sealed bid second-price, etc.), all through an on-line auction platform which offers a fair bidding process that encourages more present and future participation in sealed bid auctions, and the ability to obtain goods and/or services at the most desirable possible prices.

### SUMMARY OF THE INVENTION

This summary is not intended to identify or point to essential features or limit the scope of the subject matter claimed herein. The present invention relates generally to methods and systems for conducting a sealed bid online auction for goods and/or services, and utilizes alternate classifications for bidders such that at least one category of bidder may pay a fee to participate in the auction, and the fee is allocated to one or more auction participants or third parties in accordance with predetermined rules. The systems and methods also preferably utilize the values of multiple bids having predetermined designated ranks (e.g., the second highest, third highest, fourth highest, second lowest, third lowest, fourth lowest, etc.) to compute a payment amount associated with the winning bid for the auctioned goods/services. Generally, the methods and systems for remotely conducting a sealed bid online auction in accordance with the invention have at least the following objectives:
To mitigate or balance the risks to a vendor and/or a bidder in an online sealed bid auction, or to help optimize the interests of the vendor and/or bidder in such auctions;
To offer options for the vendor, bidder(s), or third-parties to customize the auction through various predetermined rules, settings, values, etc., including utilizing one of a variety of winning bid amount recalculation methods which result in payment amounts that can be higher, lower, or equal to the amount of the winning bid;
To provide incentives for both bidder and vendor participation by reducing “winner's remorse,” increasing the likelihood of a fair and reasonable final bid amount, and allocating a fee such as a price-protection fee paid by a bidder for distribution in accordance with one or more predetermined rules;
To establish multiple bidding categories, such as two optional bidding categories, for bidders associated with different predetermined rules and settings, and to identify a winning bid from bids in the multiple categories according to the different predetermined rules and settings;
To provide a bidder the option to select a bidding category with an associated commitment to pay an additional amount (e.g., a price-protection fee) related to the bidder's bid, and, if the bidder's bid is the winning bid, to potentially receive an adjustment to the amount of his/her bid;
To encourage bids which are closer to reasonably perceived market value;
To provide an online auction in which an option to review an advertisement by an advertiser may be provided to enable one or more bidders opting for the price-protection policy to be offered an optional payment amount from the advertiser to pay at least a portion of the fee for the price-protection policy;
To provide an online auction in which a fee paid by one or more auction participants or third parties is allocated in various ways to one or more parties based on predetermined rules and settings;
To establish a bidding category in which a recalculated winning bid amount (i.e., recalculated price, recalculated amount, recalculated final price, final recalculated amount, payment amount, etc.), is computed based on the value of the winning bid, a price-protection fee associated therewith, a value of a designated bid, and a predetermined percentage of a difference between the value of winning bid and the value of the designated bid (e.g., second highest, third highest, fourth highest, second lowest, third lowest, fourth lowest, etc.);
To enable a bidder to withdraw a bid before a close of the auction before a predetermined time, and to submit a new sealed bid after withdrawing his/her bid before the close of the auction within a predetermined time period, and to enable a plurality of bidders to submit new sealed bids within a certain time-frame when a plurality of bidders submitted identical bids identified as a winning bid amount;
To establish rankings, before a start of the auction, by a vendor, the system, a non-auction participant, or by default, corresponding to which of a plurality of sealed bids received will be selected as the winning bid and the designated bid for computing a recalculated winning bid amount;
To provide an online sealed bid auction utilizing an open (i.e., visible) or hidden (i.e., closed or not visible) reserve price as determined by the vendor to be the least the vendor is willing to accept for the auction subject, or, as determined by the buyer in an online reverse sealed bid auction, the most the buyer is willing to pay for the auction subject;
To identify a single bid as a winning bid, and utilize a reserve price established by a vendor to compute a recalculated winning bid amount;
To enable the auction to be cancelled, provide a vendor with an option to sell the auction subject for an amount below the reserve price, or provide a winning bidder with an option to acquire an auction subject at a reserve price preset by the vendor if none of the submitted bids equal or exceed the reserve price;
To close an auction with a randomly generated end time within a certain time interval, such as the last ten minutes or half hour, beyond which bidders are no longer allowed to submit bids or withdraw bids, in order to prevent collusion between one or more bidders and an auctioneer, and to minimize any advantage gleaned through unauthorized access to sealed bids;
To mitigate the risk to a vendor and/or a bidder in an online sealed bid reverse auction, or to help optimize the interests of either the vendor or the bidder in such auctions;
To offer options for the buyer, bidders, or third-parties to customize the auction through various predetermined rules, settings, values, etc.;
To establish one or more rankings, before a start of the auction, by a buyer, by a seller, by the system, by a non-auction participant, or by default, corresponding to which of a plurality of sealed bids received will be selected as the winning bid and which of the plurality of bids received will be selected as the designated bid for calculating a payment amount for the auction subject;
To identify a bid as a winning bid, and utilize a reserve price established by a vendor to compute a recalculated winning bid amount;
To facilitate relationships between buyers and sellers in sealed bid online auctions and sealed bid online reverse auctions by creating a “favorites” list and a “blacklist” or “blocklist” based on various feedback provided to the system, and to enable the auction host (i.e., the seller in a sealed bid auction and the buyer in a sealed bid reverse auction) to choose whether or not individuals or groups are one or more of the favorite list or the blacklist;
To prevent online auction users from bidding using fake IDs by deterring such non-bonafide bidders, and reducing incentives thereof;
To create an auction site blacklist or blocklist whereby auction participants may be precluded from accessing the auction site, from accessing certain auction subjects, etc.;
To allocate at least a portion of a fee to one or more auction participants or auction non-participants;
To maintain a database of records relating to the evaluation of the auction subjects over time and the individuals providing the evaluations;
To allow for crowdsourced ratings of the evaluations of auction subjects;
To provide a platform for ratings by other users with firsthand experience with an auction subject, and an award or payment allocated to users who shared the reason and/or recommendation of an evaluation or price for the auction subject when the ratings reach a predetermined number;
To update, correct, supplement, or otherwise modify the database dynamically upon reaching a predetermined number of ratings;
To provide a combined offline and online auction in which a sealed bid online auction for an auction subject is conducted, and upon a close of the sealed bid online auction, an offline auction for the same auction subject is conducted, whereupon at the close of the offline auction a comparison of the offline auction bids and the online sealed auction bids is made to determine a winning bid, and a final payment amount is calculated based on a designated bid according to the price-protection formula;
To provide a combined offline and online auction in which an offline auction for an auction subject is conducted, and upon a close of the offline auction, a sealed bid online auction for the same auction subject is conducted, whereupon at the close of the online sealed bid auction a comparison of the offline auction bids and the online sealed auction bids is made to determine a winning bid, and a final payment amount is calculated based on a designated bid according to the price-protection formula;
To disincentivize or prevent hackers or indecent bidders from participating in fraudulent, illegal, or indecent activies (e.g., exchanging or accessing inside information regarding bid values) to enhance online auction security.
To provide a combined offline and online auction where all or a portion of the sealed bid online auction is conducted simultaneously with all or a portion of an offline auction for the same auction subject, whereupon at the close of the online and offline auctions, a comparison of the offline auction bids and the online sealed auction bids is made to determine a winning bid, and a final payment amount is calculated based on a designated bid according to the price-protection formula.

In accordance with one aspect of the invention, a computer-implemented system for conducting a sealed bid electronic online auction performed in an electronic platform is provided. The system comprises a server communicatively coupled, via a network, to a remote vendor computing device associated with a vendor of an auction subject and one or more remote bidder computing devices associated with one or more bidders for the auction subject. The server includes at least one non-transitory computer-readable storage medium with computer-readable instructions stored therein to remotely perform the auction based on one or more sets of predetermined rules, a database, and a processor for executing the computer-readable instructions to: receive an auction request for an auction subject in the electronic online auction, receive, from a plurality of bidders via the remote bidder computing devices, one or more sealed bids for one or more corresponding bid amounts relating to the auction subject, assign a different identifier to each of the one or more sealed bids automatically, and transmit, during the electronic online auction, to one or more of the remote bidder computing devices, a first representation of the electronic auction including each different identifier. At least one of the one or more remote bidder computing devices displays at least a portion of the first representation. The processor is further instructed to identify a winning bid and a designated bid from the one or more sealed bids in accordance with the one or more sets of predetermined rules, calculate a payment amount corresponding to the winning bid based on an adjustment amount, wherein the adjustment amount is computed based on an amount of the winning bid and an amount of the designated bid in accordance with the one or more sets of predetermined rules, and transmit, after a close of the electronic online auction, to at least a bidder computing device associated with a bidder of the winning bid, a second representation of the electronic auction, wherein the second representation includes at least a portion of the payment amount, and wherein the bidder computing device associated with the bidder of the winning bid displays at least a portion of the second representation.

In accordance with another aspect of the invention, a computer-implemented method for conducting a sealed bid electronic online auction performed in an electronic platform is provided. The method comprises receiving an auction request for an auction subject in the electronic online auction, receiving, from a plurality of bidders via a plurality of remote bidder computing devices, one or more sealed bids for one or more corresponding bid amounts relating to the auction subject, assigning a different identifier to each of the one or more sealed bids automatically, transmitting, during the electronic online auction, to one or more of the remote bidder computing devices, a first representation of the electronic auction including each different identifier, wherein at least one of the one or more remote bidder computing devices displays at least a portion of the first representation, identifying a winning bid and a designated bid from the one or more sealed bids in accordance with the one or more sets of predetermined rules, calculating a payment amount corresponding to the winning bid based on an adjustment amount, wherein the adjustment amount is computed based on an amount of the winning bid and an amount of the designated bid in accordance with the one or more sets of predetermined rules, and transmitting, after a close of the electronic online auction, to at least a bidder computing device associated with a bidder of the winning bid, a second representation of the electronic auction, wherein the second representation includes at least a portion of the payment amount, wherein the bidder computing device associated with the bidder of the winning bid displays at least a portion of the second representation.

Other objects, features, and characteristics of the present invention, as well as the methods of operation and functions of the related structural elements, and the combination of parts and economies of development and manufacture, will become more apparent upon consideration of the detailed description below with reference to the accompanying drawings, all of which form a part of this specification.

### BRIEF DESCRIPTION OF THE DRAWINGS

A further understanding of the present invention can be obtained by reference to preferred and exemplary embodiments set forth in the illustrations of the accompanying drawings. The drawings are not intended to limit the scope of this invention, which is set forth with particularity in the claims as appended or as subsequently amended, but merely to clarify and exemplify the invention. Accordingly, a more complete appreciation of the present invention and many of the attendant aspects thereof may be readily obtained as the same becomes better understood by reference to the following detailed description when considered in conjunction with the accompanying drawings, where:

FIG. 1A depicts a system architecture according to exemplary embodiments of the present invention;

FIG. 1B depicts the database according to exemplary embodiments of the present invention;

FIG. 1C depicts additional system architecture according to exemplary embodiments of the present invention;

FIG. 2 depicts a data record according to exemplary embodiments of the present invention;

FIG. 3 depicts a computing device according to exemplary embodiments of the present invention;

FIG. 4 depicts an alternate computing device according to exemplary embodiments of the present invention;

FIG. 5A depicts the bidding process, from the bidder's side, according to exemplary embodiments of the present invention;

FIG. 5B depicts the continuation of the bidding process from the bidder's side according to exemplary embodiments of the present invention;

FIG. 5C depicts the process of distribution of a “price-protection fee” according to exemplary embodiments of the present invention;

FIG. 6A depicts the bidding process from the vendor's side according to exemplary embodiments of the present invention;

FIG. 6B depicts a continuation of the bidding process from the vendor's side according to exemplary embodiments of the present invention;

FIG. 6C depicts a continuation of the bidding process from the vendor's side according to exemplary embodiments of the present invention;

FIG. 7 depicts the process of determining the winning bidder when there are identical highest winning bid amounts;

FIG. 8A is a flowchart illustrating a bidding process from the bidder's side in an online sealed bid reverse auction, in accordance with an exemplary embodiment of the invention;

FIG. 8B is a flowchart illustrating a continuation of the bidding process from the bidder's side shown in FIG. 8A;

FIG. 8C is a flowchart illustrating alternative embodiments of a process for distributing a price-protection fee in an online sealed bid reverse auction, in accordance with an exemplary embodiment of the invention;

FIG. 9A is a flowchart illustrating an auction process from a buyer's side in an online sealed bid reverse auction, in accordance with an exemplary embodiment of the invention;

FIG. 9B is a flowchart illustrating a continuation of the auction process from the buyer's side shown in FIG. 9A;

FIG. 9C is a flowchart illustrating a continuation of the auction process from the buyer's side shown in FIG. 9B;

FIG. 10 is a flowchart illustrating a process of determining the winning bidder when there are identical lowest winning bid prices in an online sealed bid reverse auction in accordance with an exemplary embodiment of the invention; and

FIG. 11 is a flowchart illustrating alternate embodiments of a system and method for a combined online/offline auction in accordance with the present invention, further illustrating scenarios whereby (i) a sealed bid online auction is followed by an offline (open) auction, (ii) an offline (open) auction is followed by a sealed bid online auction, and (iii) the sealed bid online auction and the offline (open) auction are conducted, at least in part, simultaneously.

### DETAILED DESCRIPTION

As required, detailed illustrative embodiments of the present invention are disclosed herein, and specific embodiments that may be practiced are shown by way of illustration and explanation. The present disclosure is not intended to be limited to the specific terminology selected, and it will be understood that each specific element includes all technical equivalents which operate in a similar manner. However, techniques, methods, systems, and operating structures in accordance with the invention may be embodied in a wide variety of forms and modes, some of which may be quite different from those in the disclosed embodiments. Consequently, the specific structural, functional and step-by-step details disclosed herein are merely representative, yet in that regard, are deemed to afford the best embodiments for purposes of disclosure, and to provide a basis for the claims herein which define the scope of the present invention. The embodiments herein are described in sufficient detail to enable those skilled in the art to practice them, and it will be understood that logical, mechanical, and other changes may be made without departing from the scope of the embodiments. The following detailed description is therefore not to be taken in a limiting sense.

Exemplary embodiments of the invention provide a sealed bid online auction for a vendor and one or more bidders (i.e., bidder-buyers or bidder-sellers depending on the type of auction) in which the bidders compete for the vendor's auction subject using a sustainably balanced system and method by which the bidder can acquire or sell goods/services at a fair rate while allowing the vendor to buy or collect fair compensation for goods/services.

Generally, the terms “bidder” and “vendor” as used herein may include any individual, customer, buyer, seller, entity, or group thereof seeking to obtain or provide goods/services temporarily or permanently.

The term “auction participant” as used herein may include any individual, entity, customer, buyer, seller, or group thereof associated with or directly involved in any auction described herein.

The term “non-auction participant” or “nonauction participant” as used herein may include any party (e.g., individual, entity, group, etc.) not involved in the auction directly.

The term “fee” as used herein does not refer to traditional shipping or postage fees, fees paid to the auction site for use of it, or for any taxes or fees related to regular business operation purposes. Instead, the term “fee” and other references thereto described herein refers to an amount which may be paid either at the time a bid is submitted or after the bid is submitted, as consideration for participating in the auction as a particular type of bidder who may receive one or more benefits (e.g., a change in the amount the bidder owes for buying the auction subject, or is entitled to for providing the auction subject as a seller, if the bidder wins the auction, a kickback to the bidder after the winning bidder is determined, etc.). Such benefits depend on the auction's outcome, the specific bids received, the amounts thereof, and the predetermined rules for the particular auction. Accordingly, the system may collect a fee (also referred to herein as a “price-protection fee”, a “protection fee,” or a “participation fee)” from one or more parties (e.g., the bidder, the winning bidder, one or more other auction participants, a winning bidder who opted to participate in a presented “price-protection policy”, a non-auction participant, etc.) which functions as consideration for being allowed to participate as a bidder in a sealed bid auction, which, in certain embodiments, gives each bidder the option to protect himself/herself from, for example, significantly overvaluing or undervaluing the goods/services. In certain embodiments, the fee may not be required. In other embodiments, the fee may be paid prior to or after submission of the bidder's bid, or may be given in commitment form for payment at a later date. The fee may be paid by one or more auction participants, such as a bidder, buyer, seller, third party, vendor, advertiser (who can pay for at least portion of the fees as consideration for viewing the advertisement). The fee can also be paid by the advertiser based on the condition that the bidder who views the advertisement wins the auction. The fee may be allocated in any number of ways as described above (e.g., to an auction participant or a non-auction participant who not participate the auction directly, such as a charity that receives part of or all of the allocation fee as described herein. In yet other embodiments, the fee may be a non-monetary good, service, or anything of value, such as hotel room services, particular services, etc. The fee and calculations used herein help balance risk between auction participants.

The term “commitment” as used herein may refer to a promise to provide something of value, such as money, cash, credit, a non-monetary good and/or service, or anything else of value, such as services, including volunteer services, charity services, hotel room services, etc. The commitment may function as consideration which is tendered before, during, and/or after the auction. Alternatively, the commitment may or may not be provided, or may be provided as nominal consideration. The commitment may be tangible or intangible. For example, the commitment may be shown by tendering payment or services in advance of a bid, with the bid, or the after the bid.

The terms “ascending sealed bid auction” or “sealed bid ascending auction” as used herein refer to a sealed bid online auction in which the person or entity auctioning the auction subject (e.g., the vendor) is a seller of the auction subject, and the bidder(s) are buyers who attempt to win the auction by bidding amounts they are willing to pay for the auction subject. The auction subject may be a good and/or a service. Such a bidder-buyer wins the ascending sealed bid auction when his/her bid is identified as the winning bid based on a predetermined ranking or designated ranking (e.g., the highest bid, the second highest bid, the third highest bid, etc.) based on predetermined rules. The winning bid rank can be designated based on predetermined rules or established by default by the system. For example, the predetermined rules may dictate that the highest or lowest bidding amount be the rank corresponding to the winner of the auction at or before the initiation of the auction.

The terms “reverse sealed bid auction” or “sealed bid reverse auction” as used herein refer to a sealed bid online auction in which the person or entity auctioning the auction subject (e.g., the vendor) is a buyer who wishes to purchase a good or service (the auction subject), and in which the bidder(s) are sellers who attempt to win the auction by bidding amounts for which they are willing to provide the auctioned subject, which may be a good and/or service. Such a bidder-seller wins the reverse sealed bid auction when his/her bid is identified as the winning bid based on a predetermined ranking or designated ranking (e.g., the lowest bid, the second lowest bid, the third lowest bid, etc.) based on predetermined rules.

The terms “ranking”, “rank”, and “designated ranking” as used herein refers to the particular ranking of a sealed bid received for the auction subject compared to all of the sealed bids received for the auction subject. By way of example, a ranking of “first” may mean the highest or the lowest bid received depending on whether the auction is an ascending sealed bid auction or a reverse sealed bid auction, respectively. In ascending sealed bid auctions described herein, rankings of 1^{st}, 2^{nd}, 3^{rd}, etc. refer to the bids whose amounts are the highest, second highest, and third highest, respectively. Similarly, in reverse sealed bid auctions described herein, rankings of 1^{st}, 2^{nd}, 3^{rd}, etc. refer to the bids whose amounts are the lowest, second lowest, third lowest, respectively.

The term “winning rank” as used herein refers to the rank of the winning bid, which may be predetermined in one or more sets of rules for the auction. The term “designated rank” as used herein refers to the rank of a designated bid of the received bids. The designated bid rank can refer to a single bid rank for calculation payment purposes. The designated bid rank refers to the bid rank which is designated based on predetermined rules, or established by the system, and is relevant to calculation of payment for the auction subject. In certain embodiments, the amount of the designated bid is used in conjunction with the amount of the winning bid to perform a calculation of a payment amount associated with the winning bid.

The terms “recalculated bid amount”, recalculated winning bid amount”, “recalculated amount”, “final recalculated amount”, and “payment amount” as used herein refer to an amount associated with the winning bid after a calculation is done in accordance with predetermined rules. In certain embodiments, the term “payment amount” is also used herein to reflect a recalculated bid amount with or without the fee.

It will be appreciated that various examples and equations disclosed herein may be applied in both ascending sealed bid auctions and reverse sealed bid auctions, that these specific examples and illustrated embodiments in the figures are provided for illustrative and explanatory purposes, and that the various equations disclosed herein, along with permutations thereof, may be used for both the ascending sealed bid online auctions and the sealed bid reverse online auctions disclosed herein.

In preferred embodiments of the ascending sealed bid online auctions described herein, the potential for a winning bidder-buyer to pay less than his/her bid price results from a calculation governed by preset rules which use the value of and difference between the winning bid and a designated bid, and help mitigate problems otherwise associated with “winner's remorse” or “winner's curse” while also promoting fairness to and encouraging participation of additional bidders through allocation of a fee paid before or after the bids are submitted. Such preset rules, by introducing uncertainty and a near impossibility of predicting the outcome, balance risk between vendors and bidders, and also deter indecent bidders who might otherwise attempt to improperly collude and/or shift the outcome in their favor. In essence, the bidder who commits to pay the fee may potentially enjoy the benefits associated therewith. The invention can additionally mitigate risk to a party to the auction transaction in certain scenarios, and help balance bidder/vendor interests. Alternatively, the system can be configured to help optimize either the bidder's or the vendor's interests, and to attract bidders through various incentives, which can lower the risk to a vendor with regard to the price at which he/she is obligated to buy or sell the auction subject depending on the type of auction.

As described above, traditional auctions known in the prior art imply transfer of ownership of the auctioned item. The present invention includes but is not limited to traditional auctions. Exemplary embodiments of the present invention also allow the transfer of the possession rights for an auctioned subject from one party to another party with or without transferring actual ownership. The auctioned subject may be tangible or intangible, and may include anything that may have value, such as goods, skills, services, spaces, financial resources, etc. The systems and methods presented herein can be used on a broad spectrum of electronic devices, including but not limited to computers, mobile devices, tablets, and the like.

Bidders and vendors herein may include individuals, business entities, not for-profit organizations, charities, government agencies, etc. The system integrates a means for maintaining one or more databases which include vendor's and bidder's information without disclosing bidders' real IDs, information about auctioned tangible and/or intangible subjects, and a database of successful transactions within specific periods of time. The database serves as a reference point to potential bidders and vendors about the price of a previously auctioned subject, which can be particularly helpful when the bidders and vendors lack adequate knowledge and experience.

Users of the system who want to participate in online auctions may register for an account with the system, which includes a user agreement with the relevant rules preset for both vendors and bidders prior to the start of the auction. Registering an account includes personally identifiable information as well as valid financial information. This may include, but is not limited to, name, address, email, phone number, and valid financial information. User accounts may be verified by the system through email or phone. Exemplary embodiments of the system will only allow users to register one account by email and/or phone number with a username.

Such accounts can be used to bid or list the auctioned subject for auction. To prevent fraud in creating multiple accounts, the system can require a genuine name, genuine address and genuine financial information in order to register the account. Users of the system may be required to include financial information such as a debit card, credit card, non-auction participant payment systems such as PayPal and/or bank account details. Financial information is needed to confirm that bidders have enough money in their account to pay the amount of the sealed bid they submit. Verifying payment by confirming the buyer's financial capabilities will avoid default or delayed payments after the auction ends. This avoids issues such as delayed payment, bidders who bid purely for enjoyment without bonafide intent, bidders who do not have enough money to pay, and buyers who cancel the transaction by non-payment after the auction ends. In certain embodiments, the system can be configured to promote bidders to submit bids only for amounts they are confirmed to have, thereby preventing cancellation of transactions and helping to prevent bidders who are unable to pay after auctions are completed from claiming or asserting that the bidding was erroneous, accidental, etc.

Exemplary embodiments allow vendors to list auctioned subjects offered for auction through an online auction platform. Vendors may register their auctioned subject for the online auction by submitting an introduction about the details of the auctioned subject, which may include but is not limited to written descriptions, photos, videos, etc. Any deficiencies may also be disclosed to avoid misrepresentations or fraud. The vendor's ID or username will be disclosed with the auction listing, and will be disclosed when providing feedback after the transaction is completed at the end of the auction. Before the property that is auctioned is officially listed in the online auction platform, the system will issue an index number for each auction subject listed and will also issue a timestamp for the start time of the auction. The system will track the auction until the end of the time duration of the auction as preset by the vendor. In certain embodiments, the vendor may provide double confirmation by confirming that the auction subject is ready to be delivered or performed once the auction concludes and proper payment is made. For example, if the auctioned items are goods, then they will be delivered to the winning bidder unless there are special circumstances beyond vendor's control, such as natural disasters, war, etc. Additionally, the vendor may confirm that the start or reserve price he/she sets for the auctioned subject is indeed the price he/she is willing to accept as a start or reserve price. This prevents a vendor from cancelling the transaction after the auction ends by making excuses when the vendor cannot locate the property, or from claiming that he/she made a mistake while setting a start or reserve price. If a vendor confirms with the system but subsequently cancels the transaction after the auction ends, then the vendor's account may be suspended for a certain period, such as one month for the first time, or the vendor's account may be suspended permanently if it occurs a second time, excluding certain circumstances and force majeure.

When bidding, normally visible aspects of the auction, for example, the bidder's username and other bidder-identifying information, will not be shown. Instead, bidders will be listed in the order they bid using randomly generated ID numbers by the system, which will not be accessible to other bidders except bidders themselves even after the auction is finished. Once the auction is finished, only the vendor will be able to see the real ID of the winning bidder. Other bidders will only be able to see the bid amounts of other bidders without seeing their real IDs. The bidding times for each sealed bid will have a timestamp which is displayed to track the bids in the auction. Users will be able to see the applicable remaining time left for the auction regardless of where the user is located. In certain embodiments, a randomly generated number matched to each bidder that is unidentifiable eliminates public disclosure of bidders' identities and the chance for others to potentially emotionally bid on the auction based on past interactions with the same bidders. Emotional bidding can lead to skewed prices that do not reflect real value. In addition, random bidder IDs may prevent or reduce “shill bidding,” “collusion,” etc. as it will be impossible to identify bidders, their previous bidding activities and interests based on their IDs.

The bidding process for sealed bids within the auction allows for honesty and integrity when listing an auction or submitting bids. In certain embodiments, vendors will need to disclose their usernames and be known to potential bidders. Additionally, emotional bidding or indecent bidders who often shill bid, etc., will not take place because bidders are not identifiable when using randomly generated ID numbers. However, the system may still allow a vendor to block a particular ID number from bidding if the vendor chooses to do so because that particular bidder caused problems in previous transactions. When the vendor indicates an ID number they would like to block, the system will be able to match the ID number with the respective bidder and block the bidder from bidding within that auction.

In addition to confidential real ID numbers, in certain embodiments, bid amounts are not shown to other bidders during the auction. Bidders can thus bid a realistic amount that reflects their expectations, and an amount they have the capability to pay. In certain embodiments, bidders may provide double confirmation by verifying first that their bid amount is accurate, and after submitting their bid amount, verifying that they have the capability of paying the bid amount with any applicable shipping costs, insurance, etc. This will help to avoid discrepancies or arguments relating to potential bidder mistakes as to the amount when bidding. This method of receiving confirmation may provide some risk to indecent bidders, which may include any or all of the indecent bidders described above, because a potential cost is imposed for bidding without an intent to pay. Thus, systems and methods of the present invention build integrity into the system. In certain embodiments, winning bidders may additionally be required to pay the sealed winning bid amount within a certain period of time after the auction ends. Indecent bidders such as shill bidders will be substantially reduced in number, if not eliminated, because exemplary embodiments of the present invention render it difficult to revoke the winning bid after confirmation has been obtained from the bidder. By incorporating the risk of losing money through the applicable fees associated with bidding, indecent bidders will be deterred from bidding.

In certain embodiments, bidders are allowed to have only one valid bid amount. Additionally, in certain embodiments, bidders may withdraw their bids before the auction ends. Furthermore, withdrawn and/or changed bids may remain sealed so others will not be aware of the withdrawn or changed bidding IDs and/or amounts. By keeping withdrawn or changed bids confidential, the system prevents bidders from using these withdrawn and changed bids as reference, and can also eliminate misrepresentation or fraud. Exemplary embodiments of the present invention allow vendors to contemplate the real value they expect to receive from the proceeds of the auction and list the price they honestly believe the auctioned subject is worth. Such methodologies encourage users who are bona fide and have the capability to pay the amount to submit sealed bids and possibly win the auction without concern of being cheated. A bidder who bids at the last second will not necessarily be the actual winning bidder at the end of the auction. Additionally, as further discussed below, embodiments of the present invention reduce or substantially prevent indecent bidders by deterring them through inherent risk with respect to recalculations of the amounts they bid, and/or, in certain embodiments, by requiring payment of fees associated with the amount of the bid.

In the prior art, it is common for auctions to have a reserve price. A reserve price is typically a hidden minimum price that the vendor is willing to accept for a property. In a reserve price auction, the vendor is only obligated to sell the property once the bid amount meets or exceeds the reserve price. The downside of this concept is that the bidders do not see the hidden price and are left to constantly speculate about the amount of the hidden reserve price, which often results in a failed auction as the bidders cannot reach the reserve price. An exemplary embodiment of the present invention deviates from this aspect of the prior art in that it allows a vendor to either set an open reserve price, a conditional hidden reserve price, or no reserve price at all, all at the vendor's discretion. The open reserve price is the minimum price the vendor, as a seller, will accept in order for an ascending sealed bid auction to be successful (or the maximum price the vendor, as a buyer, will accept in order for a reverse sealed bid auction to be successful). The open reserve price is disclosed to the bidders. When the vendor chooses to set an open reserve price, the open reserve price is disclosed to the bidders prior to the start of the auction to make the bidders aware of the price accepted by the vendor. In a reverse sealed bid auction, all bids above the open reserve price may be rejected by the system. In an ascending sealed bid auction, all bids below the open reserve price may be rejected by the system. The open reserve price would not allow for premature termination unless a pre-determined set of circumstances warrant the premature termination, as bidders are aware of the reserve price preset by the vendor. In accordance with exemplary embodiments of the present invention, a conditional hidden reserve price is, first, where the system allows the vendor to terminate the auction early or continue until the end of the auction if one of the bidders reaches or exceeds the reserve price set by the vendor (e.g., in an ascending sealed bid auction), and/or second, where the system allows bids to be accepted even if the bids do not reach the conditional hidden reserve price set by the vendor, with the highest submitted bid amount considered to be the winning bid. This method of providing two categories for reserve prices is more efficient and transparent than the prior art because it allows auctions to be completed successfully, thereby reducing the chances for the auction to fail due to bidders' speculated bid amounts that do not reach an undisclosed hidden reserve price set by the vendor. The system may allow a vendor to terminate the auction early or continue the auction if one of the bidders reaches the minimum or maximum conditional reserve amount depending on the type of auction.

Sealed-second price methods with or without a one bid increment increase used by the prior art are deficient because they may deprive all other bona fide bidders from winning as the winning bidder may potentially submit an artificially high bid amount to win the auction. In the prior art, a sealed second-highest bid amount has been established as a base value that the winning bidder pays. The highest sealed price may be one bid increment more than the second-highest sealed bidder's bid amount. One bid increment is the amount by which the current highest bid may be raised by the bidder to win the auction. Bid increment is a pre-determined amount prescribed by the rules of the auction where the auction has a preset table of bid increments depending on the property's beginning or current price in the auction, such as $0.5, $1, $5, or $10. However, the one bid increment approach is not effective because the final winning amount to be paid is often not substantially related to the final winning bid amount. The fact that the winner may only have to pay one increment value more than the second-highest winning price, may induce indecent bidders to place artificially high bid amounts with the sole purpose of winning the auction. Such indecent bidders do not have to take responsibility for paying the amounts they bid, and therefore, do not fear facing financial consequences of their artificially high bid amounts.

Embodiments of the present invention are intended to resolve these deficiencies. For example, in certain embodiments of an ascending sealed bid auction, the winning bidder is responsible for paying either the full amount of the winning bid or a certain percentage of the winning bid plus the amount of the second-highest bid. Since the winning bid amount may be directly related to the amount the winner pays, the bidders are less likely to place artificially high bids.

Exemplary embodiments of the present invention may provide a method through a computing system to divide the bidders into two categories, such as a bidding category one bidder and a bidding category two bidder. A bidding category one winning bidder may be required to pay the submitted sealed bid amount. A bidding category two bidder may be committed to buy a “price-protection policy” to have a chance of reducing a payment amount associated with the category two bidder's bid to an amount less than that of the bid should the bid be the winning bid. The bidder may be given the option of self-determining or classifying himself/herself either as a bidding category one or a bidding category two bidder based on his/her own experience or preference, in consideration of the auction strategies or as randomly chosen by the bidder. Based on two categories, the name of the bidding category can be flexible, such as bidding category A and B, “experienced” and “inexperienced” or any other names to identify two different categories of bidders. Exemplary embodiments of the present invention divide the bidders into bidding category one and bidding category two bidders. A bidding category one bidder will be responsible for the winning bid amount, while a bidding category two bidder may be able, under certain conditions, to enjoy the potential benefit of paying a reduced price with the purchase of the “price-protection policy”. Exemplary embodiments may offer a “price-protection policy” at a certain percentage of the submitted bid amount (e.g., 3% or 5%) for bidding to potentially lower the winning bid amount if the bidder indicates he or she is a bidding category two bidder. In certain embodiments, the bidders may have a chance to change categories while bidding in different auctions. A bidder who confirms to be a bidding category one bidder when bidding for one auctioned subject may identify himself/herself as a bidding category two bidder during the auction or when bidding for another auctioned subject in another auction. Accordingly, a bidding category one bidder who confirms the bid amount based on his/her own experience, preference, or in consideration of auction strategies or as randomly chosen by the bidder should bid with confidence and have no regrets about the payment obligations if he/she is the winning bidder after the auction ends. Similarly, a bidding category two bidder who commits to pay the “price-protection fee” may feel comfortable bidding with the possibility of obtaining a potential discount if he/she is the winning bidder after the auction ends. In other embodiments, the systems and methodologies described herein may be utilized in conjunction with only a single category of bidder in which the winning bidder is entitled to calculation of a payment amount based on the value of the winning bid or a designated bid and at least one of the fee and the adjustment.

Exemplary embodiments of the present invention resolve various deficiencies with the prior art described above, such as “winner's remorse,” by using a “price-protection policy”, “price-protection formula,” or “price calculation methodology”, and in certain embodiments, by giving bidders the option of choosing bidding categories which may or may not utilize the price calculation methodology. According to exemplary embodiments of the present invention, the winning final price paid by a bidding category two winning bidder is calculated by the sum of: the “price-protection fee,” the second-highest bid amount, and the amount of a pre-determined percentage of the difference of the winning bid amount and a designated bid amount (e.g., the second highest bid amount, the third highest bid amount, etc.). Bidders will have to confirm which bidding category they belong to before they start to bid, and may change their bidding category before the end of the auction. The bidder will then be responsible for the amount of bid they submitted according to the bidding category to which they belong. Bidding category one bidders will be responsible for the full submitted bid amount, whereas bidding category two bidders will have a chance to pay a reduced amount of the winning bid due to the price-protection policy.

In certain embodiments, the final amount of the winning bid may be recalculated according to a price-protection formula, where, in certain embodiments, the winning final price paid by a bidding category two winning bidder is calculated by the sum of: the price-protection fee, the second-highest bid amount, and the amount of a pre-determined percentage of the difference of the winning bid amount and the second-highest bid amount. Depending on different business strategies, the system may provide the option for vendors to determine who will be awarded the fee for the price-protection policy. As preset by the vendor through the system, the fee paid for the price-protection policy may be entirely awarded to the vendor, entirely awarded to second-highest bidders, wherein the price-protection policy fee amount is split between all second-highest bidders by the pre-determined percentage, or may be split between the vendor and second-highest bidder(s). As a practical matter, if the vendor is confident that the auctioned subject will attract many bidders, he/she may choose to keep the entire amount of the price-protection fee. On the other hand, if the vendor wants to attract more bidders to participate in the auction for the auctioned subject, he/she may decide to award the entire price-protection fee to second-highest bidder(s). Therefore, even if the vendor receives less than the original winning bid because the bidder purchased the policy, the vendor will still have an option to receive a portion of the price-protection fee payment in addition to the recalculated winning bid amount. Additionally, the bidding category two bidders may bid without having to worry about overpaying for the auctioned subject, which will ultimately promote participation in the auction. In addition, if there is only one bidder placing the bid for the auctioned subject and the bidder identifies himself/herself as a bidding category two bidder, then the entire amount of the price-protection fee may go to the vendor, and the starting price of the vendor may be considered the second-highest bid amount.

However, as further discussed below, there is an element of risk involved in purchasing the price-protection policy as this will not always lower the winning bid amount the bidder pays. If, for example, there is a large difference between the winning bid amount and the second-highest bid amount (e.g., a large bid spread between the two), then a bidding category two bidder buying the policy will likely have their bid amount substantially lowered. However, if there is a small or nominal difference between the winning bid amount and the second-highest bid amount, then a bidding category two bidder buying the policy may end up incurring more costs (or suffer a loss) because the final price the winning bidder will pay will be higher than the originally submitted bid amount. This potential loss associated with the price-protection policy purchase will prevent bidders from abusing the system. If no potential loss were involved, then every bidder would purchase the price-protection policy in order to pay less than the winning bid amount.

In accordance with exemplary embodiments of the invention, numerous formulas may be employed for determining a recalculated final price or payment amount that a bidder-buyer will be obligated to pay in a sealed bid ascending auction for the auctioned goods/services, or the amount for which a bidder-seller will be obligated to provide the auctioned subject in a sealed bid reverse auction. The formulas may be implemented as methods in embodiments herein using system codes with programming language.

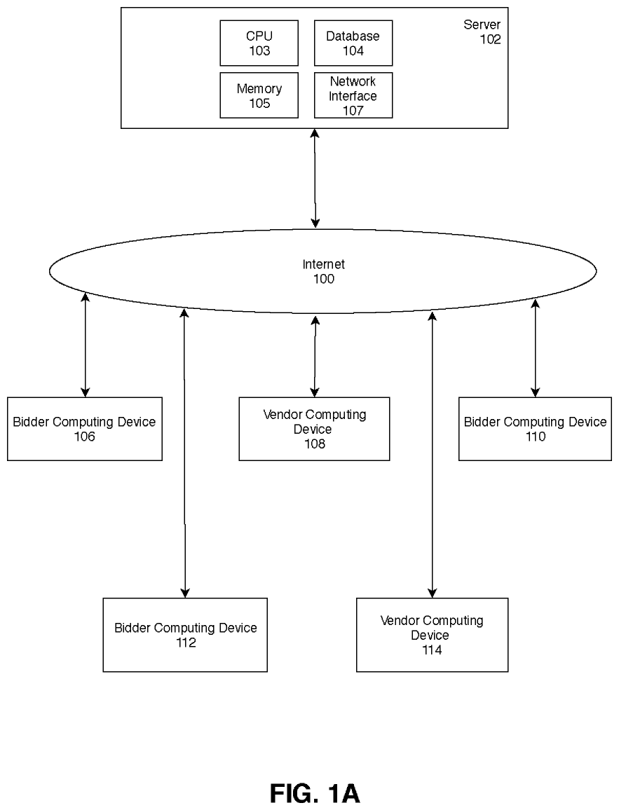

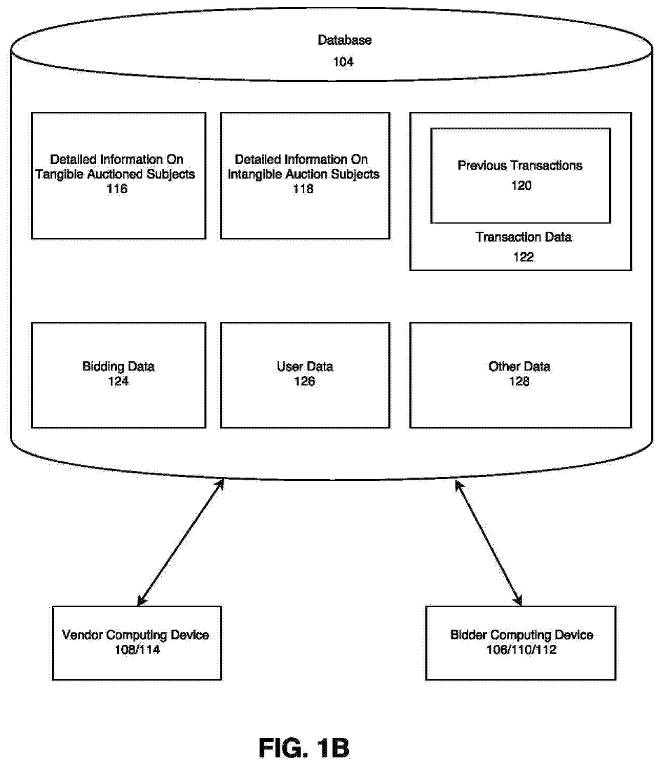

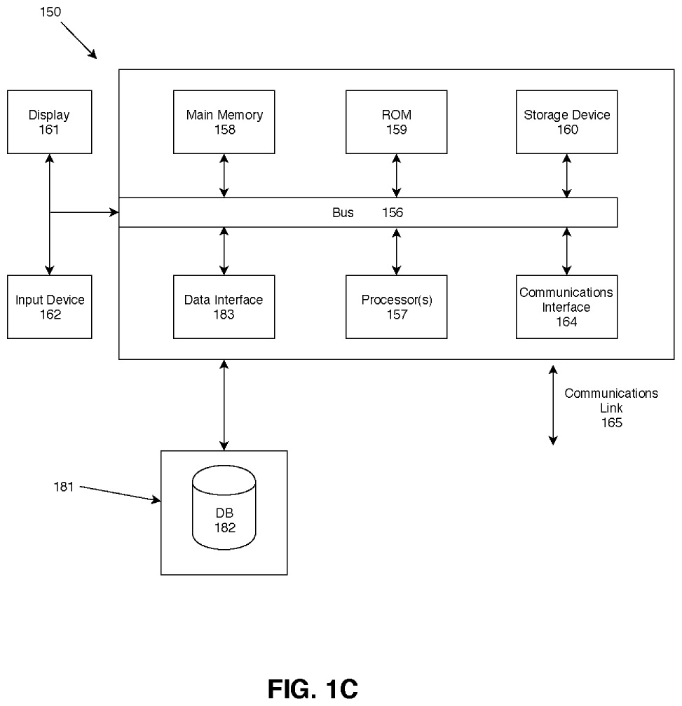

To illustrate exemplary embodiments of the various methodologies of the present invention described herein, eleven examples of an ascending sealed bid online auction using a first equation, twenty-four examples with respect to twenty-four equations, and a description of FIGS. 1A-11 are discussed below. The following price-protection formula may be used after the close of an ascending sealed bid auction to compute the final Recalculated Price the buyer has to pay for the good/service auctioned when a Category two bidder wins, and may be represented by the following equation:

R_{P1}=[B_{D}]+[P_{PCT}*(B_{W}−B_{D})]+[P_{PP}*(B_{W})]. Equation 1

where R_{P1} is the Recalculated Price or Payment Amount; B_{W} is the Winning Bid amount; P_{PCT} is the Predetermined Percentage; B_{D} is the Designated Bid (e.g., the Second Highest Bid) amount relative to the Winning Bid amount B_{W}; and P_{PP} is the Price-Protection Fee Percentage.

### Example 1

A bidder (Bidder 1) confirms he/she is a bidding Category two bidder, submits a bid of $100, and pays a price-protection fee, which may have been preset at 5% (i.e., $5.00). Additionally, a first ranking for the Winning Bid has been preset to be the highest bid, a second ranking for the designated bid has been preset to be the second highest bid, and a pre-determined percentage of 20% has been preset. Another bidder (Bidder 2) confirms he/she is a bidding Category one bidder and submits a bid of $50, which, at the close of the auction is the second-highest bid amount. Yet another bidder, for example Bidder 3, confirms he/she is a bidding Category one bidder, submits a bid of $40. At the end of the auction, Bidder 1 is the winning bidder, and, being a Category two bidder, is entitled to a recalculation of the winning bid amount to determine the payment amount. The recalculated winning bid amount is computed according to the formula of the method where Bidder 1 pays: designated bid amount (here, the second-highest bid amount)+[20%*(winning bid amount−designated bid amount)]. Therefore, Bidder 1 ends up paying: $50+[20%*($100−$50)], which is $60. Bidder 1's total cost (or payment amount) for the auctioned item is $60 plus the $5.00 price-protection fee makes a grand total of $65. Bidder 1 thus pays a total of $65 when Bidder 1 originally submitted a winning bid for $100, thereby winning the auction and saving $35.

### Example 2

Assume the same situation above applies for this example, except Bidder 1 bids $101 and pays the $5.05 price-protection fee. Bidder 2 bids $100, which is the designated bid amount (i.e., the second-highest bid amount). Bidder 1, who is the winning bidder at the end of the auction will pay: $100+[20%*($101−$100)], which is $100.20. Bidder 1's total cost (or payment amount) for the auctioned subject is $100.20 plus the $5.05 price-protection fee makes a final grand total of $105.25. Bidder 1 this time wins the auction but pays $4.25 more than the $101 bid that Bidder 1 originally submitted, therefore suffering a loss because of purchasing the price-protection policy.

### Example 3

Assume yet again the same situation from Example 1 applies, where Bidder 1 bids $100 and pays the $5.00 price-protection fee. Bidder 2 however bids $80. Bidder 1, who is the winning bidder at the end of the auction will pay: $80+[20%*($100−$80)], which is $84. Bidder 1's total costs for the auctioned subject is now the $84 and the $5.00 price-protection fee, which is a final grand total of $89. Bidder 1 this time wins the auction but saves $11 relative to his/her original bid, which is not as significant a discount as compared to Example One.

It will thus be appreciated that exemplary embodiments of the present invention prevent bidders from bidding artificially high amounts in order to win the auction without paying the price he/she bids because the present invention requires the bidder to pay either the full amount he/she bids (Category 1) or the sum of a designated bid amount (e.g., in this case the second highest bid amount) plus a pre-determined percentage of a difference between the winning bid amount and the designated bid amount, plus, in certain embodiments, the price-protection fee. Bidders will thus be deterred from bidding artificially high because the higher the bid amount, the more money the bidder will have to pay. In certain embodiments, the system may require each Category 2 bidder to pay the price-protection fee up front, and to refund the price-protection fee if the Category 2 bidder does not win the auction. This will further deter non-bona-fide bidders. Exemplary embodiments of the present invention will also reflect a more realistic value of what the winning bidder should pay. Bidders who win will also be less likely to believe they overpaid for the auction subject because they will have had the option to bid as a bidding Category two bidder, and potentially been entitled to a final winning amount recalculation. Thus, the “winner's curse” may be substantially reduced for all bidders, and particularly for a Category 2 bidder.

As discussed above with respect to Example 2, and further discussed below with respect to Examples 4-11, purchasing a price-protection policy will not always lower the final payment amount the bidder owes the vendor. For example, if there is a large difference between the winning bid amount and the designated bid amount, then a bidding Category two bidder buying the policy will likely have his/her payment amount substantially decreased with respect to the winning bid amount. However, if there is a small or nominal difference between the winning bid amount and the second highest bid amount, then a Category two bidder buying the policy may end up paying near, at, or more money for the auctioned subject than the winning bid amount. This potential loss associated with the price-protection policy will help prevent bidders from abusing the system and optimize benefit to the vendor. If there were no potential gain involved after adding the price-protection fee, then no bidder would buy a price-protection policy to decrease the amount to which they are required to pay with respect to the winning bid amount. It will be appreciated that in certain embodiments, the systems and methodologies described herein need not include two bidding categories, and may simply offer an auction which utilizes one of the recalculations described herein.

### Example 4

Example 4 shows an auction conducted with three (3) bidders submitting respective bids of $10, $100 and $101, where the vendor chose, prior to submission of any bids or at the beginning of the auction, to have the Highest Bid be the B_{W}, the B_{D} be the Second Highest Bid, the P_{PCT} to be 20%, and the P_{PP} to be 10%. At the close of the auction (e.g., the expiration of a time period predetermined by the buyer for the auction), if the winning bid/bidder is a Category two bid/bidder, then the R_{P}, as determined using Equation 1, with a B_{W} of $101, a B_{D} of $100, a P_{PCT} of 20%, and P_{PP} of 10%, is calculated as follows: R_{P}=$100+[20%*($101−$100)]+[10%*($101)]=$100+$0.20+$10.10=$110.30. The Recalculated Price here is $110.30, so even though the winning bid amount was $101, the winning bidder owes $110.30 for the goods and/or services instead of the $101 actually bid. Had the winning bidder not selected to be a Category two bidder, then he would have only had to pay the $101 actual bid amount for the auctioned good/service. Therefore, it will be appreciated that there is a level of risk in choosing to be a Category two bidder.

### Example 5

Example 5 shows an auction conducted with three (3) bidders submitting respective bids of $30, $50, and $75, where the vendor chose, prior to submission of any bids, to have the Highest Bid be the B_{W}, the B_{D} be the Second Highest Bid, the P_{PCT} to be 15%, and the P_{PP} to be 10%. Therefore, upon closing of the auction, if the winning bid/bidder is a Category two bid/bidder, then the R_{P}, as determined using Equation 1, with a B_{W} of $75, B_{D} of $50, P_{PCT} of 15%, and P_{PP} of 10%, is calculated as follows: R_{P}=$50+[15%*($75−$50)]+[10%*($75)]=$50+$3.75+$7.50=$61.25. The Recalculated Price here is $61.25, which is less than the actual winning bid submitted ($75), thereby demonstrating that it is possible for the Winning Bidder, as a Category two bidder, to receive a final Recalculated Price lower than the actual submitted winning bid.

### Example 6

Example 6 shows an auction conducted with three (3) bidders submitting respective bids of $30, $50, and $75, where the vendor chose, prior to submission of any bids, to have the Highest Bid be the B_{W}, the B_{D} be the Second Highest Bid, the P_{PCT} to be 10%, and the P_{PP} to be 30%. Therefore, upon closing of the auction, if the winning bid/bidder is a Category two bid/bidder, then the R_{P}, as determined using Equation 1, with a B_{W} of $75, B_{D} of $50, P_{PCT} of 10%, and P_{PP} of 30%, is calculated as follows: R_{P}=$50+[10%*($75−$50)]+[30%*($75)]=$50+$2.50+$22.50=$75. The Recalculated Price here is $75, which is equal to the $75 actual bid. In this instance, the Winning Bidder would actually pay the same as his/her actual bid submitted.

### Example 7

Example 7 shows an auction conducted with three (3) bidders submitting respective bids of $50, $100, and $150. In this auction, the vendor chose, prior to submission of any bids, to have the Second Highest Bid be the winning bid B_{W}, the B_{D} be the Third Highest Bid, the P_{PCT} to be 20%, and the P_{PP} to be 5%. At the close of the auction, if the winning bid/bidder is a Category two bid/bidder, then the R_{P}, as determined using Equation 1, with a B_{W} of $100, B_{D} of $50, P_{PCT} of 20%, and P_{PP} of 5%, is calculated as follows: R_{P}=$50+[20%*($100−$50)]+[5%*($100)]=$50+$10+$5=$65. The Recalculated Price here is $65, so even though the winning bid (in this case, the second highest bid) was $100, the bidder-buyer owes $65 for the goods and/or services instead of the $100 actually bid.

### Example 8

Example 8 is an auction where an open reserve price is set by the vendor. In this example, the auction is conducted with three (3) bidders submitting respective bids of $10, $100, and $101. Prior to bidding, the vendor chose to disclose an open reserve price of $10, and chose the Highest Bid to be the B_{W}, the B_{D} be the Second Highest Bid, the P_{PCT} to be 10%, and the P_{PP} to be 10%. Since the reserve price is open to all bidders, the bids received for the auction subject will be equal to or over the reserve price. Any bidding price or amount below the open reserve price will be deemed invalid and will be rejected. At the close of this auction, if the winning bid/bidder is a Category two bid/bidder, then the R_{P}, as determined using Equation 1, with a B_{W} of $101, B_{D} of $100, P_{PCT} of 10%, and P_{PP} of 10%, is calculated as follows: R_{P}=$100+[10%*($101−$100)]+[10%*($101)]=$100+$0.10+$10.10=$110.20. The Recalculated Price here is $110.20, which the bidder-buyer is obligated to pay. It will be appreciated that an auction having an open reserve price may decrease the likelihood of the auction failing for lack of a valid bid.

### Example 9

Example 9 shows an auction where a hidden (i.e., closed or not visible) reserve price is set by the vendor. In this example, the auction is conducted with three (3) bidders submitting respective bids of $10, $90, and $110. Prior to bidding, the vendor chose to set a hidden reserve price of $105 (which is unknown to all bidders), and chose the Highest Bid to be the B_{W}, the B_{D} to be the Second Highest Bid, the P_{PCT} to be 10%, and the P_{PP} to be 10%. In this example, only the $110 bid falls above the $105 reserve price, and the $90 and $10 bids may be deemed failed bids by the system for not reaching or exceeding the $105 reserve price. As the Highest Bid, the $110 bid is deemed the Winning Bid, and in one embodiment, the reserve price of $105 may be deemed the B_{D} for purposes of calculating the R_{P}. Upon the close of the auction, the R_{P} is calculated here, with a B_{W} of $110, B_{D} being the $105 reserve price, P_{PCT} of 10%, and P_{PP} of 10%, as follows: R_{P}=$105+[10%*($110−$105)]+[10%*($110)]=$105+$0.50+$11−$116.50. The buyer is obligated to pay a Recalculated Price in the amount of $116.50 for the goods and/or services, which is greater than the winning bid amount.

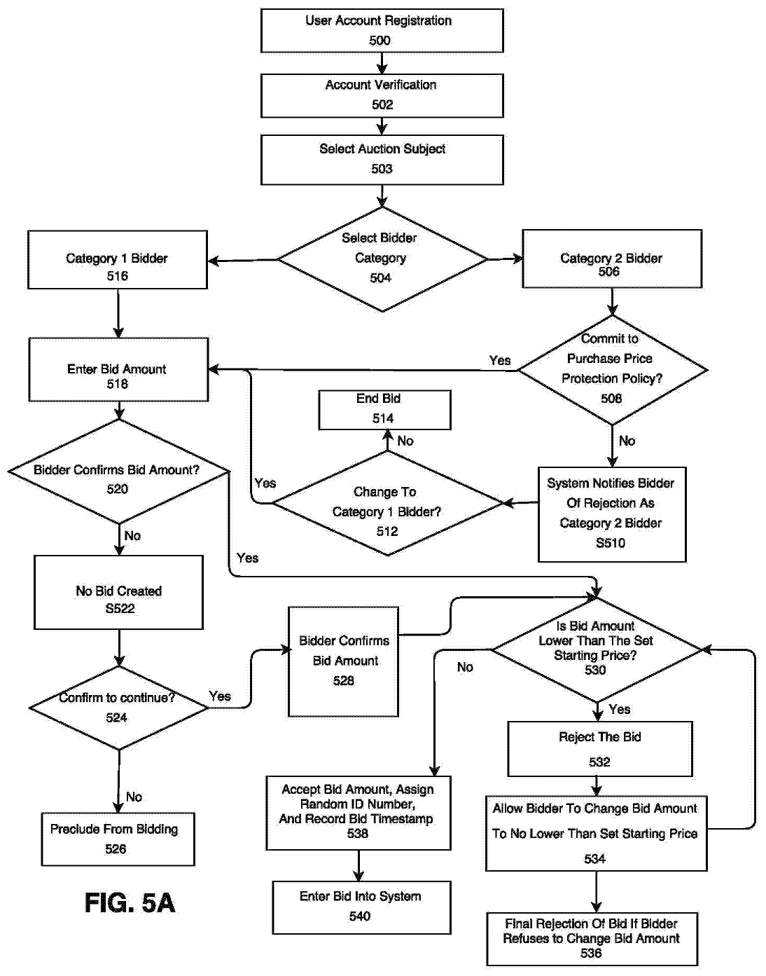

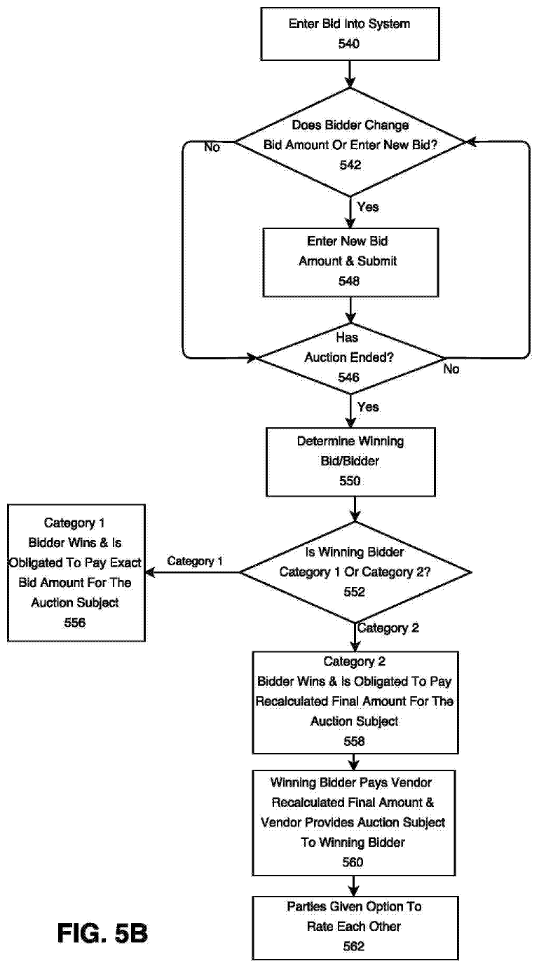

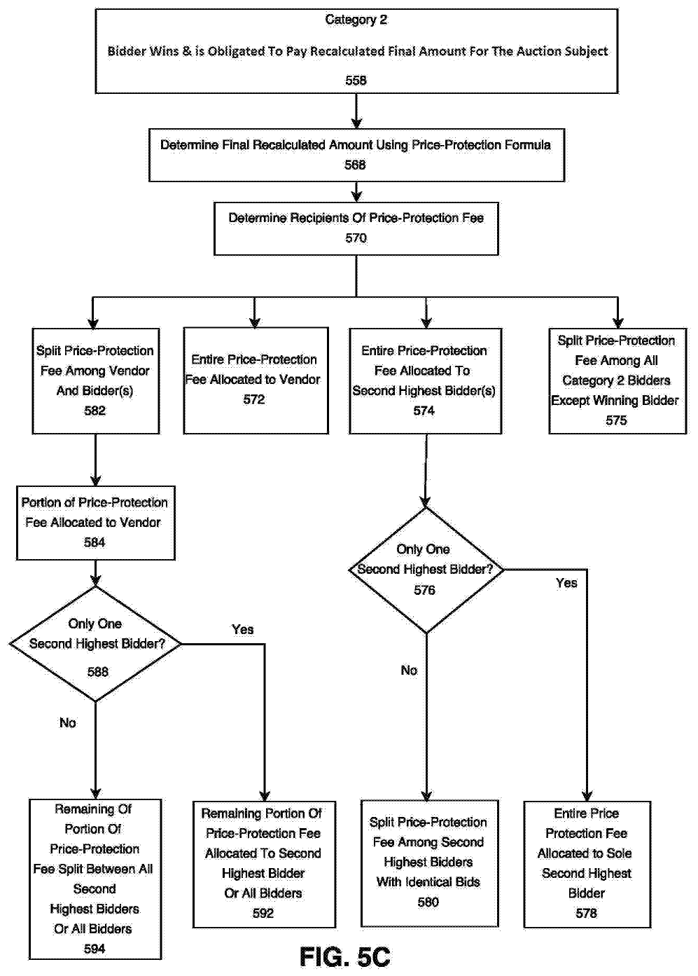

Alternatively, a bid received which is below the reserve price, but is the Second Highest received Bid relative to the winning bid, may be used for the recalculation as the B_{D} rather than the reserve price. In this scenario, the R_{P} is calculated with a B_{W} of $110, B_{D} of $90, P_{PCT} of 10%, and P_{PP} of 10%, as follows: R_{P}=$90+[10%*($110−$90)]+[10%*($110)]−$90+$2+$11=$103. In this scenario, the R_{P} is $103, which is below the reserve price of $105. In certain embodiments, the system may be configured to (i) declare a failed auction and restart the auction, (ii) offer the vendor the opportunity to accept the $103 for the auction subject even though it is below the reserve price of $105, and/or (iii) request or demand the winning bidder pay the reserve price of $105 for the auction subject even though it is above the recalculated price of $103. In such embodiments, the vendor may be entitled to the full amount of the price-protection fee paid by the Buyer. In other words, the amount received by the Vendor is not the same as the amount paid by the Buyer unless the price-protection Fee is fully allocated to the Vendor. Allocation of the price-protection fee is further discussed below with respect to FIG. 5C.

### Example 10

Example 10 is an auction conducted with three (3) bidders submitting respective bids of $100 (Category two), $150 (Category two), and $150 (Category one). In this auction, the vendor chose, prior to submission of any bids, to have the Highest Bid be the B_{W}, the B_{D} be the Second Highest Bid, and to have the P_{PCT} and P_{PP} each be 10%. In a preferred embodiment, the recalculated price can be determined for the Category two bidder to break the tie with the Category one bidder and decide which bidder wins the auction. The Rip, as determined using Equation 1, with a B_{W} of $150, B_{D} of $100, P_{PCT} of 10%, and P_{PP} of 10%, is calculated as follows: R_{P}=$100+[10%*($150−$100)]+[10%*($150)]=$100+$5+$15=$120. The R_{P} here is $120, which is less than the $150 actual bid, and therefore, the winning bidder would be the Category one $150 bidder since the R_{P} of $120 is not the highest amount. The Category one bidder who bid $150 would win. If the R_{P} were calculated to be above $150, then the Category two $150 bidder would have won, and would have been entitled to the auction subject for the recalculated amount. In other embodiments, all bidders who are tied for the highest bid may be asked to resubmit bids, regardless of the category to which they belong, and the highest bid among the resubmitted bids can then be selected as the winning bid. Alternatively, the system can determine the winning bid to be the first submitted bid from the group of equal bids.

### Example 11

Example 11 shows an auction conducted with three (3) Category two bidders submitting respective bids of $100, $150, and $150. In this auction, the vendor chose, prior to submission of any bids, to have the Highest Bid be the B_{W}, and the B_{D} be the Second Highest Bid. The vendor has additionally decided that the P_{PCT} and P_{PP} would be correlated, and selected individually by each Category two bidder prior to submitting their respective bids. The first Category two bidder who submitted a $150 bid, B₂₋₁, selected a 5% P_{PP}, correlating to a 20% P_{PCT} in accordance with predetermined rules set by the buyer. The second Category two bidder who submitted a $150 bid, B₂₋₂, selected a 10% P_{PP}, correlating to a 10% P_{PCT} in accordance with the predetermined rules. Since there are two highest bids that are Category two bids, according to a preferred embodiment, a Recalculated Price can be determined for each of the highest Category two bids to decide which is the B_{W}. The R_{P-1}, for the first bid, B₂₋₁, as determined using Equation 1, with a B_{W} of $150, B_{D} of $100, P_{PCT} of 20%, and P_{PP} of 5%, is calculated as follows: R_{P-1}=$100+[20%*($150−$100)]+[5%*($150)]=$100+$10+$7.50=$117.50. The Recalculated Price for B₂₋₁ here is $117.50. The R_{P-2} for the second bid, B₂₋₂, as determined using Equation 1, with B_{W} of $150, B_{D} of $100, P_{PCT} of 10%, and Pp of 10%, is calculated as follows: R_{P-2}=$100+[10%*($150−$100)]+[10%*($150)]=$100+$5+$15=$120. The R_{P-2} for B₂₋₂ here is $120. In this example, the winning bidder would be the second Category bidder, B₂₋₂ ($120>$117.5), who bid $150, who would be entitled to the auction subject for $120. To potentially reduce multiple bids with the same amounts, the bids may be required to be submitted in dollar amounts with two decimal spaces after the dollar amount (e.g., $25.78).

In the event that the two highest bidders who bid the same price are of the same bidding category (e.g. either two bidding category one bidders or two bidding category two bidders), then the bidders may re-bid again within specific period of time pre-determined by the system. However, if the two highest bidders who bid the same price are of two different categories (e.g. one is a bidding category one bidder and the other bidder is a bidding category two bidder), then the final price for both bidders may be calculated and the bidder with the highest final price may be determined to be the winning bidder in this situation. Determining the winning bidder based on the highest final price in this situation will preserve fairness in that the person paying the most will be the winning bidder.

It will be appreciated that, in the foregoing examples, although numbers or percentages may vary, the principles disclosed herein are within the scope of the present invention. When a Category two bidder is the winning bidder, the percentages for both the Predetermined Percentage and the Price-Protection Fee Percentage can be preset by the vendor. However, in other embodiments, a bidder may be able to select his/her own percentages, or the system may be configured to automatically preset one or both of these percentages. In still other embodiments, the Predetermined Percentage and Price-Protection Fee Percentage may be correlated in accordance with predetermined rules such that setting one automatically sets the other as illustrated above.

For example, if a vendor sets up a sealed bid online auction seeking a good/service, the vendor, bidder, the system, or a non-auction participant may set the Predetermined Percentage (P_{PCT}) to 62%, and the Price-Protection Fee Percentage (P_{PP}) to 8%. Conversely, if the vendor wants to use corresponding percentages, then the Predetermined Percentage can follow a pattern or one or more predetermined correlations relative to the Price-Protection Fee Percentage, or vice versa (i.e., such that the P_{PP} increases as the P_{PCT} increases, or the P_{PP} increases as the P_{PCT} decreases, or the P_{PF} decreases as the P_{PCT} increases, or the P_{PP} decreases as the P_{PCT} decreases). Similarly, the P_{PCT} can follow a pattern or correlations relative to the difference (D) between the winning bid and the next lowest bid (i.e., such that the P_{PCT} decreases as the D increases, or the P_{PCT} decreases as the D decreases, or the PICT increases as the D decreases, or the P_{PCT} increases as the D increases). If the vendor decides to use corresponding percentages, then the vendor, bidder, or the system may set a fixed number for the Price-Protection Fee Percentage which directly corresponds to the Predetermined Percentage. For example, if the vendor sets the Price-Protection Fee Percentage to 1%, then the Predetermined Percentage may automatically be set to 10%. Similarly, if the buyer sets the Price-Protection Percentage Fee to 2%, then the Predetermined Percentage may automatically be set to 9%, and so forth. In embodiments with such correlated percentages, the Predetermined Percentage may be correlated to decrease as a function of the increase of the Price-Protection Fee Percentage. In this manner, as the bidder-buyer agrees to pay out a higher percentage of his/her bid should he/she win, he/she can improve upon the potential recalculation through use of a lower predetermined percentage P_{PCT} of the difference between the Winning Bid and the Second Highest Bid.

In an online sealed bid auction, in accordance with exemplary embodiments of the invention, numerous formulae may be employed for determining a recalculated final price that the bidder (e.g., the buyer) will be obligated to pay in a sealed bid auction for the auctioned goods/services. In these exemplary embodiments, the Recalculated Price amount is designated as R_{P #}, the Winning Bid amount is designated as B_{W}, the Predetermined Percentage is designated as P_{PCT}, the Designated Bid amount relative to the Winning Bid amount is designated as B_{D}, and the Price-Protection Fee Percentage is designated as P_{PP}. The following presents several embodiments illustrating the various price-protection formulas in accordance with the invention. In certain exemplary embodiments of the present invention, as demonstrated by Equations 1-6 and 19-24, a vendor chooses to have the winning bid, B_{W}, be higher than the designated bid, B_{D}, (i.e., a non-winning bid chosen to be used for recalculation purposes), and in certain alternative embodiments, as demonstrated by Equations 7-18, the a vendor chooses to have the designated bid, B_{D}, be higher than the winning bid, B_{W}.

### Sealed Bid Ascending Auction (B_{W}>B_{D}) (Equations 1-6)

### Equation 1

As described above in Examples 1-11, in a preferred embodiment of the present invention, the following price-protection formula may be used after the close of the auction to compute a final Recalculated Price the bidder-buyer has to pay for the good/service auctioned when a Category two bidder wins the auction, which may be represented by the equation:

R_{P1}=[B_{D}]+[P_{PCT}*(B_{W}−B_{D})]+[P_{PP}*(B_{W})]. Equation 1

By way of example, a sealed bid auction may be conducted with three (3) bidders submitting respective bids of $800, $900, and $1000, where the vendor chose, prior to submission of any bids, to have the Highest Bid be the B_{W}, the Second Highest Bid be the B_{D}, 10% be the P_{PCT}, and 5% be the P_{PP}. Upon closing of the auction, if the winning bidder is a Category two bidder, then R_{P1}, using Equation 1 with B_{W}=$1000, B_{D}=$900, P_{PCT}=10%, and P_{PP}=5%, is calculated as follows: R_{P1}=$900+[10%*($1000−$900)]+[5%*($1000)]=$900+$10+$50=$960. The Recalculated Price here is $960, which is less than the $1000 actual winning bid submitted, thereby demonstrating that the Winning Bidder, as a Category two bidder (i.e., by opting for the price-protection policy), may only have to pay a final Recalculated Price that is lower than his/her actual submitted winning bid. Of course, there are also scenarios whereby the winning bidder may end up obligated to pay an amount that is higher than his/her winning bid amount, which demonstrates that there is an element of risk associated with purchasing the price-protection policy.

### Equation 2

In a first alternative embodiment, a Category two bidder-buyer's price-protection plan works in a manner such that the price-protection fee is a separate transaction from the recalculation according to the price-protection formula. Indeed, the fee for the price-protection policy may not even be paid for by the bidder-buyer, but rather be paid for by any number of third-parties or the system itself. After the close of the auction an alternative formula may be used to calculate the final Recalculated Price the bidder-buyer has to pay for the good/service auctioned when the winner is a Category two bidder-buyer. This alternative method separates the price-protection fee for the price-protection policy from the Recalculated Price the bidder-buyer is obligated to pay upon winning the auction, and may be represented by the following equation:

R_{P2}=[B_{D}]+[P_{PCT}*(B_{W}−B_{D})]. Equation 2

By way of example, a sealed bid auction may be conducted with three (3) bidders submitting respective bids of $800, $900, and $1000, where the vendor chose, prior to submission of any bids, to have the Highest Bid be the B_{W}, the Second Highest Bid be the B_{D}, and 50% be the P_{PCT}. In this scenario, the P_{PP} is not relevant for determining the R_{P2}, and upon closing of the auction, if the winning bid/bidder is a Category two bid/bidder, then R_{P2}, using Equation 2, with B_{W}=$1000, B_{D}=$900, and P_{PCT}=10%, is calculated as follows: R_{P2}=$900+[10%*($1000−$900)] $900+$10=$910. The Recalculated Price here is $910, which is less than the actual winning bid submitted, thereby demonstrating again that the Winning Bidder, as a Category two bidder (i.e., by opting for the price-protection policy), may only have to pay a final Recalculated Price that is lower than his/her actual submitted winning bid. Of course, there are also scenarios whereby the winning bidder may end up obligated to pay an amount that is higher than his/her winning bid amount, which demonstrates that there is an element of risk associated with purchasing the price-protection policy. Also, the Price-Protection Fee may be provided (in whole or in part) as a separate transaction by one or more parties other than the buyer (i.e., third-parties, the system, the seller, etc.) as an incentive to attract bidders, or as payment or consideration for requiring the bidder to review advertising materials and/or provide reviews of an advertiser's website, product, etc. In this manner, a winning bidder can further reduce his/her net cost for the auctioned subject by accepting the non-auction participant's offer to pay the price-protection fee in a separate transaction, in whole or in part, in exchange for the winning bidder doing what the non-auction participant needs for a related or unrelated product, service, or website.

### Equation 3

In a second alternative embodiment, a Category two bidder-buyer's price-protection plan may work in a manner such that the Recalculated Price a bidder-buyer has to pay for the auctioned subject is a sum of the designated bid amount and the price-protection fee. That is, after the close of the auction yet another alternative formula may be used to calculate the final Recalculated Price the bidder-buyer has to pay for the good/service auctioned when the winner is a Category two bidder-buyer. This alternative method only uses the price-protection fee and the designated bid amount when computing the Recalculated Price the bidder-buyer is obligated to pay upon winning the auction, and may be represented by the following equation:

R_{P3}=[B_{D}]+[P_{PP}*(B_{W})]. Equation 3

By way of example, a sealed bid auction may be conducted with three (3) bidders submitting respective bids of $800, $900, and $1000, where the vendor chose, prior to submission of any bids, to have the Highest Bid be the B_{W}, the Second Highest Bid be the B_{D}, and 5% be the P_{PP}. In this embodiment, the P_{PCT} is not relevant for determining the R_{P3}, and upon closing of the auction, if the winning bid/bidder is a Category two bid/bidder, then R_{P3}, using Equation 3 with B_{W}=$1000, B_{D}=$900, and P_{PP}=5%, is calculated as follows: R_{P}3=$900+[5%*($1000)]=$900+$50=$950. The Recalculated Price here is now only $950, which is yet again less than the actual bid submitted, thereby demonstrating once again that the Winning Bidder, as a Category two bidder (i.e., by opting for the price-protection policy), may only have to pay a final Recalculated Price that is lower than his/her actual submitted winning bid. However, it will be appreciated that if the designated bid, B_{D}, is relatively close in value to the winning bid and the price-protection fee percentage is relatively high, then the bidder may be obligated to pay significantly more than the winning bid amount.

### Equation 4

In a third alternative embodiment, a Category two bidder-buyer's price-protection plan may work in a manner such that the Recalculated Price a bidder-buyer has to pay for the auctioned subject is a sum of the winning bid amount and the price-protection fee minus a predetermined percentage of the difference between the winning bid amount and the designated bid amount. That is, after the close of the auction yet another alternative formula may be used to calculate the final Recalculated Price the bidder-buyer has to pay for the good/service auctioned when the winner is a Category two bidder-buyer. This alternative method uses the predetermined percentage, the price-protection fee and the designated bid amount when computing the Recalculated Price, and may be represented by the following equation:

R_{P4}=[B_{W}]−[P_{PCT}*(B_{W}−B_{D})]+[P_{PP}*(B_{W})]. Equation 4

By way of example, a sealed bid auction may be conducted with three (3) bidders submitting respective bids of $800, $900, and $1000, where the vendor chose, prior to submission of any bids, to have the Highest Bid be the B_{W}, the Second Highest Bid be the B_{D}, 10% be the P_{PCT}, and 5% be the P_{PP}. Upon closing of the auction, if the winning bid/bidder is a Category two bid/bidder, then Ra, using Equation 4 with B_{W}=$1000, B_{D}=$900, P_{PCT}=10%, and P_{PP}=5%, is calculated as follows: R_{P4}=$1000−[10%*($1000−$900)]+[5%*($1000)]=$1000−$10+$50=$1040. The Recalculated Price here is $1040, which is greater than the actual winning bid amount submitted, thereby demonstrating once again that the Winning Bidder, as a Category two bidder (i.e., by opting for the price-protection policy), may be obligated to pay a final Recalculated Price that is greater than his/her actual submitted winning bid.

### Equation 5

In a fourth alternative embodiment, a Category two bidder-buyer's price-protection plan may work in a manner such that the Recalculated Price a bidder-buyer has to pay for the auctioned subject is the winning bid amount minus a predetermined percentage of the difference between the winning bid amount and the designated bid amount. That is, after the close of the auction yet another alternative formula may be used to calculate the final Recalculated Price the bidder-buyer has to pay for the good/service auctioned when the winner is a Category two bidder-buyer. This alternative method uses the price-protection fee and the winning bid amount when computing the Recalculated Price, and may be represented by the following equation:

R_{P5}=[B_{W}]−[P_{PCT}*(B_{W}−B_{D})] Equation 5

where one or more third-parties contribute at least a portion of the price-protection fee.

By way of example, a sealed bid auction may be conducted with three (3) bidders submitting respective bids of $800, $900, and $1000, where the vendor chose, prior to submission of any bids, to have the Highest Bid be the B_{W}, the Second Highest Bid be the B_{D}, and 10% be the P_{PCT}. In this embodiment, P_{PP} is not relevant for determining the R_{P5}, and upon closing of the auction, if the winning bid/bidder is a Category two bid/bidder, then R_{P5}, using Equation 5 with B_{W}=$1000, B_{D}=$900, and P_{PCT}=10%, is calculated as follows: R_{P5}=$1000−[10%*($1000−$900)] $1000−$10=$990. The Recalculated Price here is $990, which is less than the actual winning bid submitted. Accordingly, it is demonstrated once again that the Winning Bidder, as a Category two bidder (i.e., by opting for the price-protection policy), may only have to pay a final Recalculated Price that is lower than his/her actual submitted winning bid. In this embodiment, the bidder-buyer will also never be obligated to pay more than his/her actual winning bid for the auction subject. In such embodiments, it will be appreciated that the price-protection fee functions as a discount on the winning bid amount, and can be paid for by a non-auction participant as an incentive to attract bidders, or as payment or consideration for requiring the winning bidder to review advertising materials and/or provide reviews of an advertiser's website, product, etc. In this manner, a winning bidder can further reduce his/her net cost for the auctioned subject by accepting the non-auction participant's offer to pay the price-protection fee in a separate transaction, in whole or in part, in exchange for the winning bidder doing what the non-auction participant needs for a related or unrelated product, service, or website.

### Equation 6

In a fifth alternative embodiment, a Category two bidder-buyer's price-protection plan may work in a manner such that the Recalculated Price a bidder-buyer has to pay for the auctioned subject is the winning bid amount plus the price-protection fee, and may be represented by the following equation:

R_{P6}=[B_{W}]+[P_{PP}*(B_{W})] Equation 6

As detailed above in the example for R_{P5}, P_{PCT} and B_{D} are not relevant for determining R_{P6}, and upon closing of the auction, if the winning bid/bidder is a Category two bid/bidder, then R_{P6}, using Equation 6 with B_{W}=$1000, and P_{PP}=5%, is calculated as follows: R_{P6}=$1000+[5%*($1000)]$1000−$50=$1050. The Recalculated Price here is $1050, which is greater than the actual bid submitted. Accordingly, it is demonstrated on that the Winning Bidder, as a Category two bidder (i.e., by opting for the price-protection policy), may have to pay a final Recalculated Price that is higher than his/her actual submitted winning bid. In this embodiment, the bidder-buyer pays the price-protection fee in order to get the benefit of not only playing the auction, but also knowing ahead of time exactly what the total cost will be to him/her since he/she will know the price-protection fee percentage, and the recalculation is based solely on the value of his/her bid. In such embodiments, it will be appreciated that the price-protection fee can similarly be paid by a non-auction participant (e.g., up to a certain cap), or paid for as a promotion by the seller of the auction subject to attract more bidders. If a non-auction participant pays the price-protection fee, then a cap is preferably placed on this amount in order to protect the non-auction participant. If a seller pays the price-protection fee, then the cap may be optional since the seller will ultimately receive the winning bid amount less the price-protection fee amount.

### Sealed Bid Ascending Auction (B_{D}>B_{W}) (Equations 7-12—Potential Right of First Refusal)

### Equation 7

In a sixth alternative embodiment of the present invention, the following price-protection formula is used after the close of the auction to compute a final Recalculated Price the bidder-buyer has to pay for the good/service auctioned when a Category two bidder wins the auction, which may be represented by the equation:

R_{P7}=[B_{D}]−[P_{PCT}*(B_{D}−B_{W})]+[P_{PP}*(B_{W})]. Equation 7

By way of example, a sealed bid auction may be conducted with three (3) bidders submitting respective bids of $800, $900, and $1000, where the vendor chose, prior to submission of any bids, to have the Second Highest Bid be the B_{W}, the Highest Bid be the B_{D}, 10% be the P_{PCT}, and 5% be the P_{PP}. Upon closing of the auction, if the winning bidder is a Category two bidder, then R_{P7}, using Equation 7 with B_{W}=$900, B_{D}=$1000, P_{PCT}=10%, and P_{PP}=5%, is calculated as follows: R_{P7}=$1000−[10%*($1000−$900)]+[5%*($900)]=$1,000−$10+$45=$1,035. The Recalculated Price here is $1,035, which is greater than the $900 actual winning bid submitted. It will be appreciated that in this embodiment, the recalculated price will always be higher than the winning bid amount since the designated bid has a higher rank than the winning bid, only a percentage of the difference between the two is deducted from the designated bid amount, and the price-protection fee is added thereto. In this embodiment, the bidder-buyer pays the price-protection fee in order to get the benefit of playing an auction in which he/she can win the auction as the second highest bidder, but at a cost. In such embodiments, it will be appreciated that the price-protection fee can similarly be paid by a non-auction participant (e.g., up to a certain cap), or paid for as a promotion by the seller of the auction subject to attract more bidders. Additionally, it is contemplated that in such embodiments, since the Recalculated Price will always be higher than the winning bid amount, the winning bidder may be given the option of first refusal. In other words, the winning bidder may be given the option to either accept the win and purchase the auction subject for the recalculated price, or to reject the win and refuse the auction subject at the recalculated price, in which case the bidder who bid the highest bid will be declared the winner of the auction, and will be obligated to purchase the auction subject at the amount of the designated bid. In other embodiments, when the winning bidder rejects the win, the bidder of the designated bid may be entitled to purchase the auction subject at the Recalculated Price refused by the winning bidder rather than the amount of the winning bid.

### Equation 8

In a seventh alternative embodiment, a Category two bidder-buyer's price-protection plan may work in a manner such that the price-protection fee is a separate transaction from the recalculation according to the price-protection formula, and the Recalculated Price a bidder-buyer has to pay for the auctioned subject is calculated by subtracting from the designated bid amount a predetermined percentage of the difference between the winning bid amount and the designated bid amount. Indeed, the fee for the price-protection policy may not even be paid for by the bidder-buyer, but rather be paid for by any number of third-parties or the system itself. After the close of the auction an alternative formula may be used to calculate the final Recalculated Price the bidder-buyer has to pay for the good/service auctioned when the winner is a Category two bidder-buyer. This alternative method separates the price-protection fee for the price-protection policy from the Recalculated Price the bidder-buyer is obligated to pay upon winning the auction, and may be represented by the following equation:

R_{P8}=[B_{D}]−[P_{PCT}*(B_{D}−B_{W})]. Equation 8

By way of example, a sealed bid auction may be conducted with three (3) bidders submitting respective bids of $800, $900, and $1000, where the vendor chose, prior to submission of any bids, to have the Second Highest Bid be the B_{W}, the Highest Bid be the B_{D}, and 10% be the P_{PCT}. In this scenario, the P_{PP} is not relevant for determining the R_{P8}, and upon closing of the auction, if the winning bid/bidder is a Category two bid/bidder, then R_{P8}, using Equation 8 with B_{W}=$900, B_{D}=$1000, and P_{PCT}=10%, is calculated as follows: R_{P8}=$1000−[10%*($1000−$900)]=$1000−$10=$990. The Recalculated Price here is $990, which is greater than the actual bid submitted, thereby demonstrating again that the Winning Bidder, as a Category two bidder (i.e., by opting for the price-protection policy), will have to pay a final Recalculated Price that is higher than his/her actual submitted winning bid. It will be appreciated that in this embodiment, the Recalculated Price will similarly always be higher than the winning bid amount. The price-protection fee may be provided (in whole or in part) as a separate transaction by one or more parties other than the buyer (i.e., third-parties, the system, etc.) as an incentive to attract bidders, or as payment or consideration for requiring the bidder to review advertising materials and/or provide reviews of an advertiser's website, product, etc. Similar to Equation 7, the winning bidder may be given the right of first refusal.

### Equation 9

In an eighth alternative embodiment, a Category two bidder-buyer's price-protection plan may work in a manner such that the Recalculated Price a bidder-buyer has to pay for the auctioned subject is calculated by adding the price-protection fee to the designated bid amount. That is, after the close of the auction yet another alternative formula may be used to calculate the final Recalculated Price the bidder-buyer has to pay for the good/service auctioned when the winner is a Category two bidder-buyer. This alternative method only uses the price-protection fee and the designated bid amount when computing the Recalculated Price the bidder-buyer is obligated to pay upon winning the auction, and may be represented by the following equation:

R_{P9}=[B_{D}]+[P_{PP}*(B_{W})]. Equation 9

By way of example, a sealed bid auction may be conducted with three (3) bidders submitting respective bids of $800, $900, and $1000, where the vendor chose, prior to submission of any bids, to have the Second Highest Bid be the B_{W}, the Highest Bid be the B_{D}, and 5% be the P_{PP}. In this embodiment, the P_{PCT} is not relevant for determining the R_{P9}, and upon closing of the auction, if the winning bid/bidder is a Category two bid/bidder, then R_{P9}, using Equation 15 with B_{W}=$900, B_{D}−$1000, and P_{PP}=5%, is calculated as follows: R_{P9}=$1000+[5%*($900)]=$1000+$45=$1,045. The Recalculated Price here is now only $1,045, which is yet again greater than the actual bid submitted. It will be appreciated that in such embodiments, the winning bidder will always pay more than the amount of his/her winning bid, but can get the benefit of winning the auction with the second highest bid, and potentially be given the option of first refusal as discussed above.

### Equation 10

In a ninth alternative embodiment, a Category two bidder-buyer's price-protection plan may work in a manner such that the Recalculated Price a bidder-buyer has to pay for the auctioned subject is calculated by adding a predetermined percentage of the difference between the designated bid amount and the winning bid amount from to the winning bid amount and the price-protection fee. That is, after the close of the auction yet another alternative formula may be used to calculate the final Recalculated Price the bidder-buyer has to pay for the good/service auctioned when the winner is a Category two bidder-buyer. This alternative method uses the predetermined percentage, the price-protection fee, the winning bid amount, and the designated bid amount when computing the Recalculated Price, and may be represented by the following equation:

R_{P10}=[B_{W}]+[P_{PCT}*(B_{D}−B_{W})]+[P_{PP}*(B_{W})]. Equation 10

By way of example, a sealed bid auction may be conducted with three (3) bidders submitting respective bids of $800, $900, and $1000, where the vendor chose, prior to submission of any bids, to have the Second Highest Bid be the B_{W}, the Highest Bid be the B_{D}, 10% be the P_{PCT}, and 5% be the P_{PP}. Upon closing of the auction, if the winning bid/bidder is a Category two bid/bidder, then R_{P10}, using Equation 16 with B_{W}=$900, B_{D}=$1000, P_{PCT}=10%, and P_{PP}=5%, is calculated as follows: R_{P10}=$900+[10%*($1000−$900)]+[5%*($900)]=$900+$10+$45=$955. The Recalculated Price here is $955, which is greater than the actual winning bid submitted. In this embodiment, the winning bidder will similarly always pay more than the amount of his/her winning bid, but can get the benefit of winning the auction with the second highest bid, and potentially be given the option of first refusal as discussed above.

### Equation 11

In a tenth alternative embodiment, a Category two bidder-buyer's price-protection plan may work in a manner such that the Recalculated Price a bidder-buyer has to pay for the auctioned subject is the winning bid amount plus a predetermined percentage of the difference between the designated bid amount and the winning bid amount. That is, after the close of the auction yet another alternative formula may be used to calculate the final Recalculated Price the bidder-buyer has to pay for the good/service auctioned when the winner is a Category two bidder-buyer. This alternative method uses a predetermined percentage of the difference between the designated bid amount and the winning bid amount and the winning bid amount when computing the Recalculated Price, and may be represented by the following equation:

R_{P11}=[B_{W}]+[P_{PCT}*(B_{D}−B_{W})] Equation 11

where one or more third-parties contribute at least a portion of the price-protection fee.

By way of example, a sealed bid auction may be conducted with three (3) bidders submitting respective bids of $800, $900, and $1000, where the vendor chose, prior to submission of any bids, to have the Second Highest Bid be the B_{W}, the Highest Bid be the B_{D}, 10% be the P_{PCT}. Upon closing of the auction, if the winning bid/bidder is a Category two bid/bidder, then R_{P11}, using Equation 11 with B_{W}=$900, and P_{PCT}=10%, is calculated as follows: R_{P11}=$900+[10%*($1000−$900)]=$900+$10=$910. The Recalculated Price here is $910, which is greater than the actual bid submitted. In this embodiment, the winning bidder will similarly always pay more than the amount of his/her winning bid, but can get the benefit of winning the auction with the second highest bid, and potentially be given the option of first refusal as discussed above.

### Equation 12

In an eleventh alternative embodiment, a Category two bidder-buyer's price-protection plan may work in a manner such that the Recalculated Price a bidder-buyer has to pay for the auctioned subject is the winning bid amount plus the price-protection fee, and again may be represented by the following equation:

R_{P12}=[B_{W}]+[P_{PP}*(B_{W})] Equation 12

By way of example, a sealed bid auction may be conducted with three (3) bidders submitting respective bids of $800, $900, and $1000, where the vendor chose, prior to submission of any bids, to have the Second Highest Bid be the B_{W}, and 5% be the P_{PP}. In this embodiment, P_{PCT} and B_{D} are not relevant for determining the R_{P12}, and upon closing of the auction, if the winning bid/bidder is a Category two bid/bidder, then R_{P12}, using Equation 12 with B_{W}=$900, and P_{PP}=5%, is calculated as follows: R_{P12}=$900+[5%*($900)]=$900+$45=$945. The Recalculated Price here is $945, which is greater than the actual bid submitted. In such embodiments, it will be appreciated that the price-protection fee can be built into the winning bid, in whole or in part, and can similarly be paid by a non-auction participant as discussed above with respect to Equation 5, or paid for as a promotion by the seller of the auction subject to attract more bidders. In such embodiments, the winning bidder will similarly always pay more than the amount of his/her winning bid, but can get the benefit of winning the auction with the second highest bid, and potentially be given the option of first refusal as discussed above.

In an online sealed bid reverse auction, in accordance with exemplary embodiments of the invention, numerous formulae may be employed for determining a recalculated final price that the bidder (e.g., the seller) will receive for auctioned goods/services in exchange for being obligated to provide the auctioned goods/services. In these exemplary embodiments, the Recalculated Price amount is designated as R_{P #}, the Winning Bid amount is designated as B_{W}, the Predetermined Percentage is designated as P_{PCT}, the Designated Bid amount relative to the Winning Bid amount is designated as B_{D}, and the price-protection fee percentage is designated as P_{PP}. The following presents several embodiments illustrating the various price-protection formulas in accordance with the invention.

### Sealed Bid Reverse Auction (B_{D}>B_{W}) (Equations 13-18)

### Equation 13

In a twelfth alternative embodiment of the present invention, the following price-protection formula may be used after close of a sealed bid reverse auction to compute the final Recalculated Price the buyer has to pay to a bidder-seller for the good/service auctioned when a Category two bidder wins, which may be represented by the equation:

R_{P13}=[B_{W}]+[P_{PCT}*(B_{D}−B_{W})]−[P_{PP}*(B_{W})]. Equation 13

By way of example, a sealed bid reverse auction may be conducted with three (3) bidders submitting respective bids of $800, $900, and $1000, where the buyer chose, prior to submission of any bids, to have the Lowest Bid be the B_{W}, the Second Lowest Bid be the B_{D}, 10% be the P_{PCT}, and 5% be the P_{PP}. Upon closing of the reverse auction, if the winning bidder is a Category two bidder, then R_{P13}, using Equation 13 with B_{W}=$800, B_{D}=$900, P_{PCT}=10%, and P_{PP}=5%, is calculated as follows: R_{P7}=$800+[10%*($900−$800)]−[5%*($800)]=$800+$10−$40=$770. The Recalculated Price here is $770, which is less than the $800 actual winning bid submitted, thereby demonstrating that the Winning Bidder-Seller, as a Category two bidder (i.e., by opting for the price-protection policy), receives a final Recalculated Price for the auctioned goods/services that is lower than his/her actual submitted winning bid. This demonstrates that there is an element of risk associated with purchasing the price-protection policy.

### Equation 14

In a thirteenth alternative embodiment, a Category two bidder-seller's price-protection plan works in a manner such that the price-protection fee is a separate transaction from the recalculation according to the price-protection formula. Indeed, the fee for the price-protection policy may not even be paid for by the bidder-seller, but rather be paid for by any number of third-parties or the system itself as consideration for performing requirements of non-auction participant advertisers or the system as discussed above, or simply as a way of attracting more bidders to the reverse auction. After the close of the reverse auction, an alternative formula may be used to calculate the final Recalculated Price at which the bidder-seller has to provide the good/service auctioned for when the winner is a Category two bidder-seller. This alternative method separates the price-protection fee for the price-protection policy from the Recalculated Price at which the bidder-seller is obligated to provide the auctioned subject upon winning the auction, and may be represented by the following equation:

R_{P14}=[B_{W}]+[P_{PCT}*(B_{D}−B_{W})]. Equation 14

By way of example, a sealed bid reverse auction may be conducted with three (3) bidders submitting respective bids of $800, $900, and $1000, where the buyer chose, prior to submission of any bids, to have the Lowest Bid be the B_{W}, the Second Lowest Bid be the B_{D}, and 10% be the P_{PCT}. Upon closing of the reverse auction, if the winning bidder is a Category two bidder, then R_{P14}, using Equation 14 with B_{W}=$800, B_{D}=$900, and P_{PCT}=10%, is calculated as follows: R_{P14}=$800+[10%*($900−$800)]=$800+$10=$810. The Recalculated Price here is $810, which is greater than the $800 actual winning bid submitted, thereby demonstrating that the Winning Bidder, as a Category two bidder (i.e., by opting for the price-protection policy), may receive a final Recalculated Price for the auctioned goods/services that is higher than his/her actual submitted winning bid.

### Equation 15

In a fourteenth alternative embodiment, a Category two bidder-seller's price-protection plan works in a manner such that the price-protection fee is subtracted from the winning bid amount according to the price-protection formula. After the close of the reverse auction, an alternative formula may be used to calculate the final Recalculated Price at which the bidder-seller has to provide the good/service auctioned for when the winner is a Category two bidder-seller. This alternative method reduces the final amount the bidder-seller receives for providing the auctioned good/service by an amount of the price-protection fee, and may be represented by the following equation:

R_{P15}=[B_{W}]−[P_{PP}*(B_{W})] Equation 15

where a non-auction participant may contribute at least a portion of the price-protection fee.

By way of example, a sealed bid reverse auction may be conducted with three (3) bidders submitting respective bids of $800, $900, and $1000, where the buyer chose, prior to submission of any bids, to have the Lowest Bid be the B_{W}, and 5% be the P_{PP}. Upon closing of the reverse auction, if the winning bidder is a Category two bidder, then R_{P15}, using Equation 15 with B_{W}=$800, and P_{PP}=5%, is calculated as follows: R_{P15}=$800−[5%*($800)]=$800−$40=$760. The Recalculated Price here is $760, which is less than the $800 actual winning bid submitted, thereby demonstrating that the Winning Bidder, as a Category two bidder (i.e., by opting for the price-protection policy), may receive a final Recalculated Price for the auctioned goods/services that is lower than his/her actual submitted winning bid. In this embodiment, it will be appreciated that the benefit of the price-protection fee is to the buyer who posts the auction subject, and that a non-auction participant or the system preferably is the provider of payment for the price-protection policy. In other words, in this embodiment, the price-protection fee provides a deduction to the buyer, which helps protect the buyer from having to pay too much for the auction subject if the winning bid is not sufficiently low (e.g., too high above market value). The bidder-seller may pay the price-protection fee in order to participate in the auction, and will know in advance the total recalculated amount should he/she in the reverse auction. If the buyer were to choose a bid other than the lowest bid to be the winning bid (e.g., the second lowest, third lowest, etc.), then the price-protection fee could similarly protect the buyer from having to pay too much for the auction subject.

### Equation 16

In a fifteenth alternative embodiment, a Category two bidder-seller's price-protection plan works in a manner such that the predetermined percentage of the difference between the winning bid and the designated bid and the price-protection fee are subtracted from the designated bid amount according to the price-protection formula. After the close of the reverse auction, an alternative formula may be used to calculate the final Recalculated Price at which the bidder-seller has to provide the good/service auctioned for when the winner is a Category two bidder-seller. This alternative method reduces the final amount the bidder-seller receives for providing the auctioned good/service by an amount of the predetermined percentage of the difference between the winning bid and the designated bid, and may be represented by the following equation:

R_{P16}=[B_{D}]−[P_{PCT}*(B_{D}−B_{W})]−[P_{PP}*(B_{W})] Equation 16

By way of example, an auction may be conducted with three (3) bidders submitting respective bids of $800, $900, and $1000, where the buyer chose, prior to submission of any bids, to have the Lowest Bid be the B_{W}, the B_{D} be the Second Lowest Bid, the Peer to be 10%, and the P_{PP} to be 5%. Upon closing of the reverse auction, if the winning bidder is a Category two bidder, then the R_{P16}, using Equation 16 with a B_{W} of $800, B_{D} of $900, P_{PCT} of 10%, and P_{PP} of 5%, is calculated as follows: R_{P16}=$900−[10%*($900−$800)]−[5%*($800)]=$900−$10−$40=$850. The Recalculated Price here is $850, which is greater than the $800 actual winning bid submitted, thereby demonstrating that the Winning Bidder, as a Category two bidder (i.e., by opting for the price-protection policy), may receive a final Recalculated Price for the auctioned goods/services that is higher than his/her actual submitted winning bid.

### Equation 17

In a sixteenth alternative embodiment, a Category two bidder-seller's price-protection plan works in a manner such that the price-protection fee is a separate transaction from the recalculation according to the price-protection formula. Indeed, the fee for the price-protection policy may not even be paid for by the bidder-seller, but rather by any number of third-parties and/or the system itself. After the close of the reverse auction an alternative formula may be used to calculate the final Recalculated Price at which the bidder-seller has to provide the good/service auctioned for when the winner is a Category two bidder-seller. This alternative method separates the price-protection fee for the price-protection policy from the Recalculated Price at which the bidder-seller is obligated to provide the auctioned subject upon winning the auction, and may be represented by the following equation:

R_{P17}=[B_{D}]−[P_{PCT}*(B_{D}−B_{W})] Equation 17

By way of example, a sealed bid reverse auction may be conducted with three (3) bidders submitting respective bids of $800, $900, and $1000, where the buyer chose, prior to submission of any bids, to have the Lowest Bid be the B_{W}, the Second Lowest Bid be the B_{D}, and 10% be the P_{PCT}. Upon closing of the reverse auction, if the winning bidder is a Category two bidder, then R_{P17}, using Equation 17 with B_{W}=$800, B_{D}=$900, and P_{PCT}=10%, is calculated as follows: R_{P17}=$900−[10%*($900−$800)]=$900−$10=$890. The Recalculated Price here is $890, which is more than the $800 actual winning bid submitted, thereby demonstrating that the Winning Bidder, as a Category two bidder (i.e., by opting for the price-protection policy), receives a final Recalculated Price for the auctioned goods/services that is higher than his/her actual submitted winning bid. It will be appreciated that in this embodiment, the seller will always be entitled to a Recalculated Price that is equal to or higher than his/her bid. Such embodiments provide a benefit to the bidder-seller, and may be attractive for the Buyer to use in order to attract more sellers to the reverse auction.

### Equation 18

In a seventeenth alternative embodiment, a Category two bidder-seller's price-protection plan works in a manner such that the price-protection fee is subtracted from the designated bid amount according to the price-protection formula. After the close of the reverse auction, an alternative formula may be used to calculate the final Recalculated Price at which the bidder-seller has to provide the good/service auctioned for when the winner is a Category two bidder-seller. This alternative method potentially increases the final amount the bidder-seller receives for providing the auctioned good/service, and may be represented by the following equation:

R_{P18}=[B_{D}]−[P_{PP}*(B_{W})] Equation 18

where one or more third-parties, the system, and/or the buyer can optionally contribute to at least a portion of the price-protection fee.

By way of example, a sealed bid reverse auction may be conducted with three (3) bidders submitting respective bids of $800, $900, and $1000, where the buyer chose, prior to submission of any bids, to have the Lowest Bid be the B_{W}, the Second Lowest Bid be the B_{D}, and 5% be the Pr. Upon closing of the reverse auction, if the winning bidder is a Category two bidder, then R_{P18}, using Equation 18 with B_{W}=$800, B_{D}=$900, and P_{PP}=5%, is calculated as follows: R_{P18}=$900−[5%*($800)]=$900−$40=$860. The Recalculated Price here is $860, which is greater than the $800 actual winning bid submitted, thereby demonstrating that the Winning Bidder, as a Category two bidder (i.e., by opting for the price-protection policy), receives a final Recalculated Price for the auctioned goods/services that is greater than his/her actual submitted winning bid by the increase to the higher designated bid amount minus the price-protection fee. It will be appreciated that in such embodiments, when the bid spread between the winning bid and the designated bid are small and/or the price-protection fee percentage is large, the Recalculated Price may not be to the bidder-seller's advantage.

### Sealed Bid Reverse Auction (B_{W}>B_{D}) (Equations 19-24—Potential Right of First Refusal)

### Equation 19

In an eighteenth alternative embodiment of the present invention, the following price-protection formula may be used after close of a sealed bid reverse auction to compute the final Recalculated Price the buyer has to pay to a bidder-seller for the good/service auctioned when a Category two bidder wins, which may be represented by the equation:

R_{P19}=[B_{D}]+[P_{PCT}*(B_{W}−B_{D})]−[P_{PP}*(B_{W})] Equation 19

By way of example, a sealed bid reverse auction may be conducted with three (3) bidders submitting respective bids of $800, $900, and $1000, where the buyer chose, prior to submission of any bids, to have the Second Lowest Bid be the B_{W}, the Lowest Bid be the B_{D}, 10% be the P_{PCT}, and 5% be the P_{PP}. Upon closing of the reverse auction, if the winning bidder is a Category two bidder, then R_{P19}, using Equation 19 with B_{D}=$800, B_{W}=$900, P_{PCT}=10%, and P_{PP}=5%, is calculated as follows: R_{P19}=$800+[10%*($900−$800)]−[5%*($900)]=$800+$10−$45=$765. The Recalculated Price here is $765, which is less than the $900 actual winning bid submitted, thereby demonstrating that the Winning Bidder-Seller, as a Category two bidder (i.e., by opting for the price-protection policy), receives a final Recalculated Price for the auctioned goods/services that is less than his/her actual submitted winning bid. It will be appreciated that in such embodiments, the winning bidder will always receive less than the amount of his/her winning bid, but can get the benefit of winning the auction with the second lowest bid, and potentially be given the option of first refusal as discussed above. In the event the option of first refusal is given to the winning bidder and the winning bidder declines his/her right to win the auction, the bidder of the designated bid can be declared the winner of the reverse auction, and may be obligated to provide the auction subject for that amount (e.g., for the amount of the designated bid or the amount of the Recalculated Price turned down by the winning bidder depending on the predetermined rules).

### Equation 20

In a nineteenth alternative embodiment, a Category two bidder-seller's price-protection plan works in a manner such that the price-protection fee is a separate transaction from the recalculation according to the price-protection formula. Indeed, the fee for the price-protection policy may not even be paid for by the bidder-seller, but rather be paid for by any number of third-parties or the system itself as consideration for performing requirements of third parties such as advertisers or the system as discussed above, or simply as a way of attracting more bidders to the reverse auction. After the close of the auction, an alternative formula may be used to calculate the final Recalculated Price at which the bidder-seller has to provide the good/service auctioned for when the winner is a Category two bidder-seller. This alternative method separates the price-protection fee for the price-protection policy from the Recalculated Price at which the bidder-seller is obligated to provide the auctioned subject upon winning the auction, and may be represented by the following equation:

R_{P20}=[B_{D}]+[P_{PCT}*(B_{W}−B_{D})]. Equation 20

By way of example, a sealed bid reverse auction may be conducted with three (3) bidders submitting respective bids of $800, $900, and $1000, where the buyer chose, prior to submission of any bids, to have the Second Lowest Bid be the B_{W}, the Lowest Bid be the B_{D}, and 10% be the P_{PCT}. Upon closing of the reverse auction, if the winning bidder is a Category two bidder, then R_{P20}, using Equation 20 with B_{W}=$900, B_{D}=$800, and P_{PCT}=10%, is calculated as follows: R_{P20}=$800+[10%*($900−$800)]=$800+$10=$810. The Recalculated Price here is $810, which is less than the $900 actual winning bid submitted, thereby demonstrating that the Winning Bidder, as a Category two bidder (i.e., by opting for the price-protection policy), receives a final Recalculated Price for the auctioned goods/services that is lower than his/her actual submitted winning bid. It will be appreciated that in such embodiments, the winning bidder will always receive less than the amount of his/her winning bid, but can get the benefit of winning the auction with the second lowest bid, and potentially be given the option of first refusal as discussed above. In the event the option of first refusal is given to the winning bidder and the winning bidder declines his/her right to win the auction, the bidder of the designated bid can be declared the winner of the reverse auction, and may be obligated to provide the auction subject for that amount (e.g., for the amount of the designated bid or the amount of the Recalculated Price turned down by the winning bidder depending on the predetermined rules).

### Equation 21

In a twentieth alternative embodiment, a Category two bidder-seller's price-protection plan works in a manner such that the price-protection fee is subtracted from the designated bid amount according to the price-protection formula. After the close of the auction an alternative formula may be used to calculate the final Recalculated Price at which the bidder-seller has to provide the good/service auctioned for when the winner is a Category two bidder-seller. This alternative method reduces the final amount the bidder-seller receives for providing the auctioned good/service by an amount of the price-protection fee, and may be represented by the following equation:

R_{P21}=[B_{D}]−[P_{PP}*(B_{W})] Equation 21

where a non-auction participant contributes at least a portion of the price-protection fee.

By way of example, a sealed bid reverse auction may be conducted with three (3) bidders submitting respective bids of $800, $900, and $1000, where the buyer chose, prior to submission of any bids, to have the Second Lowest Bid be the B_{W}, the Lowest Bid be the B_{D}, and 5% be the P_{PP}. Upon closing of the reverse auction, if the winning bidder is a Category two bidder, then R_{P9}, using Equation 21 with B_{W}=$900, B_{D}=$800, and P_{PP}=5%, is calculated as follows: R_{P21}=$800−[5%*($900)]=$800−$45=$755. The Recalculated Price here is $755, which is less than the $900 actual winning bid submitted, thereby demonstrating that the Winning Bidder, as a Category two bidder (i.e., by opting for the price-protection policy), receives a final Recalculated Price for the auctioned goods/services that is lower than his/her actual submitted winning bid. In this embodiment, it will be appreciated that the benefit of the price-protection fee is to the buyer who posts the auction subject, and that a non-auction participant or the system preferably is the provider of payment for the price-protection policy. It will be appreciated that in such embodiments, the winning bidder will always receive less than the amount of his/her winning bid, but can get the benefit of winning the auction with the second lowest bid, and potentially be given the option of first refusal as discussed above. In the event the option of first refusal is given to the winning bidder and the winning bidder declines his/her right to win the auction, the bidder of the designated bid can be declared the winner of the reverse auction, and may be obligated to provide the auction subject for that amount (e.g., for the amount of the designated bid or the amount of the Recalculated Price turned down by the winning bidder depending on the predetermined rules).

### Equation 22

In a twenty-first alternative embodiment, a Category two bidder-seller's price-protection plan works in a manner such that the price-protection fee and the predetermined percentage of the difference between the winning bid and the designated bid are subtracted from the winning bid amount according to the price-protection formula. After the close of the auction an alternative formula may be used to calculate the final Recalculated Price at which the bidder-seller has to provide the good/service auctioned for when the winner is a Category two bidder-seller. This alternative method reduces the final amount the bidder-seller receives for providing the auctioned good/service by an amount of the predetermined percentage of the difference between the winning bid and the designated bid, and may be represented by the following equation:

R_{P22}=[B_{W}]−[P_{PCT}*(B_{W}−B_{D})]−[P_{PP}*(B_{W})] Equation 22

where B_{W} cannot be the lowest amount of the sealed bids, and the buyer pays at least a portion of the price-protection fee.

By way of example, an auction may be conducted with three (3) bidders submitting respective bids of $800, $900, and $1000, where the buyer chose, prior to submission of any bids, to have the Second Lowest Bid be the B_{W}, the B_{D} be the Lowest Bid, the P_{PCT} to be 10%, and the P_{PP} to be 5%. Upon closing of the reverse auction, if the winning bidder is a Category two bidder, then the R_{P22}, using Equation 22 with a B_{W} of $900, B_{D} of $800, P_{PCT} of 10%, and P_{PP} of 5%, is calculated as follows: R_{P22}=$900−[10%*($900−$800)]−[5%*($900)]=$900−$10−$45=$845. The Recalculated Price here is $845, which is less than the $900 actual winning bid submitted, thereby demonstrating that the Winning Bidder, as a Category two bidder (i.e., by opting for the price-protection policy), receives a final Recalculated Price for the auctioned goods/services that is lower than his/her actual submitted winning bid, which demonstrates that there is an element of risk associated with purchasing the price-protection policy. It will be appreciated that in such embodiments, the winning bidder will always receive less than the amount of his/her winning bid, but can get the benefit of winning the auction with the second lowest bid, and potentially be given the option of first refusal as discussed above. In the event the option of first refusal is given to the winning bidder and the winning bidder declines his/her right to win the auction, the bidder of the designated bid can be declared the winner of the reverse auction, and may be obligated to provide the auction subject for that amount (e.g., for the amount of the designated bid or the amount of the Recalculated Price turned down by the winning bidder depending on the predetermined rules).

### Equation 23

In a twenty-second alternative embodiment, a Category two bidder-seller's price-protection plan works in a manner such that the price-protection fee is a separate transaction from the recalculation according to the price-protection formula. Indeed, the fee for the price-protection policy may not even be paid for by the bidder-seller, but rather by any number of third-parties and/or the system itself. After the close of the auction an alternative formula may be used to calculate the final Recalculated Price at which the bidder-seller has to provide the good/service auctioned for when the winner is a Category two bidder-seller. This alternative method separates the price-protection fee for the price-protection policy from the Recalculated Price at which the bidder-seller is obligated to provide the auctioned subject upon winning the auction, and may be represented by the following equation:

R_{P23}=[B_{W}]−[P_{PCT}*(B_{W}−B_{D})] Equation 23

where B_{W} cannot be the lowest of the sealed bids.

By way of example, a sealed bid reverse auction may be conducted with three (3) bidders submitting respective bids of $800, $900, and $1000, where the buyer chose, prior to submission of any bids, to have the Second Lowest Bid be the B_{W}, the Lowest Bid be the B_{D}, and 10% be the P_{PCT}. Upon closing of the reverse auction, if the winning bidder is a Category two bidder, then R_{P23}, using Equation 23 with B_{W}=$900, B_{D}=$800, and P_{PCT}=10%, is calculated as follows: R_{P23}=$900−[10%*($900−$800)]=$900−$10=$890. The Recalculated Price here is $890, which is less than the $900 actual winning bid submitted, thereby demonstrating that the Winning Bidder, as a Category two bidder (i.e., by opting for the price-protection policy), receives a final Recalculated Price for the auctioned goods/services that is lower than his/her actual submitted winning bid, but still higher than the lowest bid. Thus, the bidder-seller gets the benefit of being able to win the auction with the second lowest bid rather than the lowest bid, but pays a price for it (e.g., by having to provide the auction subject for $10 less than the amount of his/her winning bid). It will be appreciated that in such embodiments, the winning bidder will always receive less than the amount of his/her winning bid, but can get the benefit of winning the auction with the second lowest bid, and potentially be given the option of first refusal as discussed above. In the event the option of first refusal is given to the winning bidder and the winning bidder declines his/her right to win the auction, the bidder of the designated bid can be declared the winner of the reverse auction, and may be obligated to provide the auction subject for that amount (e.g., for the amount of the designated bid or the amount of the Recalculated Price turned down by the winning bidder depending on the predetermined rules).

### Equation 24

In a twenty-third alternative embodiment, a Category two bidder-seller's price-protection plan works in a manner such that the price-protection fee is subtracted from the winning bid amount according to the price-protection formula. After the close of the auction the alternative formula may be used to calculate the final Recalculated Price at which the bidder-seller has to provide the good/service auctioned for when the winner is a Category two bidder-seller. This alternative method may be represented by the following equation:

R_{P24}=[B_{W}]−[P_{PP}*(B_{W})] Equation 24

where one or more third-parties, the system, and/or the buyer contribute to at least a portion of the price-protection fee.

By way of example, a sealed bid reverse auction may be conducted with three (3) bidders submitting respective bids of $800, $900, and $1000, where the buyer chose, prior to submission of any bids, to have the Second Lowest Bid be the B_{W}, the Lowest Bid be the B_{D}, and 5% be the P_{PP}. Upon closing of the reverse auction, if the winning bidder is a Category two bidder, then R_{P24}, using Equation 24 with B_{W}=$900, B_{D}=$800, and P_{PP}=5%, is calculated as follows: R_{P24}=$900−[5%*($900)]=$900−$45=$855. The Recalculated Price here is $855, which is less than the $900 actual winning bid submitted, thereby demonstrating that the Winning Bidder, as a Category two bidder (i.e., by opting for the price-protection policy), receives a final Recalculated Price for the auctioned goods/services that is lower than his/her actual submitted winning bid. It will be appreciated that in such embodiments, the winning bidder will always receive less than the amount of his/her winning bid, but can get the benefit of winning the auction with the second lowest bid, and potentially be given the option of first refusal as discussed above. In the event the option of first refusal is given to the winning bidder and the winning bidder declines his/her right to win the auction, the bidder of the designated bid can be declared the winner of the reverse auction, and may be obligated to provide the auction subject for that amount (e.g., for the amount of the designated bid or the amount of the Recalculated Price turned down by the winning bidder depending on the predetermined rules).

After a bidder and vendor complete a transaction, it is helpful for both parties to provide feedback to each other to better improve the auction services. Usually, this is done through ratings and/or comments. After the auction ends and both sides complete the transaction through payment and delivery of the auctioned subject, if applicable. Exemplary embodiments of the system will allow vendors and bidders to rate each other and provide feedback related to the transaction. The system will provide the opportunity for both parties to contact each other prior to submitting negative ratings/reviews. This will provide for better communication between the parties and the opportunity to solve any problems and concerns and decrease the chances of negative reviews.

Notifications may be sent by the system through the server to both vendor computing devices and/or bidder computing devices through emails, instant messages, voice messages, etc. when necessary to alert them of different occurrences, including but not limited to a successfully submitted bid, relevant time duration for the auction, rejected bids, auction wins, auction results, etc. The system may be used to provide a platform to facilitate at least one or multi-sided matching auction markets, where bidders may simultaneously bid from one or multiple vendors and vendors may solicit to one or multiple bidders, wherein each transaction is facilitated against a fee or commission.

The system also comprises means for determining the costs associated with one or more risk elements of the transaction, wherein the means utilize the bidders' information to identify the highest bid and the second-highest bid amount, the cost of the price-protection policy for bidding category two users, as well as the final amount the winning bidder has to pay. In addition, the system or the platform may charge a certain percentage of service fees for providing auction services. The present invention may also utilize a data verification module in online auction. This would verify at least four major data sets through the system: (i) identify bidders and vendors; (ii) identify that data submitted to the auction is accurate; (iii) verify the winning bidder; and (iv) verify completion of transaction, etc.

Another aspect of an exemplary embodiment of the invention relates to ID Verification. One of the problems that arises in online auctions is that of information asymmetry due to the fact that transactions are completely anonymous. To resolve the anonymity problem, the system may allow vendors and bidders to become “ID Verified” by paying a small fee to have their identity confirmed by a credit information company. Doing so may reassure the users that their counterparties, bidders and vendors, are verified since their identity is known, and there is more assurance that the users could be tracked down should a problem arise. Once verification that the data submitted to the auction is correct, the bids are received and safeguarded. All bids received before the time set for the opening of bids are kept secure. The bids are not opened or viewed by seller or administrator and remain in restricted-access electronic bid box. If the bid was withdrawn, it remains in the bid box until the auction is finished. Before the bids are opened, information concerning the identity and number of bids received is made available only to the administrator of the auction. The bid opening time is preset by the vendor before the auction. The system verifies the accuracy of the bids. All bids shall be submitted in acceptable numerical format. The bids are verified by the system in the manner that precludes the possibility of a substitution, addition, deletion, or alteration in the bids. Also, all bids may be recorded in database 104. All bids are completed and certified as to their accuracy by the bid system as soon as bid verification is complete. Where bid items are too numerous to warrant complete recording of all bids, abstract entries for individual bids may be limited to item numbers and bid prices. Bids shall be available for viewing wherein the real IDs of the bidders are coded/encoded.

After bids have been opened, an award may be made to that responsible bidder who submitted the highest responsive bid according to exemplary embodiments of the present invention, unless there is a compelling reason to reject all bids and cancel the auction. Every effort shall be made to anticipate changes before the opening of the auction and to notify all prospective bidders of any resulting modification or cancellation of the auctioned item. This will permit bidders to change or withdraw their bids and prevent unnecessary exposure of bid prices. As a general rule, after the opening of bids, an auction should not be cancelled and re-solicited, and award should be made on the initial bid invitation for bids and the additional quantity should be treated as a new acquisition. Invitations for bids may be cancelled and all bids rejected before award but after opening when, it has been determined that: (i) specifications have been revised; (ii) the auctioned subject of value is no longer available due to circumstances beyond the auction host's control; (iii) no bids have been received; or (iv) for other reasons where cancellation is clearly in the public's interest. Verification of the completion of a transaction may be accomplished by requiring the winning bidder and the auction host to confirm with the system that a transaction was successfully completed by both parties, including, for example, that the auction subject and the payment therefor have been exchanged.

Should administrative difficulties be encountered after bid opening that may delay award beyond bidders' acceptance periods, notice should be provided to all bidders of the rejection of all bids. When the system determines the necessity to reject all bids, the system will notify each bidder that all bids have been rejected and shall state the reason for such action. If a bid received by the system is unreadable to a degree that conformance to the essential requirements of the bid invitation cannot be ascertained, then the system can be configured to notify the bidder that the bid will be rejected due to non-compliance. The system can also be configured to examine all bids for mistakes and, if any mistakes are identified, notify the bidders to correct the mistakes before their bids are accepted. Mistakes can include but are not limited to obvious misplacement of a decimal point, etc.

Referring now to FIGS. 1A through 4, shown is a server 102 in communication with at least one of a plurality of vendors at vendor computing device 108, 114 and at least one of a plurality of registered bidders at bidder computing device 106/110/112) through a communication network (e.g., Internet 100). Vendor computing device 108, 114 is authenticated by server 102 to create new auction subjects. After successful authentication and authorization, the required contents are displayed (e.g., a browser or content display system) to the vendor for creating the new auction subjects. Server 102 receives an auction request for an auctioned subject from a vendor computing device 108, 114. The auction request has at least a description of the auctioned subject and a time duration of the auction inputted by at least one registered vendor into vendor computing device 108, 114. The server uses inventory management (e.g. non-volatile database 104 memory) to persist the auctioned subject. Register bidders request server 102 to display the auction subjects through a search service or filter service based on the categories in which they are interested. CPU 103 in server 102 executes the instructions based on the search or filter service, and queries the relevant subjects in the inventory management database 104, and presents auction subjects based on the auction request to the plurality of registered bidders at bidder computing device 106, 110, 112 (e.g. via a browser or mobile applications). Vendor and bidder computing devices 106, 108, 110, 112, 114 may each include a location identifier capable of determining the location of the computing device. Such location identifier may be instantiated through processing of received GPS data from location-based or geo-aware resources of the computing device. Additionally, the location identifier can receive GPS data from other applications or programs that operate on the computing device. For example, computing devices 106, 108, 110, 112, 114 may communicate with one or more other applications using one or more application program interfaces (APIs). The application can then use the location information to cause a user interface component to configure a user interface framework based on the location information. In this manner, the computing devices can communicate location-based services (LBS) data to one or more computing systems.

Server 102 authenticates the bidders before they submit their sealed bids. Such validations may include, for example, ensuring that the vendor of the auctioned subject cannot submit a bid, that the bid amounts are in decimal format, etc. At least one sealed bid may be received via bidder computing device 106, 110, 112 during the time duration of the auction and communicated to server 102, wherein the at least one sealed bid includes a bid amount for the auctioned subject. Random bidder ID 202 may be assigned by server 102 to each of the at least one sealed bid received in a bidder computing device 106/110/112 during the time duration of the auction. Data record 210 for each of the at least one sealed bid is stored in the server. Data record 210 contains at least auction subject ID 200, status 201, random bidder ID 202, actual bidder ID 204, timestamp 206, bid amount 208, other information 209, and commit ID 211. Server 102 is in communication with at least one of a plurality of registered vendors and at least one of a plurality of registered bidders through the communication network (e.g., Internet 100). The system determines the winning bid at the end of the time duration of the auction according to data record 210 for each of the at least one sealed bids. The server may have database 104. While in preferred embodiments, the ID assigned to each bid is random, in certain embodiments, the bidder ID assigned to the sealed bid and/or bidder thereof may not be random, and may instead be a same ID previously assigned. It will be appreciated that random ID assignments help avoid emotional decisions caused by any previous personal interactions among bidders or any personal knowledge previously gleaned by them.

It will be appreciated that auction systems described herein may include multiple vendor computing devices 108, 114 and bidding computing devices 106, 110, 112 connected to the Internet 100 and in communication with server 102 via a web browser, mobile application, text messaging, or any other form of data communication. Server 102 may include a CPU 103, memory 105 such as RAM, and network interface 107. CPU 103 processes instructions stored in memory 105, in accordance with operating system and auction information stored in database 104 or other storage medium such as a hard disk or solid state drive. Database 104 may additionally or alternatively store data for the auction, such as information related to auction listings, bids, and bidders (further discussed below). Network interface 107 of server 102 enables server 102 to communicate with Network/Internet 100 for operative communication with various user devices.

Referring to FIG. 1C, in certain embodiments, a computer system 150 may be provided in addition to or as an alternative to server 102. Computer system 150 is broadly used herein to describe any computing device that can store and independently run one or more programs. Each computer system 150 may include a communication interface 164 coupled to bus 156. Communication interface 164 provides two-way communication between computer systems 150. Communication interface 164 of a respective computer system 150 transmits and receives electrical, electromagnetic or optical signals that include data streams representing various types of signal information, e.g., instructions, messages and data. A communication link 165 may link one computer system 150 with another computer system 150. For example, communication link 165 may be a LAN, in which case communication interface 164 may be a LAN card, or communication link 165 may be a PSTN, in which case the communication interface 164 may be an integrated services digital network (ISDN) card or a modem, or the communication link 165 may be the Internet, in which case communication interface 164 may be a dial-up, cable or wireless modem. Computer system 150 may transmit and receive messages, data, and instructions, including program, i.e., application, code, through its respective communication link 165 and communication interface 164. Received program code may be executed by the respective processor(s) 157 as it is received, and/or stored in the storage device 160, or other associated non-volatile media, for later execution.

Computer system 150 may operate in conjunction with a data storage system 181 that contains a database 182 (or 104) readily accessible by computer system 150. Computer system 150 communicates with data storage system 181 through a data interface 183. Data interface 183, which is coupled to bus 156, transmits and receives electrical, electromagnetic or optical signals that include data streams representing various types of signal information, e.g., instructions, messages and data. The functions of data interface 183 may be performed by communication interface 164.

Computer system 150 includes bus 156 or other communication mechanism for communicating instructions, messages and data, collectively, information, and one or more processors 157 coupled with bus 156 for processing information. Computer system 150 also includes a main memory 158, such as a random access memory (RAM) or other dynamic storage device, coupled to bus 156 for storing dynamic data and instructions to be executed by processor(s) 157. Main memory 158 may also be used for storing temporary data, i.e., variables, or other intermediate information during execution of instructions by processor(s) 157. Computer system 150 may further include read only memory (ROM) 159 or other static storage device coupled to bus 156 for storing static data and instructions for processor(s) 157.

In certain embodiments, computer system 150 may perform specific operations by respective processor(s) 157 executing one or more sequences of one or more instructions contained in main memory 158. Such instructions may be read into main memory 158 from another computer-usable medium, such as ROM 159 or storage device 160. Execution of the sequences of instructions contained in main memory 158 causes processor(s) 157 to perform the processes described herein. In alternative embodiments, hard-wired circuitry may be used in place of or in combination with software instructions. Thus, embodiments described herein are not limited to any specific combination of hardware circuitry and/or software.

The term “computer-usable medium,” as used herein, may refer to any medium that provides information or is usable by processor(s) 157. Such a medium may take many forms, including, but not limited to, non-volatile, volatile and transmission media. Non-volatile media, i.e., media that can retain information in the absence of power, includes ROM 159, CD ROM, magnetic tape, and magnetic discs. Volatile media, i.e., media that cannot retain information in the absence of power, includes main memory 158. Transmission media includes coaxial cables, copper wire and fiber optics, including the wires that comprise the bus 1206. Transmission media can also take the form of carrier waves; i.e., electromagnetic waves that can be modulated, as in frequency, amplitude or phase, to transmit information signals. Additionally, transmission media can take the form of acoustic or light waves, such as those generated during radio wave and infrared data communications. Computing system 150 may be utilized in conjunction with bidder computing devices 106, 110, 112 and vendor computing devices 108, 114 to implement various methodologies described herein.

Computing system 150 may communicate wirelessly through the communications interface 164, which may include digital signal processing circuitry where necessary. Communications interface 164 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication may occur, for example, through a transceiver using a radio-frequency. Short-range communication may also occur, such as via a Bluetooth, Wi-Fi, or other such transceiver (not shown). A GPS (Global Positioning System) receiver module may be provided which provides additional navigation and location-related wireless data to the computing devices. The mobile computing devices 106-114 may also communicate audibly using an audio codec, which may receive spoken information from a user and convert it to usable digital information. The audio codec may likewise generate audible sound for a user, such as through a speaker, e.g., in a handset of the mobile computing device. Such sound may include sound from voice telephone calls, and may also include sound generated by applications operating on the mobile computing devices. The mobile computing devices may be implemented in any number of different forms, such as, for example, as a cellular phone, part of a smart-phone, a personal digital assistant, or other similar mobile device. Various implementations of the systems and techniques described herein can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The systems and techniques described herein can be implemented on a computer having a display device (e.g., a CRT (cathode ray tube) or LCD (liquid crystal display) monitor) for displaying information to the user and a keyboard and pointing device (e.g., a mouse or a trackball) by which the user can provide input to the computer. Other kinds of devices can be used to facilitate interaction with a user. For example, auction and/or advertising content provided to or received from a user can be in any form, such as visual, auditory, or tactile. The systems and methodologies described herein can be implemented in a computing system that includes a back end component (e.g., as a data server), a middleware component (e.g., an application server), and may include a front end component (e.g., a client computer having a graphical user interface or a Web browser through which a user can interact with an implementation of the systems and techniques described herein), or any combination of such back end, middleware, or frontend components. The components of the system can be interconnected by any form or medium of digital data communication (e.g., a communication network). Examples of communication networks include a local area network (LAN), a wide area network (WAN), and the Internet. The computing system can include clients and servers. A client and server are generally remote from one another, and typically interact through a communication network.

In certain embodiments, the auction processes described herein may be performed through bidders and vendors visiting an auction website. However, in other embodiments, bidders and vendors may be given the option of using social media such as Facebook or Twitter to submit bids in the various methodologies described herein. In yet other embodiments, bidding may be performed via mobile phone text messaging, or any other known and/or convenient method. Auction data may be submitted and/or received by third party applications or devices, such as an external phone or web application enabled to display bid activity in real-time, or a bid amount inputted to a bidder computing device of a bidder and sent to an auction site server. Bidders 106, 110, 112 and vendors 108, 114 may be given the option to connect themselves as friends. Similarly, bidders can be given the option to “follow” vendors. Vendors may be given the option to block bidders from becoming their friends, or to follow them. For example, vendors may decide to become friends of bidders based on their previous transactions together, their trust for one another, etc. Server 102 may be configured to keep a record of all transactions in the non-volatile database 104. CPU 103 connects to database 104 to determine the relationship between any bidders and vendors. Vendors may add conditions for bidding on the auction subject. For example, one condition may be that only friends or followers of the Vendor posting the auction subject can bid on it. CPU 103 receives instruction(s) concerning the auction subject and stores them in memory 105. When the bidders create their bids for the auctioned subject, CPU 103 may be configured to validate the relationship between the bidders and the vendors if such relationship is required by the vendor. Upon such verification, the bid record is created or the bid is denied.

In certain embodiments, vendors and bidders may be given the option to choose to define one or more geographic regions for doing business (e.g., local bidder-sellers, bidder-buyers, or vendors may be willing to buy, sell, or provide a particular auction subject in one or more geographic regions). Vendors and bidders may be given the option to register to do business in such geographic regions, and may be prompted to provide any documentation needed depending on local licensure requirements. The system may be configured to verify that the location of a bidder's mobile device is within a predefined geographic region before accepting a bid from that bidder (or verify that the bidder for example, lives or works in a particular area within the predefined geographic region. In certain embodiments, vendors may be allowed to define preconditions for accepting bids from bidders, such as the bidder being connected to the vendor, directly or indirectly, through social media such as Facebook friends, connected on LinkedIn, etc.

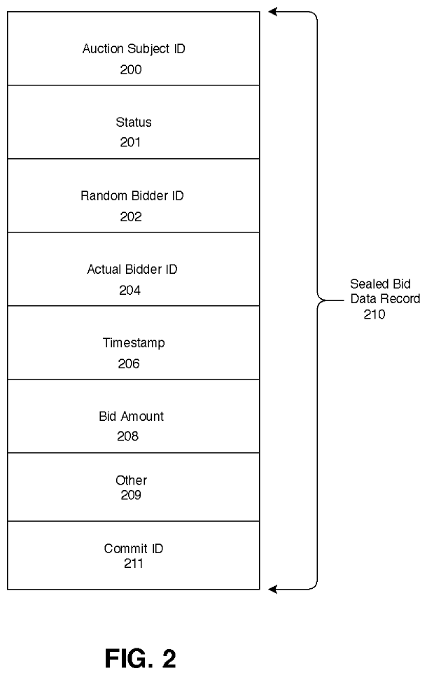

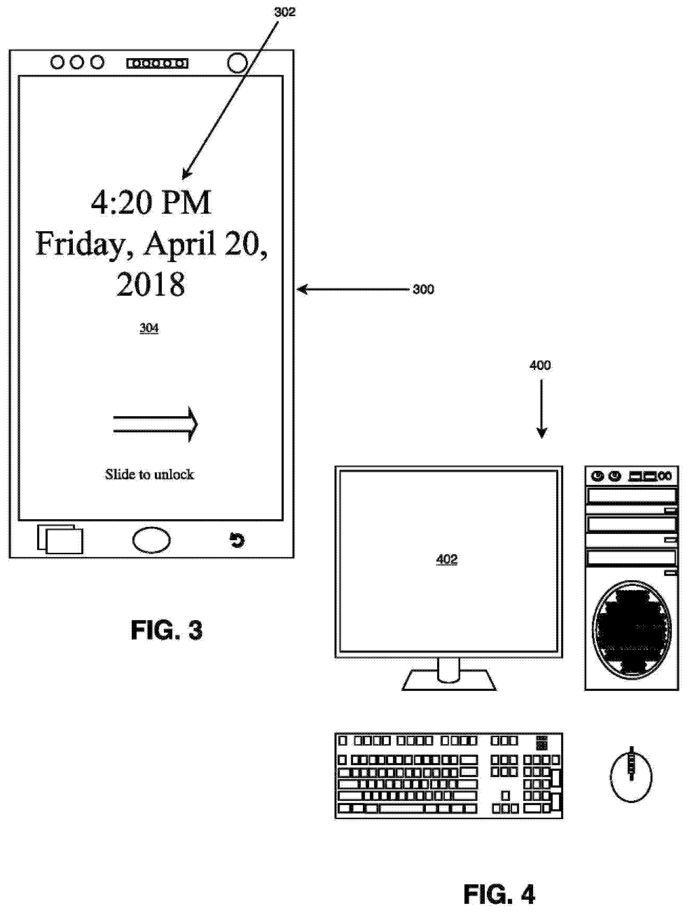

As shown in FIG. 3, bidder computing device 300 may have an internal clock mechanism providing time and/or date information 302 that automatically identifies and communicates to server 102 timestamp 206 for each of the at least one sealed bids. The timestamp is used to determine the time and sequence of submitted bids. Server 102 may be configured to sort the bids by bid amount 208 (FIG. 2) and time 304 to identify the winning bid, and potentially a recalculation of the final price if the winning bid is associated with the commitment as described herein. Each bidder computing device 300 may also have display 304 and be any computing device known in the art, such as, for example, a smartphone, tablet, personal computer or any other computing device. Similarly, the vendor computing device may be user device 400 such as a personal computer having display 402, an example of which is depicted in FIG. 4. User device 400 may be any computing device known in the art, such as, for example, a personal desktop computer, a laptop, a tablet, a smart TV, a gaming system, an in-vehicle computer or navigation system, or any other computing device. When the vendor computing devices 108, 114 are used to create an auction subject posting, server 102 validates the auction start time and end time as at or later than the current time. All times in every transaction are converted to UTC standard to avoid the time zone conflicts.

As shown in FIG. 1B, database 104 contains data related to the bidding process that includes but is not limited to: detailed information on tangible auctioned subjects 116; detailed information on intangible auctioned subjects 118; transaction data 122 which is divided based on the nature of the auctioned subject. The auctioned subject posting may contain information about the vendor's preferences on the restriction of bidders, recalculation criteria, and the allocation of the consideration (e.g., the price protection fee price). Server 102 may also collect other information related to advertisements and keep track of the advertisements viewed by the bidders 106,110,112 in the application (e.g. on a bid page, an auction subject page, etc.) and may use these metrics to decide the payer of the consideration (e.g., the price protection fee) for category II bidding. The database also contains previous transactions (e.g., previous successful transactions with winning prices) 120; bidding data 124 (e.g., bid history, prices, timestamps); user data 126 (e.g., user profiles, financial information, auction history, sealed winning bidder ID information); and other transaction data 128. The database may be connected to and queried by vendors and bidders from vendor computing device 108 or bidder computing device 106 to obtain relevant information such as references about historical transactions and prices of the auctioned subjects. The historical transactions within the database may provide a price reference to at least one of the plurality of registered bidders or the plurality of registered vendors about at least one previously auctioned subject of value in case the bidders lack sufficient knowledge and experience about the properties they intend to bid on, or in case the vendors need references for listing reserve prices within auctions. The database can be queried for searches by at least one of the plurality of registered bidders or the plurality of registered vendors about at least one previously auctioned property of value without disclosing the actual bidder ID of the winning bidder. Each of the at least one sealed bids may be securely stored in the server during the time duration of the auction. At the end of the auction, bid amounts and the timestamps are displayed to the plurality of bidders. The actual bidder IDs are not displayed.

The system may have a means for maintaining one or more of the databases. Such databases can include, but are not limited to, winning bidders' and vendors' information without disclosed real ID (also referred to as an actual bidder ID), information about auctioned tangible and/or intangible auctioned subjects, and the database of successful transactions within specific period of time.

As shown in FIG. 5A, exemplary embodiments of the present invention allow bidders to register with the system (Step 500) before submitting bids for an auction. After the registration, the user account is verified (Step 502). Server 102 may verify a user by sending a registration token to the user's registered email, or by sending a one-time password (OTP) code to a registered mobile number of the user. Server 102 may collect funds as part of the registration and store the user's information to database 104 for future reference and verification of the user. To begin an auction, registered bidders may select an auction subject (Step 503) to bid on, and then may select a bidding category (Step 504) based on experience, preference, in consideration of auction strategies, or as randomly chosen by the bidder, etc. A bidder who selects to be a bidding category two bidder (Step 506) may commit to pay a fee to purchase the price-protection policy for his/her winning bid (Yes, Step 508). The system may display the auction subject and related information, such as an image of the auction subject, descriptions thereof, a reserve price, shipping details, etc. (via a web page or mobile application). The system may be configured to display different commitment plans involved with the auction subject as further discussed below with respect to Table 1. The commitment plans may contain detailed information associated with the price protection policy and the predetermined percentage associated with each of the plans. Once a bid is created, a bid record 210 (FIG. 2) is created with the selected commit Id 211 in database 104. The record will have the status of ‘ACTIVE’ in the bid record. If the bidding category two bidder does not commit to pay a fee to purchase the price-protection policy (No, Step 508), then the system will advise the bidder (Step 510) that the bid will be rejected as a bidding category two bidder. The system will send the bidder with a request to change to be a bidding category one bidder (Step 512). If the bidder chooses yes to change to a bidding category one bidder (Yes, Step 512), then the bidder may begin to bid as a bidding category one bidder on the auction by entering a bid amount to submit to the system (Step 518). If the bidder chooses no (No, Step 512), then the bidder's ability to bid on the auction will end (Step 514).

A bidder who selects to be a bidding category one bidder (Step 516) may begin bidding by entering a bid amount (Step 518). The bidder, regardless of whether a bidding category one or bidding category two bidder, will then confirm the bid amount is accurate, and may also be prompted to confirm the bidder's financial ability to pay the entered bid amount and affiliated costs, which is the bidder's double confirmation (Step 520). If the bidder does not confirm either the bid amount or the financial ability to pay (No, Step 520), then the bidder may be notified by the system that the bid will be rejected and no bid will be created (Step 522). The bidder may choose to change the bid amount and continue (Yes, Step 524) by confirming the bid amount and financial ability to pay (Step 528). If the bidder still chooses to not confirm the bid amount and financial ability to pay (No, Step 524), then the bidder is precluded from bidding (Step 526). If the bidder confirms the bid amount and the financial ability to pay the submitted bid amount (Step 528), then the bid amount is accepted, and the system assigns a random ID number and bid timestamp (Step 538) and enters the bid within the system (Step 540). It will be appreciated that in certain embodiments, such double confirmations may be optional or not required.

Once the bid is double-confirmed (Step 520), the system can query whether the submitted bid amount is lower than the starting price set by the vendor (Step 530). If the bid amount is lower than the starting price set by the vendor (Yes, Step 530), then the system will automatically reject the bid (Step 532) and allow the bidder to change the bid amount to a value no lower than (at least as high as) the starting price set by the vendor (Step 534). If the bidder refuses to change their bid amount, then the system will make a final rejection of the bid (Step 536). If the bidder changes the bid amount, the system will once again query whether the submitted bid amount is lower than the starting price set by the vendor (Step 530). If the resubmitted bid amount is higher (not lower) than the starting price (No, Step 530), then the system will accept the submitted bid amount (Step 538) and enter it for the auction within the bidding system (Step 540) and the bidder's ID will be sealed. Since all accepted bid amounts are sealed, the bidder and bid amount will be assigned a random identification number and a timestamp indicating when the bid was accepted by the system in the auction (Step 538).

As shown in FIG. 5B, in certain embodiments, after the system accepts the bid and assigns random ID number and bid timestamp (Step 538), and enters the bid (Step 540), a bidder is allowed to change the submitted bid amount before the auction ends (Step 542). However, every bidder is allowed to submit only one valid bid. If the bidder does not change their submitted bid (No, Step 542), then the system determines the submitted bid to be the only valid bid. If the bidder decides to change their submitted bid (Yes, 542), then the bidder may change the previous bid and re-enter a new bid amount and submit it to the system (Step 548). If the bidder does not change the bid anymore, then the system will determine the re-entered submitted bid to be the only valid bid. Each time a new bid is created with status 201 ‘ACTIVE’ in database 104, previous bids made by the same bidder are made invalid by changing the status 201 to ‘INACTIVE’. The system may store all information associated with the transactions in database 104 All bidders 106,110,112 with ‘ACTIVE’ bids are considered to identify the winning bid and the designated bid as described herein. Once the time expires on the auction (Yes, Step 546), the auction will end and the winning bidder will be determined (Step 550). In preferred embodiments, if a bidder submits a new bid or otherwise re-submits a bid, then any previously submitted bids by that bidder are replaced. In this manner, each bidder may only have one pending valid bid for an auction subject. Alternatively, the system may determine only the most recent bid to be the valid bid, or may alternatively select the highest bid to be the valid bid, depending on the predetermined rules for the auction. If the bidder does not change the bid again, then the system will determine the re-submitted bid to be the only valid bid by that bidder.

In alternative embodiments, the system may be configured to allow a bidder to change his/her bid by raising, lowering, re-submitting a bid, change a bidding category, and/or change a bid amount before the close of the auction. Bidders may also be allowed to withdraw their bids before the auction closes. Server 102 in turn updates the most recent ‘ACTIVE’ bid record the bid status to ‘WITHDRAW’ for the bidders in database 104. When the winning bidder is determined, the ‘WITHDRAW’ records are discarded and only the ‘ACTIVE’ statuses are considered. If the same bidders re-bid on the auction subjects (withdrawn by them earlier), a new bid record is created with ‘ACTIVE’ status. Withdrawn and/or changed bids may still remain sealed so others will not be aware of them. By keeping withdrawn or changed bids confidential, the system can prevent bidders from using withdrawn and/or changed bids as reference points, and can eliminate or reduce misrepresentation or fraud. The system may continuously monitor the auction for any indications from bidder computing devices 106/110/112 that a bidder wants to change an existing bid (Step 542) up until the auction has closed or ended upon expiration of the time-frame for the auction (Step 546). At this point the auction will close or end (Yes, Step 546).

In yet other embodiments, the system may be configured to preclude withdrawal of a bid and/or submission of a bid at any time after a randomly generated time before a predetermined end time of the auction. In this manner, the system can help prevent colluding vendors and bidders from using unauthorized access to bid amounts to their advantage, since neither party will know exactly at which point submission and/or withdrawal bids will no longer be accepted by the system. By way of example, a colluding vendor-seller will not be able to ensure that a colluding bidder-buyer submit a second highest bid close to the highest bid (to ensure more money to the vendor-seller) because neither party will know the exact end time for submission of bids. By way of another example, if a bidder illegally hacks into the system (or has someone else do this on his/her behalf), and unlawfully obtains access to the bid values, he/she will still not know exactly when the auction will end, which will make it harder to affect the outcome in his/her favor.

Once the auction ends, the bid amounts may be opened to the participants of the auction, and the system will determine a winning bidder for the auction (Step 550). If the bidder wins the auction and is a bidding category one bidder (Category 1, Step 552), then the bidder who won will pay the exact bid amount submitted for the auction plus related costs, if any such as shipping fees, etc. (Step 556). If the bidder wins the auction and is a bidding category two bidder (Category 2, Step 552), then the bidder who won will pay a recalculated final price that is determined after applying the price-protection formula plus related costs, if any (Step 558). If the system determines that the bidder did not win, then the bidder loses the auction and no payment will be made by the bidder. After the bidder wins the auction and pays the final price, the vendor delivers the auctioned subject to the winning bidder (Step 560). After the auctioned subject has been delivered to the winning bidder, the parties may rate each other (Step 562) through the system, and such ratings may be stored in database 104. The process concludes once ratings are received or after the parties decline to rate one another.

As shown in FIG. 5C, after the bidding category two bidder wins, the final price is determined by applying the price-protection formula. If a Category 2 bidder wins the auction, then the winning bidder will be obligated to pay a final recalculated price for the auction subject (e.g., the good, service or both) to the vendor (Step 558), and the final recalculated price is determined by applying the price-protection formula (Step 568). In preferred embodiments, the price-protection formula is calculated as the sum of: the price-protection fee, the designated bid amount (e.g., in certain embodiments, the second-highest bid amount), and the amount of a pre-determined percentage of the difference of the winning bid amount and the designated bid amount. (Step 568). In certain embodiments, the designated bid amount may correspond to a different pre-assigned ranking (e.g., the third highest bid amount, the fourth highest bid amount, etc.). In other words, the vendor, system, and/or non-auction participant may agree to preset rules for an auction with two preset rankings as described above, the first corresponding to the ranking of the winning bid and the second corresponding to the ranking of the designated bid used in conjunction with the winning bid to calculate the adjustment amount in the formula. The system then determines who will receive the price-protection fee (Step 570), which can also be preset as one or more of the rules and agreed to by the vendor, the system, and/or a non-auction participant. It will be appreciated that the system is preferably configured to give each bidder access to and require confirmation of and agreement to all preset rules of the auction.

The system, the vendor, or a non-auction participant may establish one or more sets of predetermined rules for allocating the price-protection fee submitted by at least a winning bidder. The vendor or the system can preset whatever rule or rules he/she wishes with respect to allocation and distribution of the price-protection fee(s), including but not limited to, any one of the auction participants. For example, rules may be established dictating that the entire price-protection fee may be allocated to the vendor (Step 572) or to the second-highest bidder (Step 574), among all Category two bidders except the winning bidder (Step 575), to the vendor and bidder(s) (Step 582), to the system, the vendor, the winning bidder, and/or the losing bidders, whether they be Category one or Category two bidders. For example, the vendor may decide that he/she does not want to allocate any of the price-protection fee to the highest bidder, and wishes to allocate all of it to, for example, the second or third highest bidder.

The system can then also determine the number of bidders to whom the price-protection fee should be paid and further determine the number of second-highest bidders (Step 576). If there is only one second-highest bidder (Yes, Step 576), then the entire amount of the price-protection fee is allocated to the sole second-highest bidder (Step 578). If there are several second-highest bidders (e.g., if two or more Category two bidders bid an equal amount and the equal amount is the second highest amount relative to the winning bid) (No, Step 576), then the entire amount of the price-protection fee is split between all second-highest bidders by, for example, a pre-determined percentage (Step 580). Another option is when the price-protection fee is split between the vendor and the second-highest bidders by a pre-determined allocation percentage (Step 582) which may be predetermined by the vendor, the system, or a non-auction participant. In this case, one pre-determined portion of the price-protection fee may be allocated to the vendor (Step 584), while the remaining portion of the price-protection fee may be allocated to one or more of the second-highest bidders. In the next step, the system determines whether there is only one second-highest bidder (Step 588). If the system determines that there is only one second-highest bidder (Yes, Step 588), then the rest of the portion of the price-protection fee is allocated to the sole second-highest bidder (Step 592). If the system determines that there is no second-highest bidder to be awarded such as in the situation where there is only one bidder and the start price as preset by the vendor will be deemed the second-highest price, the rest of the portion of the price-protection fee may be allocated to the vendor, or may be given back in part or in total to the single bidder. If there is more than one second-highest bidder (No, Step 588), then the rest of the portion of the price-protection fee is split between all of the second-highest bidders (Step 594) in accordance with pre-determined rules, or may be split among all of the remaining bidders who did not win. The allocation of the price-protection fee may thus be customizable by the vendor, the system, or a non-auction participant based on predetermined rules.

Alternatively, the price-protection fee paid by the winning bidder may be split equally, in whole or in part, among all Category two bidders who did not win the auction (Step 575). In yet other embodiments, the price-protection fee may be entirely or partially allocated to the system or a non-auction participant where the system may be the entity who developed, hosted, or otherwise provided a software application for the online auction. Also, the non-auction participant may include the managing company or agent of the system, or may further include a representative of a vendor, representative of a buyer, website manager, auction housing company, outside investors of the auction site, or others having vested interests in the auction. In such embodiments, the system or non-auction participant may collect all or a portion of the price-protection fee from a given auction.

In preferred embodiments, only the winning bidder pays the price-protection fee, and the fee is distributed to one or more of the other bidder-buyers. In other embodiments, the price-protection fee may be a required payment by every Category two bidder, regardless of whether or not he/she is a winning bidder, and the total price-protection fees collected can be split based on one or more of the predetermined rules. Such embodiments contemplate the price-protection fee as consideration for the right to be a Category two bidder, and thus the potential to win the auction subject for a reduced price payable to the vendor for the auction subject (e.g., an amount below the amount of his/her winning bid, based on a second highest or other designated bid amount). It will be appreciated that such a “pay to play” embodiment can potentially increase total revenue to the vendor, the system, or a non-auction participant by virtue of requiring payment from all Category two bidders, and can additionally help deter indecent bidders. These payments may be required prior to, during, or after the close of the auction. It will be appreciated that regardless of whether the auction rules offer Category two as “pay to play” or “get paid to play” with respect to the price-protection fee, the system allocates the price-protection fee based on predetermined rules. Alternatively, in certain embodiments, only the top two or three bidders pay the price-protection fee, and upon the close of the auction, are each entitled to receive a portion of the allocation of the protection fee amount. In still other embodiments, the system or a non-auction participant may offer to pay the protection fee or a portion thereof, in order to attract additional bidders. In such a situation, the system would then preferably receive a greater portion of the allocation of the protection fee amount upon close of the auction.

If the vendor is confident that the auctioned subject will attract many bidders, the vendor may choose to keep the entire amount of the price-protection fee paid. On the other hand, if the vendor wishes to attract more bidders to participate in the auction for the auctioned subject, the vendor may decide to award the entire price-protection fee to the second highest bidder(s) or to all or a portion of the participating bidders. If only one bidder has placed a bid for the auctioned subject and the bidder identifies himself/herself as a Category two bidder, then a reserve price of the vendor can be considered as the second highest bid amount for purposes of recalculation if the sole bid is a Category two bid and above the reserve price.

The distribution/allocation rules may be preset by the vendor, the system by default or by a non-auction participant, for example, in accordance with a predetermined scale, correlation, or corresponding array of percentages, or may be decided by the vendor after the auction ends. The allocation rules may include predetermined percentages whereby a first portion of the allocation amount gets split among one or more of the winning bidder, one or more losing bidders, the system, or a non-auction participant, and a second portion of the allocation amount goes into a pool or lottery that may be “up for grabs” on a first come, first serve basis. The allocation amounts of the price-protection fee may also be based on the rankings of bidders relative to the winning bidder (e.g., second highest, third highest, fourth highest, etc.), with the second highest bidder receiving the highest percentage of the price-protection fee, the third highest bidder receiving a smaller percentage of the price-protection fee, the fourth highest bidder receiving an even smaller percentage of the price-protection fee, etc. In other embodiments, the bidder whose bid corresponds to the designated bid used in the recalculation may be entitled to a portion of, the majority of, or all of the price-protection fee. Alternatively, the winning bidder may be entitled to all or a portion of the price-protection fee. In one embodiment, if every Category two bidder pays the price-protection fee upfront, then the winning bidder may receive a “kickback” of what he/she has already paid to the system. If only the winning bidder pays the price-protection fee, then the amount of the price-protection fee owed by the winning bidder once the auction ends may be reduced depending on the allocation rules preset by the vendor. In still another embodiments, the system may include predetermined rules that preclude certain auction participants (e.g., all non-bona fide bidders, bidders whose bids are a predetermined amount lower than the winning bidder, bidders whose bid amounts are less than a predetermined percentage of the winning bid amount, all bidders whose bid amounts are less than a predetermined fixed amount, a predetermined percentage of the lowest bidders, etc.) from receiving any portion of the allocation amount.

In other embodiments, the predetermined rules of an auction may allow for allocation of at least a portion of the price-protection fee in a particular auction (e.g., a portion of the price-protection fee paid by a winning Category two bidder or by all Category two bidders in the particular auction) to any user of or registrant to the system, including non-participant registered users (e.g., users of the system who did not participate in the particular auction). The individual non-participant user's percentage of the available portion he/she can collect from a particular auction can be based on, for example, a user's aggregate ranking by the system. The user's aggregate ranking can be based on, for example, the total number of auctions the user has previously participated in through the system (as a vendor or as a bidder), the total number of auctions in which the user has previously paid a price-protection fee (e.g., as a winning Category two bidder or as a losing Category two bidder in certain “pay to play” auctions where all Category two bidders were required to pay the price-protection fee), the total amount of price-protection fees the non-participant user previously paid, the total number of bids previously submitted, the total number of actions the user has taken through the system (e.g., total time spent online and interacting with the system), the total amount of money the non-participant user has paid for goods or services as a buyer in auctions conducted through the system, and/or the user's rating by other users of the system over time (e.g., Step 562). One or more of these factors can be assigned a particular weighting in calculating the user's aggregate ranking. In the event that one or more users are tied in ranking, the system can use additional criteria to in determine priority, such as the first of the tied users to request payment. Alternatively, the system may simply split a portion of the fee between tied users. Such data can be stored in database 104, and dynamically updated as users participate in one or more auctions. Preferably, the system requires a user to verify that he/she is not a computer by periodically prompting input of randomly assigned characters displayed onscreen for verification.

Upon completion of a sealed bid online auction, non-participant users logged into the system may be given a notification (e.g., by text, e-mail, or popup onscreen) that one or more other auctions in which they did not participate have ended, and that a portion of one or more price-protection fees are “up for grabs” on a first come, first serve basis. Indicators may be displayed to users as symbols on-screen to convey this information. The non-participant users may be given a fixed period of time to collect their portion of the price-protection fee by simply clicking on the particular auction and an on-screen collection button, or by any other means of notification to the system. Non-participant users with the highest ranking who are logged into the system may be given first priority to collect any available portion of the price-protection fee allocated by the specific predetermined rules of the particular auction, which may indicate, for example, that the first number of non-participant users to select payment within a certain time period will receive it. Upon expiration of the time period, any remaining portion which was available to non-participant high ranking users may then be then made available to lower ranking non-participant users, or simply “returned” to the particular auction and allocated in accordance with additional predetermined allocation rules for the participants therein (e.g., the vendor, bidder(s), system administrator, etc.), or to all Category two bidders (for the particular auction or generally).

A portion of the price-protection fee in a particular auction may be allocated to new registered users of the system, or only to new registered users who participate or have participated in a sealed bid online auction as a Category two bidder. Category two bidders of the particular auction may be given priority to receive their individual portion of the price-protection fee, but not a guarantee unless they notify the system within a specific time-frame they wish to collect. Alternatively, the beneficiary of all or at least a portion of the price-protection fee for a particular auction may be a charity or other non-auction participant. If such non-auction participant charity is a beneficiary, then such payments by bidders may be tax deductible depending on applicable national and local tax laws.

In certain embodiments, the price-protection fee may be fixed regardless of the amount of the winning Category two bidder's bid, and/or regardless of each Category two bidder's bid amount (in particular pay to play auctions where each Category two bidder is required to pay a price-protection fee). Each Category two bidder may simply be required to pay, for example, $5, $10, $20, or $50 regardless of their bid amounts. The fixed amount of the price-protection fee may be set by the vendor or the system, and may or may not be correlated with the vendor's, the system's or the bidders' perceived market value of the auction subject. In other embodiments, the price-protection fee may be one or a combination of a fixed amount and a percentage of the Category two bidder's bid (e.g., the fixed amount may be added or subtracted from the amount of the fee determined from the percentage of the bid). For example, the price-protection fee may be ($10+[10%*(Amount of Winning Bid)]) or ([10%*(Amount of Winning Bid)]−$10). If this amount calculates to less than zero, then the price-protection fee can simply be set to zero. The system may individualize and modify the fixed amount of the price-protection fee set by a particular auction based on the bidder's ranking as discussed herein, prior price-protection fee payments, etc.

If the price-protection fee paid by the winning Category two bidder or by a plurality of Category two bidders is less than a predetermined threshold, then the system and/or the vendor can allocate additional funds to Category two and/or Category one bidders to attract more bidders to the system and/or retain existing users. The source of such additional funds may be, for example, system registration fees of all users, vendor fees for listing an auction subject, out of pocket expenses, fees from advertisers, etc. A vendor who is a user of the system, or a non-auction participant who wants to utilize the system to conduct a sealed bid online auction, may conduct a promotion in order to attract additional bidders to bid on an auction subject through the auction processes described herein. The vendor or non-auction participant may allocate funds for distribution during or at the end of the auction (e.g., in addition to the price-protection fee, if any), and the allocation of funds may or may not be based on the price-protection fee rules, depending on preset system configurations and the predetermined rule(s) of the particular auction. The non-auction participant may be, for example, an administrator or representative of the system, or an advertiser or advertising company that wants to utilize auctions through the system for providing goods and/or services.

In another embodiment, a debit module may be configured to debit a predetermined value from an advertiser's account upon each occurrence of a monetization event (e.g., an auction user's viewing of an advertisement, etc.). Here, the system may be configured to select an advertisement from a plurality of advertisements sponsored by one or more advertisers. The system then facilitates display of the advertisement to at least one bidder providing a sealed bid accompanied by a commitment to pay an additional amount (i.e., a Category two bidder) at a time when the sealed bid is provided by the bidder. The system verifies review of the advertisement by the bidder and stores verification information in the database relating to confirmation that the advertisement was reviewed by the particular bidder. The status of the bidder reviewing the advertisement may then be updated based on the verification information. A payment amount from the advertiser of the advertisement, upon verification that the bidder reviewed the advertisement, may be applied to pay at least a portion of the additional amount of the price-protection fee on behalf of the category two bidder. In certain embodiments where the bidder is enabled by the system to select correlated percentages corresponding to the price-protection fee and the predetermined percentage as discussed above, the advertiser may require that the bidder pick a specific correlated percentage option as additional consideration for agreeing to pay for a portion of the price-protection fee. The advertiser may also place a cap on the amount of the price-protection fee it will cover, and/or simply offer to cover a flat fee amount without regard to any percentages.

Example monetization events may associate with and/or include an auction user's interaction with computer links associated with additional information about a product or service being advertised. Other examples may include the auction user clicking on an advertisement associated with the product or service, and/or the auction user's entry into a customized brand world associated with the product being advertised. The system may be set such that different amounts are debited based on the duration the auction user views the advertisement, which may be verified by the system (e.g., by requiring the auction user to provide his/her user information, by requiring the user to answer a question about the advertisement, etc.). Other monetization events may include premium interaction events and/or an auction user's selection of a particular product or service for further information or purchase. Still other monetization events may comprise the auction user initiating purchase of the product or service depicted in the advertisement by interaction with a computer link associated with a merchant's purchase offer. The merchant's purchase offer may include: (i) a “buy it now” offer specifying a price; and/or (ii) an electronic coupon offer offering a discount. In such an embodiment, the funds provided by the advertiser for the monetization event may be used to contribute in whole or in part to a protection fee pool. In certain embodiments where losing bidders may not receive any part of the allocation of the protection fee, such losing bidders may be offered an opportunity to review one or more advertisements for the ability to participate in the pool or lottery that may be “up for grabs” on a first come, first serve basis.

In certain embodiments, one or more content providers (e.g., advertisers) may directly or indirectly enter and maintain content (e.g., advertisement) information in database 104 or a separate content management system. Various forms of content, including sponsored content, may be delivered through server 102. The content may be in the form of graphical ads such as banner ads, text only ads, image ads, audio ads, video ads, or ads combining one or more of these types. The content may also include embedded information such as links, meta-information, and/or machine executable instructions. Content providers may also select the page and location on the page to show the advertisement (e.g., subject to predetermined rules stored in database 104 of server 102). One or more publishers and/or user devices 106, 108, 110, 112, 114 may submit requests for content to a content management system, which may respond by retrieving the content and related information from the database 104. The content management system may display to the users. The content may include embedded links on landing pages (e.g., pages on the advertisers' websites) that a user (e.g., an auction participant) is directed to when the user clicks a content item presented on a publisher website. The monitoring module may provide usage information and statistics for display on user devices 106, 108, 110, 112, 114. The usage information and statistics may include originally monitored information or analyzed data, such as data measured or observed regarding user behavior related to content, the time of the usage, specific changes of the content, and the click rate, customer conversion rate, etc. The system may be configured to perform financial transactions, such as crediting publishers and charging content providers based on the usage information and statistics.

It will be appreciated that the embodiments disclosed herein are aimed at enabling system customization and encouraging and increasing user participation, and that preset system configurations combined with the one or more predetermined rules of particular sealed bid online auctions will dictate allocation of the price-protection fees, regardless of whether the allocations are fair or unfair. Additionally, “pay-to-play” auctions which require all Category two bidders to pay a price-protection fee are further incentivized by such embodiments because even if participating bidders do not win the auction (and thus lose their price-protection fees), the price-protection fees they pay can increase their aggregate rankings, and thus their priority for collecting portions of price-protection fees in other auctions they do not participate in, and the percentages to which they may be entitled.

In certain embodiments, the net amount paid by the winning bidder to the vendor for the auction subject may be different from the net amount the winning bidder ultimately is obligated to pay using the auction because the winning bidder pays the price-protection fee in full, and the vendor may receive some, none, or all of this price-protection fee. By way of example, if the recalculated amount of a winning Category two bidder is $10, which includes a $2 price-protection fee, then if the $2 goes to the remaining bidders, the vendor receives $8 from the winning bidder for the auction subject, the vendor receives no portion of the $2, and the $2 is allocated to other auction participants (e.g., other bidders) and/or third parties. The vendor thus receives a net of $8 for the auction subject. The winning bidder, however, pays a net amount of $10 (i.e., the $8 paid to the vendor plus the $2 price-protection fee paid to one or more other auction participants and/or third parties). If the winning bidder receives 50% of the price-protection fee as a “kick-back,” then the winning bidder still initially pays $10 (the recalculated amount) for the auction subject and receives $1 of the price-protection fee back. In this scenario, the bidder buyer pays a net $9, while the vendor nets $8 plus a portion of the price-protection fee, if any is allocated to the vendor. If the bidder-buyer receives 100% of the price-protection fee back, then the bidder-buyer initially pays $10 for the auction subject (the recalculated amount) and receives $2 of the price-protection fee back. Here, the buyer pays a net amount of $8 and the vendor nets an amount of $8. The above transactions can be one transaction or separate transactions. It will be appreciated that the amount the vendor nets for the auction subject equals the amount the buyer pays out for the auction subject when the buyer receives 100% of the price-protection fee.

The allocation of the price-protection fee may be based on whether or not the resulting net amount the bidder-buyer pays is equal to or greater than the reserve price. If the recalculated amount is less than the reserve price, then the bidder-buyer may be entitled to receive as a “kickback” a percentage of the price-protection fee that enables him/her to pay a net amount that reaches or exceeds the reserve price. In this manner, the bidder-buyer does not pay a net amount greater than the reserve price, and the vendor still receives the recalculated amount from the bidder-buyer. The price-protection fee may also be allocated in accordance with a dynamic formula that changes a price of the recalculated amount such that it is equal to or greater than the reserve price. In certain embodiments described herein, the bidder or vendor in an ascending sealed bid auction or a reverse sealed bid auction may be given the option of turning down any kickback or fee allocation for any reason. Allocation of the price-protection fee may be preset by vendor devices 108,114 before the auction subject is posted. Such allocation designation may be stored in database 104 with an associated auction subject identification for later identification of the auction subject. When the auction is closed and the winning bidder is a category two bidder, then the system may retrieve the pre-set allocation rules.

The Predetermined Percentage (i.e., the percentage applied to the difference between the amount of the winning bid and an amount of the second highest bid, hereafter the “Predetermined Percentage”) and the Price-Protection Fee Percentage (i.e., the percentage applied to the winning bid amount) used during a calculation of the Final Recalculated Price for Category two bidders can each be predetermined and preset in the system by the buyer prior to the start of the auction, and for any percentage amounts the vendor chooses. Alternatively, the auction house, the system, or a non-auction participant may establish these percentages by default. Either way, all auction rules are preferably laid out at the beginning of the auction.

In accordance with certain embodiments, the Predetermined Percentage and the Price-Protection Fee Percentage may be correlated. Exemplary correlations between the Price-Protection Fee Percentage and the Predetermined Percentage can include either direct or indirect relationships, linear or non-linear relationships, and the like. Preferably, an increase in the price-protection fee percentage is associated with a decrease in the predetermined percentage. The more a bidder is willing to pay in the price-protection fee should he/she win, the less of a potential upward adjustment from the second highest bid is desired. In other embodiments, the percentages may be correlated such that the predetermined percentage increases as the price-protection fee increases, the predetermined percentage increases as the price-protection fee decreases, the predetermined percentage decreases as the price-protection fee increases, or the predetermined percentage decreases as the price-protection fee decreases.

For example, the Predetermined Percentage may be correlated such that a Price-Protection Fee of 0.5% would correlate to a Predetermined Percentage of 50%, a Price-Protection Fee of 3% would correlate to a Predetermined Percentage of 40%, a Price-Protection Fee of 9% would correlate to a Predetermined Percentage of 30%, etc. In some embodiments, the system may enable a bidder-buyer to choose a particular Predetermined Percentage. Once the Predetermined Percentage is chosen, the system may automatically assign the appropriate correlated Price-Protection Fee Percentage, which may include a correlation factor (e.g., one-fourth, one-fifth, etc.) of the Predetermined Percentage chosen by the bidder. Conversely, if the bidder-buyer chooses a particular Price-Protection Fee Percentage, then the system automatically assigns a Predetermined Percentage, which may include the correlation factor, the Price-Protection Fee Percentage chosen by the bidder. In preferred embodiments, a higher price-protection fee percentage will correspond to a lower predetermined percentage, but it will be appreciated that the inverse relationship may be used as well or there may be no correlation between the two.

In yet another alternative embodiment, the Predetermined Percentage, which may range, for example, from 50% to 5%, may be set to decrease by 5% for each incremental increase in the Price-Protection Fee Percentage, which ranges from 1% to 13.5%. In particular, the initial values of 1%, 2.5%, and 3% of the Price-Protection Fee Percentage correspond to 50%, 35%, and 30% respectively, of the Predetermined Percentage. Above 3%, each incremental increase of 1.5% in the Price-Protection Fee Percentage corresponds to a decrease in the Predetermined Percentage down to values of 10% and 5% respectively. It will be appreciated that other correlations and/or preset correlated values may be utilized in accordance with the invention.

In yet other embodiments the price-protection fee percentage and predetermined percentage for the adjustment may be correlated respectively as 1% and 90%, 2% and 80%, 3% and 70%, 4% and 60%, 5% and 50%, 6% and 40%, 7% and 30%, 8% and 20%, or 9% and 10%, or may be correlated respectively as 5% and 50%, 8% and 40%, 10% and 30%, or 15% and 25%. Other fee percentage correlations may also be utilized.

As shown in Table-1 below, a Category II bidder may select a particular plan (e.g., one of Plans 1-7) corresponding to a particular Price-Protection Fee Percentage and a corresponding Predetermined Percentage as described above. When a winning bid is associated with a commitment, and thus a Category II bid (e.g., Commit-ID 211 of sealed bid data record 210 of FIG. 2), then the system may calculate the Payment Amount using one of the equations discussed above with a Price-Protection Fee Percentage of ‘A’ and a Predetermined Percentage of ‘B’, in accordance with Plan 1. Similarly, if a different Category II bid by one of a plurality of other bidders (e.g., 2011, 3011, 4011, 5011, 6011, 7011) is the winning bid, then the system may calculate the payment amount for the winning Category II bidder in accordance with the respective Price-Protection Fee and Predetermined Percentage of the particular Plan selected by the winning bidder when the bidder made the commitment. In certain embodiments, a single bidder may make multiple bids using different Plans. In other embodiments, a single bidder may be limited to using only one Plan for one or more bids for the same auction subject. In yet other embodiments, all bidders may be entitled to only one of the Plans (e.g., a specific Price Protection Fee Percentage and Predetermined Percentage).

TABLE 1

| | Price-Protection | Predetermined |
|---|---|---|
| Commit-ID | Fee Percentage | Percentage |
| 211 (Plan 1) | A % | B % |
| 2011 (Plan 2) | C % | D % |
| 3011 (Plan 3) | E % | F % |
| 4011 (Plan 4) | G % | H % |
| 5011 (Plan 5) | I % | J % |
| 6011 (Plan 6) | K % | L % |
| 7011 (Plan 7) | M % | N % |

In further embodiments, the preset rules may define the Predetermined Percentage to which the winning bidder is entitled as a function of the difference between the value of the winning bid and the value of the designated bid. By way of example, if the winning bid is $100 and the designated bid is $10, then the Predetermined Percentage may then be set to 10% (i.e., because there is a high bid spread, then there will be a low percentage), for a net adjustment of [10%*($110−$10)]=$10. If the winning bid is $60 and the designated bid is $10, then the predetermined percentage may then be set to 20% (i.e., instead of 10%), for a net adjustment of [20%*($60−$10)]=$10. Thus, the predetermined percentage may increase (or decrease) linearly in proportion to or be correlated in some other way with the spread (or difference) between the winning bid and the designated bid. These rules may be preset by the vendor in advance of the auction or may be set by the system as default settings. Optionally, the predetermined percentage may increase as the difference increases, increase as the difference decreases, decrease as the difference increases, or decrease as the difference decreases.

In still other embodiments, the price-protection fee percentage may be linked to the particular bid chosen as the designated bid in the recalculation of a category two winner's bid amount. For example, if a vendor chooses as a first ranking the highest bid to be the winning bid, he/she may leave the choice of the second ranking up to the bidder depending on which price-protection fee percentage is chosen. For example, if a category two bidder chooses a price-protection fee percentage of 5%, then this choice may correspond to the Second Highest Bid being used as the Designated Bid for recalculation if that Category two bidder wins. If the Category two bidder chooses a Price-protection Fee percentage of 10%, then this may correspond to the Fourth Highest Bid being used as the Designated Bid for recalculation if that Category two bidder wins. It will be appreciated that in such embodiments, the vender may preset a large Predetermined Percentage for the Adjustment to reduce the risk of being obligated to sell an auction subject for such a low a bid. For example, if a bidder pays a 30% Price-protection Fee Percentage and is entitled to, for example, the Fourth Highest Bid as the Designated Bid used in recalculation, then the Predetermined Percentage used may be 50%. In yet other embodiments, the Predetermined Percentage may be correlated with the Designated Bid used for recalculation.

Preferably, a sealed bid online auction utilizing correlated Predetermined Percentage and Price-Protection Fee Percentage values discloses the applicable percentages to all bidders before bidding takes place. It will be appreciated that utilizing such correlated percentages may encourage participation by more bidders in a sealed bid online auction, provide incentives for bidders to submit lower bids, and allow for greater potential reward to the bidder in exchange for an obligation to pay back a percentage of the winning bid.

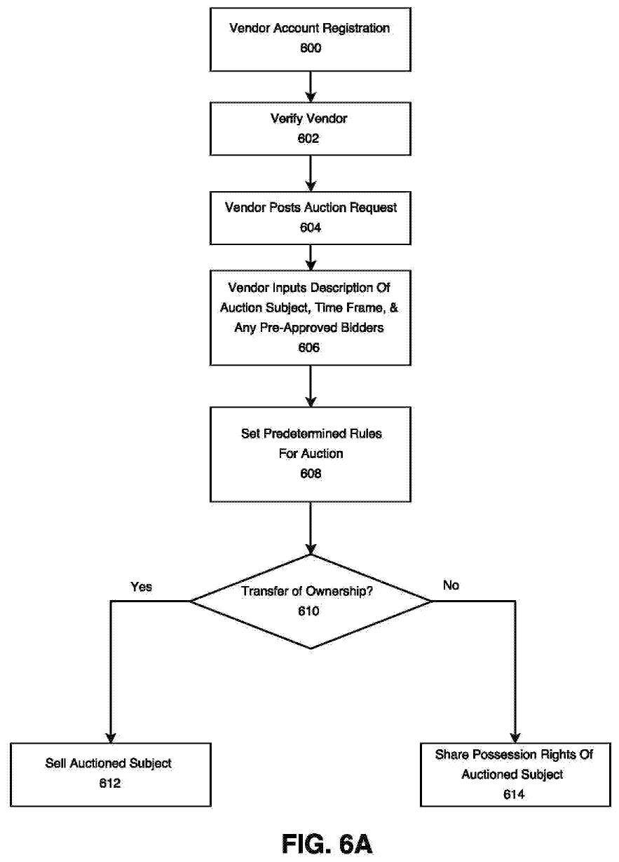

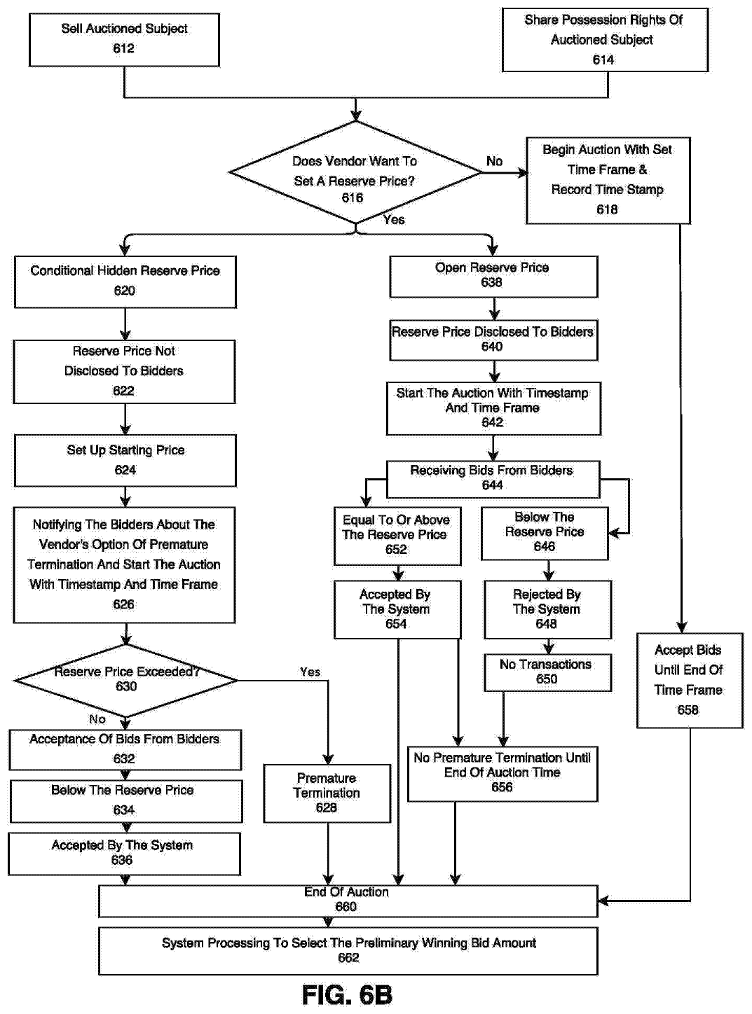

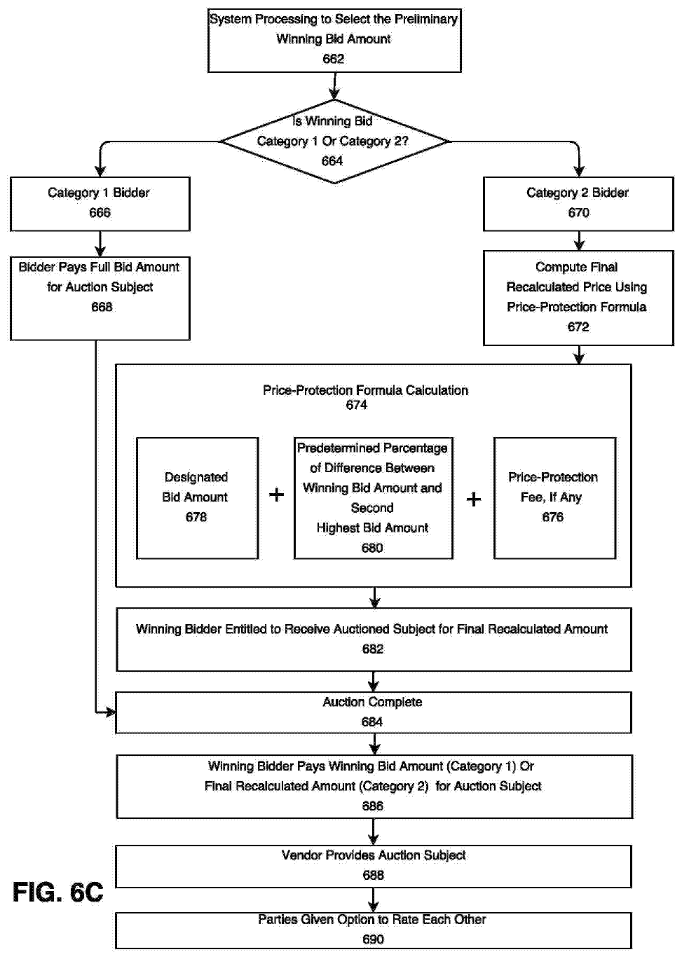

As shown in FIG. 6A, exemplary embodiments of the present invention allow vendors to register (Step 600) an account with the system. Before setting up the details of the auction, the vendor may be subject to verification by the system (Step 602), which may include, by way of example, a background check, a credit history check, a review of auction history, a reference check, double confirmation that he/she can and will make proper payment upon receipt of the goods/services desired, etc. After verification by the system is complete, the vendor may post an auction request (Step 604). When starting the process of setting up an auction, the vendor may be prompted to input a description/introduction of the auction subject with a written description, photos, videos, etc., explaining the (good(s) and/or service(s) sought), the desired time-frame for the time duration of the auction, and specify if there are any pre-approved bidders (Step 606). This description/introduction may include any requirements, preferences, and/or conditions precedent that the vendor has regarding the auction subject, such as, for example, the time-frame needed for delivery and/or completion of the good(s) and/or service(s), the total number of products or services requested, the quality needed (e.g., specifying any applicable standards or reference materials in a particular industry pertaining to quality, referring to exemplary photographs, dimensions, etc.). The vendor may also indicate any requirements of the bidders themselves and who is qualified to bid. Such requirements may include, for example, fluency in a particular language, prior experience level, equipment requirements, licenses, skill level, citizenship, geographic location, etc. The system may be configured to enable questions and answers between a vendor and bidders before the auction starts, and may make such questions and answers public to all auction participants via the computing devices. The vendor should provide any auction subject details needed to clarify or avoid confusion as to the requirements of the auction subject. The system can allow the vendor to preset the timeframe for the auction and track the auction until the end or close thereof.

In the next step the vendor can then establish predetermined rules for the auction, such as, for example, the price-protection fee, the predetermined percentage, setting a reserve price, deciding who will receive the price-protection fee, etc. (Step 608). The vendor may then specify whether the auction involves a good/service that will involve one or more transfers of ownership (Step 610). If the auction involves a transfer of ownership (Yes, Step 610), then the vendor intends to sell the auctioned subject at the auction (Step 612). If the auction does not involve a transfer of ownership (No, Step 610), then the vendor intends to share the possession rights for the auctioned subject for a specified period of time at the auction (Step 614).

As shown in FIG. 6B, once the vendor decides if there will be a transfer of ownership (e.g., selling at Step 612 or sharing possession rights at Step 614), the vendor may set up a reserve price by discretion (Step 616). The reserve price is preferably a minimum price, hidden (or closed) from bidders, representing the least amount a vendor is willing to accept for an auctioned good/service (i.e., an auction subject). In a reserve price auction, the vendor is only obligated to sell the good/service if the winning bid amount is at or above the reserve price. It will be appreciated that a downside of a hidden reserve price is that a failed auction may occur more frequently because the bidder-buyers may bid too low relative to the reserve price. Setting a hidden reserve price is preferably at the vendor's discretion, but may be automatically preset by the system by, for example, determining automatically a fair market value for the good/service being sought. In these embodiments, the bidders are not aware of the minimum amount a vendor is willing to accept for the auction subject. Such embodiments offer a bottom up bidding approach in that they encourage bidders to bid up from a start auction price irrespective of the hidden reserve price meaning that the bidding amount can be higher or lower than the reserve price. In alternative embodiments, the reserve price may be conditionally hidden at the vendor's discretion. A conditional hidden reserve price auction as contemplated herein is one in which the system allows the vendor to optionally terminate the auction early as soon as at least one bid is at or above the reserve price. The system can alternatively allow the bids to be accepted by a vendor even if they are not equal to or above the conditional hidden reserve price set by the vendor.

Alternatively, a vendor may choose to use an open reserve price, which is a reserve price that is visible to the bidders during the auction. In such embodiments, the bidders are aware of the minimum amount a vendor is willing to accept for the auction subject and offers a bottom up bidding approach in that it requires the bidders to bid up from the known reserve price, or to not participate in the auction at all. Such an open reserve auction may benefit savvy bidders in situations where a less savvy vendor sets a reserve price much lower than a market value for a particular good/service. Therefore, it will be appreciated that having an open versus hidden reserve auction has both pros and cons to the vendor and bidders. While having an open reserve auction may ensure that an auction does not fail even if there is only one bidder, it leaves open the possibility for savvy bidders to take advantage of less savvy vendors. For the bidders, an open reserve auction it enables them to offer bids that they know will be at an amount that the vendor may accept. It is also contemplated that the system may allow the bids to be accepted even if they are above the hidden reserve price set by the vendor.

In preferred embodiments, the reserve price is not used for recalculation, even if only a single bid is received above it. For example, if the winning bid is above the reserve price and the second highest bid is below the reserve price, then the recalculation is preferably still based on the winning bid and the second highest bid. However, the reserve price may be used as the second highest bid (or the designated bid, such as the third highest, fourth highest, etc. depending on the predetermined rules) for recalculation purposes if the winning bid is above it and no other bids are received.

If the vendor chooses to not set up a reserve price (No, Step 616), then he/she may set up any nominal starting price, such as $1.00, etc., the time-frame, including the starting time and the end time of the auction (Step 618). The system will issue a timestamp (Step 618) for such listing with the unique index number to identify different listings. The system will then start to accept bids (Step 658) which cannot be lower than the starting price, until the end of the auction (Step 660). After the end of the auction, the system processes all of the bids to select the preliminary winning bid amount (Step 662). On the other hand, if the vendor chooses to set up a reserve price (Yes, Step 616), then the vendor may choose between a conditional hidden reserve price (Step 620) or an open reserve price (Step 638). If the vendor chooses the open reserve price option (Step 638), then the system will advise the bidders of the reserve price before the bidders start to bid in the auction (Step 640). The auction begins with the timestamp and the time-frame (Step 642) and the system receives bids from bidders (Step 644). In certain embodiments, the time-frame is managed with a timer having a time-frame set by the vendor. If the bids are below the reserve price (Step 646), then the bids are rejected by the system (Step 648) and no transaction occurs (Step 650). If the bids are equal to or above the reserve price (Step 652), then the bids are accepted by the system (Step 654). In both cases the premature termination by the vendor is not allowed (Step 656), unless a predetermined set of circumstances warrant the premature termination. If vendor chooses to set a conditional reserve price (Step 620), then the reserve price is not disclosed to bidders (Step 622). The vendor sets up a starting price (Step 624) and the system will notify the bidders about the possibility of the auction's premature termination by the vendor when auction starts with the time-frame and time stamp (Step 626). The system starts accepting bids from the bidders. The system will query whether the reserve price was exceeded by the bid amounts (Step 630). If the reserve price was exceeded (Yes, Step 630), then the auction is subject to premature termination as preset by the vendor (Step 628). The system will notify the vendor that the reserve price had been met and the vendor may choose to terminate the auction. The vendor may also set up the system that auction is terminated automatically as soon as the reserve price is met. If the bids do not meet the reserve price, (No, Step 630), then the system still accepts such bids from bidders (Step 632) in the system. If the bids are below the reserve price (Step 634), then the system will continue to accept bids from bidders. After the bids are accepted by the system (Step 636) until the auction ends (Step 660), the system processes all the bids to select the preliminary winning bid amount (Step 662). Notwithstanding the foregoing, the system is preferably configured to accept a plurality of bids above the reserve price before the end of the auction and selecting the winning bid.

In certain alternative embodiments, the system may be configured to allow a bidder to submit his or her own reserve price, independent of the vendor's reserve price, as a category two bidder. For example, in such embodiments, the bidder may place a sealed bid in an ascending sealed bid auction with a bidder reserve price. If the bidder's bid is identified as the winning bid, then if the subsequently calculated payment amount is above the bidder's reserve price, then the system may be configured to give the bidder the option to opt-out of the auction, to automatically force the bidder out of the auction, or to give the bidder the option to pay the calculated payment amount as the winning bidder. In such embodiments, if the bidder opts out or is automatically forced out based on predetermined rules, then a new winning bidder may be identified, and a new calculation may occur, based on the rankings of the bids without that bidder's bid. Similarly, in certain embodiments, a bidder may place a sealed bid in a reverse auction with a bidder reserve price (the lowest price at which the bidder is willing to provide the auction subject).

Referring now to FIG. 6C, after the bids are accepted by the system and the auction ends (Step 660), the system selects the preliminary winning bid amount (Step 662). The preliminary winning bid amount is subject to change (Step 664), as it may be adjusted depending on the self-determined bidding category. If the winning bidder is a bidding category one bidder (Step 666), then the vendor receives the full winning bid amount (Step 668) from the winning bidder and the auction is completed (Step 684). If the winning bidder is a bidding category two bidder (Step 670), then the system calculates the final price by using the price-protection formula (Step 672). In certain embodiments, the price-protection formula (Step 674) comprises a sum of a pre-determined portion of the price-protection fee (Step 676), a designated bid amount (e.g., a second-highest bid amount) (Step 678), and a pre-determined percentage of the difference between the winning bid amount and the designated (e.g., second-highest) bid amount (Step 680). Therefore, the vendor can net the sum of the above (Step 682) minus any portion of the price-protection fee which is distributed to anyone other than the vendor. After that the auction is completed (Step 684), the winning bidder pays either the final winning bid amount as a Category 1 bidder (plus any applicable additional costs, if any) or the Final Recalculated Amount as a Category 2 bidder (Step 686). The vendor delivers the auctioned subject (Step 688), and both parties may rate each other (Step 690).

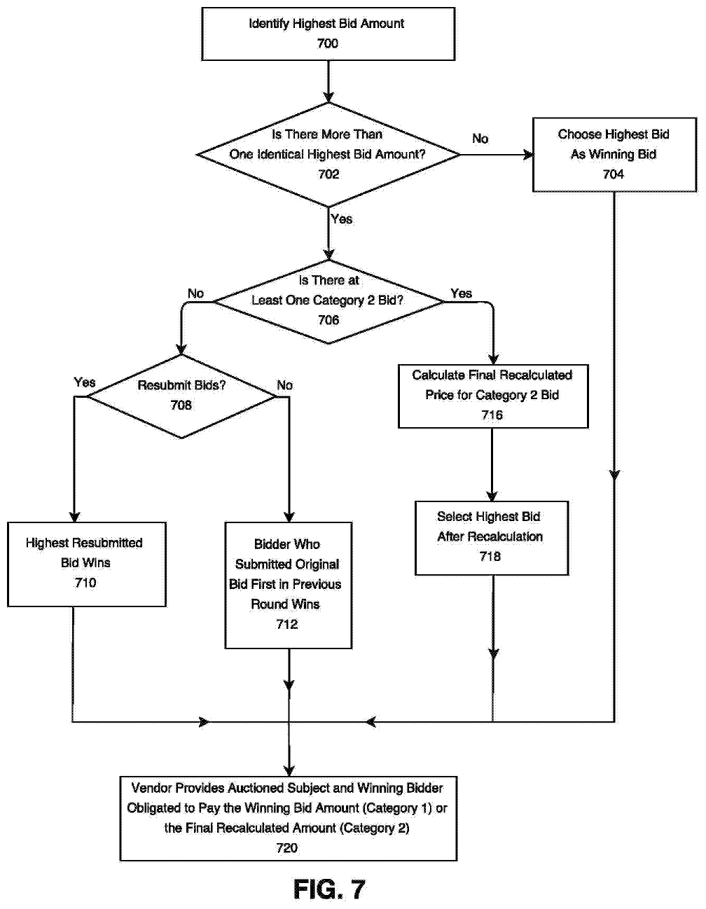

As shown in FIG. 7, after the auction ends, the system will determine the winning bidder with the highest bid amount (700). The system determines if there are identical bid amounts (702). If there are no identical bid amounts (No, Step 702), then the system chooses the highest bid (Step 704). If there are more than one identical bid amounts (Yes, Step 702), then the system determines whether there is at least one Category 2 bid (Step 706). If there is not at least one Category 2 bid (e.g., the identical highest bid amount is bid with only Category 1 Bids)(No, Step 706), then the system prompts the bidders to re-submit the bids (Step 708) within the pre-determined timeframe. If the bidders re-submit the bids (Yes, Step 708), then the highest re-submitted bid wins (Step 710). If the bidders do not re-submit the bids (No, Step 708) within a pre-determined timeframe, then the bidder who submitted original bid in the previous round first wins (Step 712). If the bidders with identical amounts include at least one Category 2 bidder (e.g., a Category 1 bidder and a Category 2 bidder both bid the highest bid amount) (Yes, Step 706), then the system calculates the final recalculated amount for the Category 2 bid (Step 716). The bidder whose bid is the highest winning amount depending on final calculation wins (Step 718). The winning bidder then pays the winning bid amount (if a Category 1 bidder is the winner) or the Final Recalculated Amount (if the Category 2 bidder is the winner) (Step 720).

The methods described herein are implemented through a computing device and/or computer system, generally comprised of a central processing unit (CPU) operatively connected to a memory device, data input and output circuitry (IO) and computer data network communication circuitry. Computer code executed by the CPU can take data received by the data communication circuitry and store it in the memory device. In addition, the CPU can take data from the I/O circuitry and store it in the memory device. Further, the CPU can take data from a memory device and output it through the IO circuitry or the data communication circuitry. The data stored in memory may be further recalled from the memory device, further processed or modified by the CPU in the manner described herein and restored in the same memory device or a different memory device operatively connected to the CPU including by means of the data network circuitry. The memory device can be any kind of data storage circuit or magnetic storage or optical device, including a hard disk, optical disk or solid-state memory. Examples of well-known computing systems, environments, and/or configurations that may be suitable for use with the invention include, but are not limited to, personal computers, server computers, hand-held, laptop or mobile computer or communications devices such as cell phones and PDA's, multiprocessor systems, microprocessor-based systems, set top boxes, programmable consumer electronics, network PCs, minicomputers, mainframe computers, distributed computing environments that include any of the above systems or devices, etc.

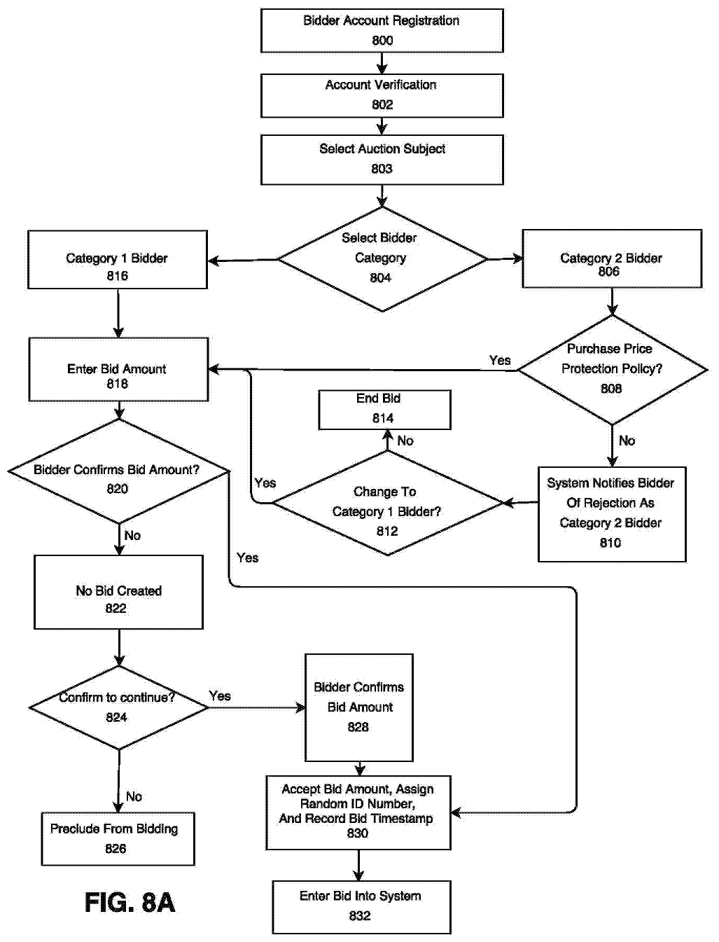

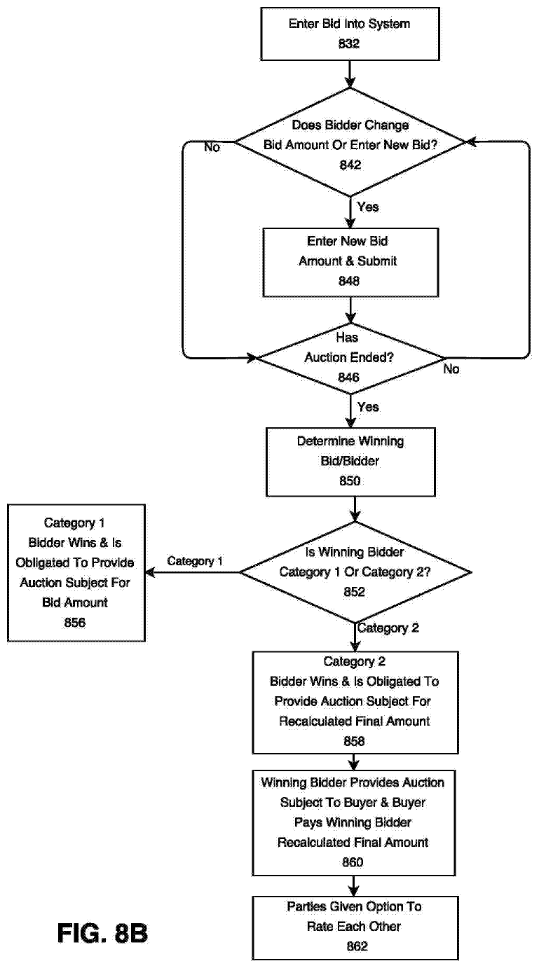

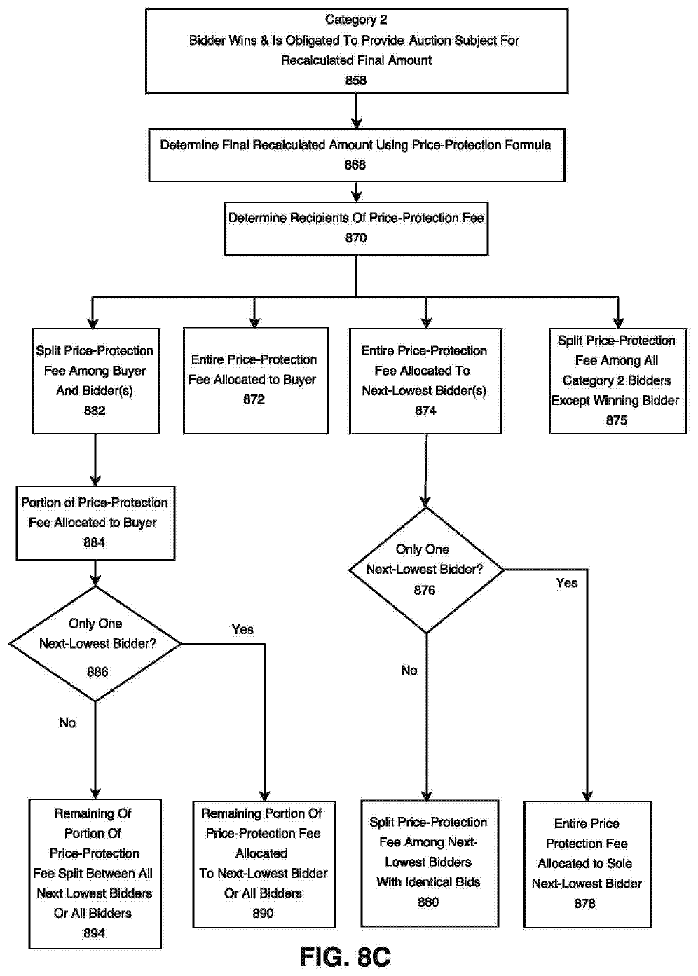

Referring next to FIG. 8A, shown is a flowchart depicting a bidding process in a reverse auction from the bidder's side, in accordance with an exemplary embodiment of the present invention. As shown, bidders initially register an account with the system (Step 800) that is verified (Step 802) before being permitted to submit bids for a reverse auction. Registering bidders may be required to sign or otherwise agree to one or more user agreements outlining relevant rules preset for both buyers and bidders prior to the start of the reverse auction. During registration, the systems disclosed herein can require that a user provide personally identifiable information and valid financial information, including, for example, name, address, email, phone number, bank information, etc. User accounts can be verified by the system through email, text, and/or phone by the system administrator. The systems disclosed herein may allow users to only register one account by email, text, and/or phone with a username for bidding or for listing a request for an auctioned subject/service. An account may be used to either bid on or list a reverse auction. The account may be used as a buyer account or a vendor account, and may be for an ascending sealed bid auction or a reverse sealed bid auction. The account may display different usernames or IDs for different types of auctions.

To begin an auction, registered bidders may select an auction subject (Step 803) to bid on, and choose a bidding category (Step 804). Preferably, the bidder is prompted to select a bidding category (e.g., Category 1 or Category 2) based on experience, preference, in consideration of a particular reverse auction strategy, or simply at random. A Category 1 winning bidder (Step 816) is required to offer the auction subject (i.e., the good/service) for a submitted sealed Category 1 bid amount, and is not associated with any commitment to pay a protection fee. A bidder who opts to be a Category 2 bidder (Step 806) is prompted to commit to paying a fee to purchase the price-protection policy should his/her bid be deemed the winning bid or pay a fee as a deposit from the bid account but then commit to pay the amount, which is sealed and kept confidential along with the deposit (Step 808). If such Category 2 bidder were to submit a winning bid, then he/she would have a chance of increasing the final winning bid amount to which he/she is entitled (e.g., to provide the auction subject to the buyer for a recalculated winning bid amount which is potentially higher than the winning bid amount submitted by the Category 2 bidder), and to potentially recover something simply for participating in the auction. The price-protection policy can correspond to a certain percentage, set by the buyer, the system or a non-auction participant, of the submitted bid amount (e.g., 3%, 5%, etc.). The bidder agrees to pay this price-protection percentage fee should he/she be the winning bidder in exchange for being allowed to participate as a Category 2 bidder. Alternatively, the bidder may be required to pay this fee regardless of whether or not he/she wins the auction.

If the bidder attempting to select Category 2 does not commit to pay a fee to purchase the price-protection policy, then the system will advise and/or notify the bidder that he/she will be rejected as a Category 2 bidder (Step 810), and/or provide the bidder with the option to be a Category 1 bidder (Step 812). If the bidder chooses to be a Category 1 bidder, then the bidder may begin to bid as a Category 1 bidder on the reverse auction by entering a bid amount to submit to the system (Step 818). If the bidder does not agree to be a Category 1 bidder, then the bidder is not permitted to bid in the reverse auction (Step 814). The system can be configured to choose the category for the bidder and/or to only allow a single category of bidders (e.g., Category 2 bidders).

As used herein, the term “winning bid amount” is an amount of the final bid submitted by a winning bidder of the auction. The term “recalculated winning bid amount” (i.e., “recalculated price,” “recalculated final price,” “recalculated amount,” “final recalculated amount,” etc.) is an amount calculated by applying a formula described herein to the winning bid amount. Also, the specific names assigned to these two bidding categories are for reference only and may alternatively be referred to as, for example, bidding categories A and B or “experienced” and “inexperienced” bidding categories. In preferred embodiments, the systems and methods disclosed herein can enable bidders to change the categories they belong to when bidding in the same or in different reverse auctions. A bidder who confirms he/she wants to be a Category 1 bidder when bidding to supply one auctioned subject may identify himself/herself as a Category 2 bidder during the reverse auction or when bidding to supply another auctioned subject in another reverse auction.

A bidder who initially opts (Step 804) to be a Category 1 bidder (Step 816) may begin bidding by entering a bid amount (Step 818). Similarly, a bidder who initially opts (Step 804) to be a Category 2 bidder (Step 806) and agrees to purchase the price-protection policy (Step 808) may begin bidding by entering a bid amount (Step 818). The bidder, regardless of whether a Category 1 or Category 2 bidder, then preferably provides double confirmation that the bid amount is accurate and confirm the bidder's ability to provide the auction subject for the amount of the bid (Step 820). If the bidder does not confirm either the bid amount or the ability to provide the auction subject for the amount of the bid (No, Step 820), then the bidder is notified by the system that no bid has been created or allowed (Step 822). The bidder may choose to change the bid amount and continue (Yes, Step 824) by confirming the bid amount and ability to provide the auction subject at the bid amount (Step 828). If the bidder still chooses to not confirm (No, Step 824), then the bidder is precluded from bidding (Step 826). If the bidder confirms (Step 828) or (Step 820), then the bid amount is accepted and the bidder is assigned a random ID number and the system records a timestamp for the bid (Step 830). The bid is then entered into the system and stored in the database (Step 832). It will be appreciated that a starting/reserve process may be optionally utilized in this reverse auction methodology, similar to that described above with respect to FIG. 5A.

While double confirmation is provided by the system to serve as a better practice purpose for the auction, an auction may still proceed without the double confirmation. Once the bid is double-confirmed and stored in the database of the system, the system can accept the submitted bid amount and enter it for the reverse auction within the bidding system (Step 832), and seal the bidder's ID. Bidders may be listed or displayed in the order in which they bid using randomly generated anonymous ID numbers by the system. The bidders' identities and respective bids and bid amounts are not accessible to other bidders (except for, potentially, the bidders' anonymous randomly generated ID numbers), even after the reverse auction closes. That is, the accepted bid amounts are sealed, and each bidder and bid amount is assigned a random identification number and identified with a timestamp to track status of the bid and indicate when it was accepted by the system (Step 830). Users may be allowed to see the applicable remaining time for the reverse auction regardless of where they are located. However, the system may enable the buyer to view the real identification of the winning bidder. In other embodiments, the system can be configured to allow all bidders to see the bid or amounts of other bidders after the auction ends with or without seeing the bidders' real identifications.

Turning now to FIG. 8B, shown is a flowchart depicting a continuation of the bidding process shown in FIG. 8A. As shown, after the bid has been entered into the system (Step 832), a bidder may change the submitted bid amount before the reverse auction closes or ends (Step 842). However, in preferred embodiments, every bidder is allowed to submit only one final valid bid. If the bidder does not change his/her submitted bid (No, Step 842), then the system determines the submitted bid to be the valid bid for that bidder. If the bidder decides to change his/her submitted bid (Yes, Step 842), then the bidder may enter a new bid amount, and submit it to the system (Step 848). In preferred embodiments, if a bidder submits a new bid or otherwise re-submits a bid, then any previously submitted bids by that bidder are replaced. In this manner, each bidder may only have one pending valid bid for an auction subject. In alternative embodiments, the system may determine only the most recent bid to be the valid bid, or may alternatively select the lowest bid to be the valid bid, depending on the predetermined rules for the auction. If the bidder does not change the bid again, then the system will determine the re-entered submitted bid to be the only valid bid by that bidder.

In alternative embodiments, the system may be configured to allow a bidder to change his/her bid by raising, lowering, re-submitting a bid, change a bidding category, and/or change a bid amount before the close of the reverse auction. Bidders may also be allowed to withdraw their bids before the reverse auction closes. Withdrawn and/or changed bids may still remain sealed so others will not be aware of them. By keeping withdrawn or changed bids confidential, the system can prevent bidders from using withdrawn and/or changed bids as reference points, and can eliminate or reduce misrepresentation or fraud. The system may continuously monitor the auction for any indications from bidder computing devices 106/110/112 that a bidder wants to change an existing bid (Step 842) up until the auction has closed or ended (Step 846). Upon expiration of the time-frame for the reverse auction, the reverse auction will close or end (Step 846).

The system can be configured using computer-executable instructions, such as program modules, to transmit a first representation of the anonymous, sealed bid online reverse auction to at least one of remote bidder computing devices 106/110/112 during the reverse auction. The first representation preferably does not include any bid amounts, but can include, for example, one or more different (or anonymous) identifiers relating to the status of the reverse auction (e.g., the randomly assigned ID numbers assigned to the bids/bidders, the number thereof, the timing thereof, and/or the time remaining in the reverse auction, etc.). Receipt of the first representation by the remote bidder computing devices may trigger or cause them to display at least a portion of the information related to the first representation.

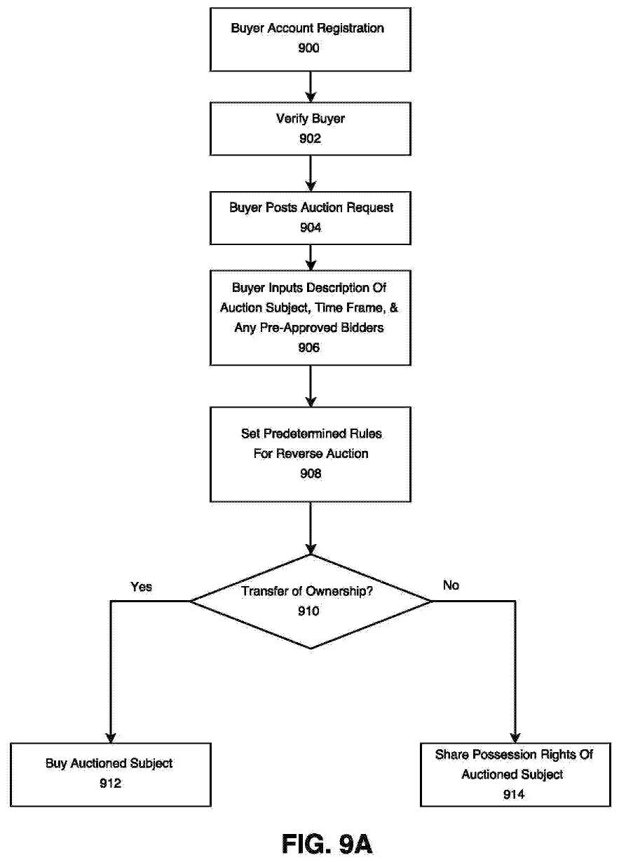

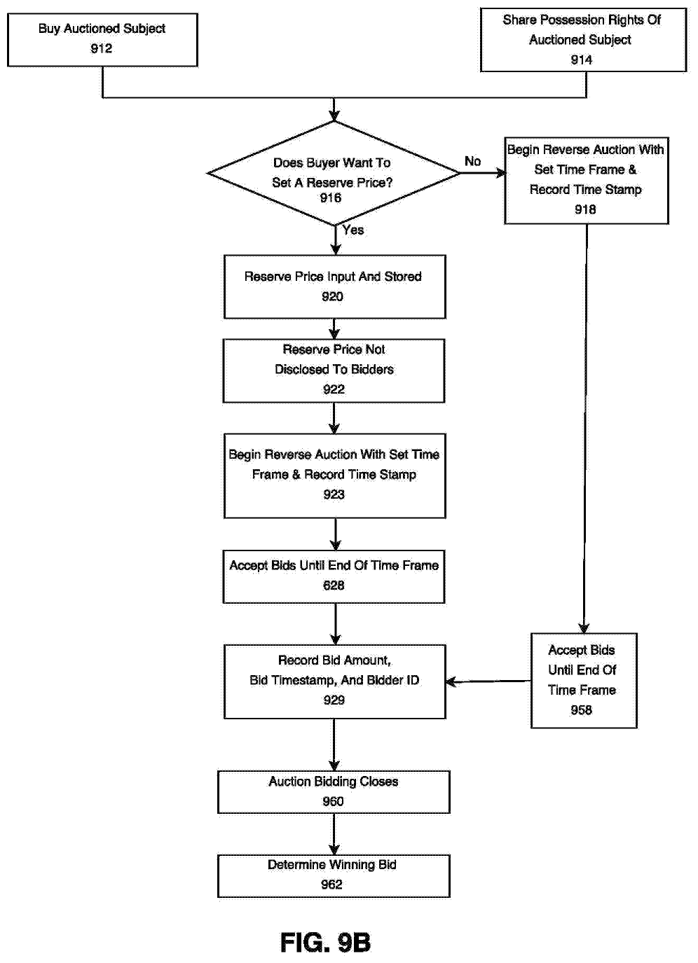

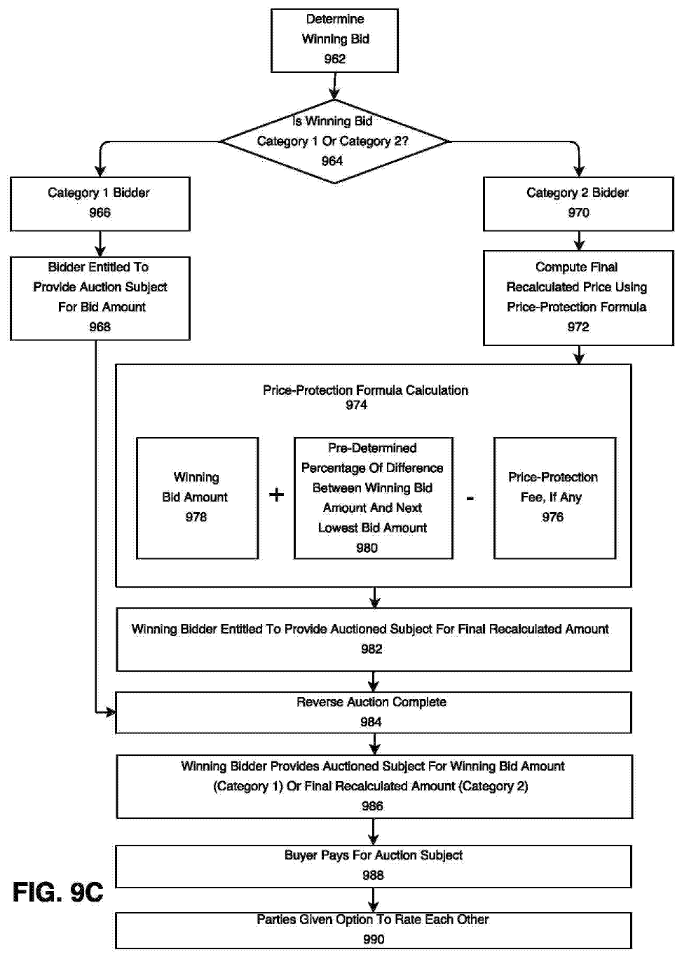

Once the reverse auction closes, the system determines a winning bid amount based on predetermined rules for the auction (Step 850), and the bid amounts may be disclosed to the participants of the reverse auction. The bid amounts may alternatively not be disclosed except for the winning bid amount to the buyer. The system next determines whether and which bidder wins the reverse auction (Step 852). If the bidder wins the reverse auction and is a Category 1 bidder (Step 852, Category 1,), then the winning bidder will be obligated to and agrees to provide the auction subject to the buyer for the bid amount submitted (Step 856). If the bidder wins the reverse auction and is a Category 2 bidder (Step 852, Category 2,), then the winning bidder will be obligated to and agrees to provide the auction subject to the buyer for a recalculated final price that is determined after applying a price-protection formula, plus related costs, if any (Step 858), as further discussed below with respect to FIG. 9C. The system may be configured to require a transaction to take place between the buyer and the winning bidder-seller within a certain amount of time (e.g., within ten days of the end of the reverse auction).

After a winning Category 2 bidder provides the auctioned subject to the buyer, the buyer pays the winning bidder a final recalculated winning bid amount (Step 860). The buyer may be obligated to pay the winning bidder before the winning bidder provides the auctioned subject. In other embodiments, the buyer may be obligated to pay the winning bidder only after receipt of the auctioned subject. Payment may be exchanged in part or in full during these transactions depending on specific agreements of the parties, the particular reverse auction, and/or user agreements. Once the auctioned subject has been received and payment has been made, the parties may be provided with the option to rate one another (Step 862) through the system, and such ratings may be stored in database 104. The process concludes once ratings are received or after the parties decline to rate one another.

The system can also be configured using computer-executable instructions, such as program modules, to transmit a second representation of the anonymous, sealed bid online reverse auction, either at a later point in the auction or once all bids are received and the auction ends, to one or more of the bidder computing devices 106/110/112. The second representation can include at least a winning bid amount associated with a winning bidding Category 2 bidder corresponding to an assigned identifier. Receipt of the second representation by the remote computing devices can trigger or cause at least one of the remote computing devices to display at least a portion of the information related to this second representation. The second representation may additionally or alternatively include one or more of the different identifiers relating to a second (e.g., later or end) status of the reverse auction, the randomly assigned ID numbers assigned to the bids/bidders, the number thereof, the timing thereof, etc. The information or image data relating to the first or second representations may be displayed using bitmap representation, or any other known technique for displaying image data.

FIG. 8C shows a flowchart depicting an example process of distribution of a price-protection fee in accordance with an exemplary reverse auction embodiment of the present invention. As illustrated, the price-protection fee paid by a Category 2 bidder may be split or allocated in various ways. If a Category 2 bidder wins the reverse auction, then the winning bidder will be obligated to and agrees to provide the auction subject (e.g., the good, service or both) to the buyer for a final recalculated price (Step 858), and the final recalculated price is determined by applying the price-protection formula (Step 868). In preferred exemplary embodiments, the price-protection formula subtracts the price-protection fee from the sum of the winning bid and a predetermined percentage of the difference between the winning bid and the next-lowest bid (Step 868) to compute a final recalculated winning bid amount, as discussed below with respect to FIG. 9C. Alternatively, any other designated bid based on buyer presets, default system settings, or a non-auction participant, may be used in calculating the difference (e.g., not just the next-lowest bid, the third, fourth, fifth, etc. lowest bid with respect to the winning bid). In other embodiments, the price-protection formula does not include subtracting the price-protection fee, and comprises the sum of the winning bid and the predetermined percentage of the difference between the winning bid and the next-lowest bid. The price-protection fee may be a predetermined percentage of the winning bid amount, and once the winning bid has been selected and the final recalculated price calculated, the system may determines the recipients of the price-protection fee paid by the winning Category 2 bidder (Step 870).

The system, the buyer, or a non-auction participant may establish one or more sets of predetermined rules for allocating the price-protection fee submitted by a winning bidder. The buyer or the system can pre-set whatever rule he/she wishes with respect to allocation and distribution of the price-protection fee(s), including but not limited to, any one of the auction participants. For example, rules may be established dictating that the entire price-protection fee may be allocated entirely to the buyer (Step 872), entirely to the next-lowest bidder or bidders (Step 874), among all Category 2 bidders except the winning bidder (Step 875), the buyer and bidder(s) (Step 882), the system, the buyer, the winning bidder, and the losing bidders, whether they be Category 1 or Category 2 bidders. For example, the buyer may decide that he/she does not want to allocate any of the price-protection fee to the highest bidder, and wishes to allocate all of it to, for example, the second or third lowest bidder. The system can also determine the number of next-lowest bidders to whom the price-protection fee should be paid. If there is only one next-lowest bidder (Yes, Step 876), then the entire amount of the price-protection fee may be allocated to the sole next-lowest bidder (Step 878). If there are several next-lowest bidders (e.g., if two or more Category 2 bidders bid an equal amount and the equal amount is the next-lowest amount relative to the winning bid) (No, Step 876), then the entire amount of the price-protection fee can be split among all of the next-lowest bidders with identical bids, by an allocation percentage which may be predetermined by the buyer, the system or a non-auction participant (Step 880).

Alternatively, the price-protection fee paid by the winning bidder may be split, such as equally, in whole or in part, among all Category 2 bidders who did not win the reverse auction (Step 875). In yet other embodiments, the price-protection fee may be entirely or partially allocated to the system or a non-auction participant where the system may be the entity who developed, hosted, or otherwise provided a software application for the online reverse auction. Also, the non-auction participant may include the managing company or agent of the system, or may further include a representative of a buyer, representative of a seller, website manager, auction housing company, outside investors of the auction site, or others having vested interests in the auction. In such embodiments, the system or non-auction participant may collect all or a portion of the price-protection fee from a given auction.

In another embodiment, the price-protection fee can be split between the buyer and bidder(s) (Step 882) by an allocation percentage which may be predetermined (e.g., by the buyer, the system, or a non-auction participant). For example, one portion of the price-protection fee may be allocated to the buyer (Step 884), while the remaining portion of the price-protection fee may be allocated to the next-lowest bidder (Step 890) if there is only one next-lowest bidder (Yes, Step 886). Where there is no second-lowest bidder because only a single bidder bid on the reverse auction, then the buyer may keep all of the price-protection fee paid by the single bidder, or may give back part or all of it to the single bidder. If there are multiple next lowest bidders with identical bids, then the price-protection fee can be split among all of the next lowest bidders (Step 894), or may be split among all of the remaining bidders who did not win. The allocation of the price-protection fee may be customizable by the buyer, the system, the seller, or a non-auction participant based on predetermined rules.

Turning next to FIG. 9A, illustrated is a flowchart depicting a bidding process from the buyer's side in accordance with an exemplary embodiment of the invention. As shown, buyers may register an account with the system (Step 900). Before setting up the details of the reverse auction, the buyer may be subject to account verification (Step 902), which may include background check, credit history check, review of auction history, reference check, double confirmation that he/she can and will make proper payment upon receipt of the goods/services desired, etc. After verification by the system is complete, the buyer may post a reverse auction request (Step 904). When beginning the process of setting up a reverse auction, the buyer may be prompted to input a description/introduction of the auction subject with a written description, photos, videos, etc., explaining the (good(s) and/or service(s) sought), the desired time-frame for the reverse auction (e.g., from start to end), whether there are any pre-approved bidders, etc. (Step 906). This description/introduction may include any requirements, preferences, and/or conditions precedent to service the buyer has regarding the auction subject, such as, for example, the time-frame needed for delivery and/or completion of the good(s) and/or service(s), the total number of products or services requested, the quality needed (e.g., specifying any applicable standards or reference materials in a particular industry pertaining to quality, referring to exemplary photographs, dimensions, etc.). The buyer may also indicate any requirements of the bidders themselves and who is qualified to bid. Such requirements may include, for example, fluency in a particular language, prior experience level, equipment requirements, licenses, skill level, citizenship, geographic location, etc. The system may be configured to enable questions and answers between a buyer and bidders before the reverse auction starts, and may make such questions and answers public to all auction participants via the computing devices. The buyer should provide any auction subject details needed to clarify or avoid confusion as to the requirements of the auction subject. The system can allow the buyer to preset the timeframe for the reverse auction and track the reverse auction until the end or close thereof.

The buyer can then establish predetermined rules for the auction, such as, for example, the price-protection fee, the predetermined percentage, setting a reserve price, deciding who will receive the price-protection fee, etc. (Step 908). The buyer can also specify whether the reverse auction will involve a good/service that will involve one or more transfers of ownership (Step 910). If the reverse auction will involve a transfer of ownership (Yes, Step 910), then the buyer intends to buy rather than share possession rights of the auctioned subject (Step 912). If the reverse auction does not involve a transfer of ownership (No, Step 910), then the buyer intends to share possession rights for the auctioned subject for a specified period of time (Step 914).

As shown in FIG. 9B, once the buyer decides whether the auction subject will involve a transfer of ownership (Steps 910, 912, 914), the buyer may be prompted to set up a reserve price (Step 916). The reserve price is preferably the maximum amount that the buyer is willing to pay for the auction subject. In one embodiment, the reserve price is preset by the buyer and is not disclosed to any potential or actual bidders. In other embodiments, the reserve price may be disclosed to bidders before, during, or after the end of the reverse auction. The reserve price is set by the buyer at his/her discretion. In preferred embodiments, if the final amount of the winning bid.

The reserve price is preferably a maximum price, hidden (or closed) from bidders, representing the most a buyer is willing to pay for an auctioned good/service (i.e., an auction subject). In a reserve price reverse auction, the buyer is only obligated to buy the good/service if the winning bid amount is at or below the reserve price. It will be appreciated that a downside of a hidden reserve price is that a failed reverse auction may occur more frequently because the bidder-sellers may bid too high relative to the reserve price. Setting a hidden reserve price is preferably at the buyer's discretion, but may be automatically preset by the system by, for example, determining automatically a fair market value for the good/service being sought. In these embodiments, the bidders are not aware of the maximum amount a buyer is willing to pay for the auction subject. Such embodiments can offer a bottom up bidding approach in that they encourage bidders to bid up from a start auction price irrespective of the hidden reserve price meaning that the bidding amount can be higher or lower than the reserve price. In alternative embodiments, the reserve price may be conditionally hidden at the buyer's discretion. A conditional hidden reserve price auction as contemplated herein is one in which the system allows the buyer to optionally terminate the reverse auction early as soon as at least one bid is at or below the reserve price. The system can alternatively allow the bids to be accepted by a buyer even if they are not equal to or below the conditional hidden reserve price set by the buyer.

Alternatively, a buyer may choose to use an open reserve price, which is a reserve price that is visible to the bidders during the reverse auction. In these embodiments, the bidders are aware of the maximum amount a buyer is willing to pay for the auction subject and offers a top down bidding approach in that it requires the bidders to bid down from the known reserve price, or to not participate in the auction at all. Such an open reserve auction may benefit savvy bidders in situations where a less savvy buyer sets a reserve price much higher than a market value for a particular good/service. Therefore, it will be appreciated that having an open versus hidden reserve auction has both pros and cons to the buyer and bidders. While having an open reserve auction will likely ensure that an auction does not fail even if there is only one bidder, it leaves open the possibility for savvy bidders to take advantage of less savvy buyers. For the bidders, an open reserve auction it enables them to offer bids that they know will be at an amount that the buyer may accept. It is also contemplated that the system may allow the bids to be accepted even if they are above the hidden reserve price set by the buyer.

In preferred embodiments, the reserve price is not used for recalculation, even if only a single bid is received below it. For example, if the winning bid is below the reserve price and the next lowest bid is above the reserve price, then the recalculation is preferably still based on the winning bid and the next lowest bid. However, the reserve price may be used as the next lowest bid for recalculation purposes if the winning bid is below it and no other bids are received which are greater than the winning bid.

The buyer may also be prompted to input a start price for the auction. The start price is a pre-set amount which serves as a means for getting the reverse auction bidding started. It is open to (or visible by) the bidder-sellers, and may represent a maximum amount the buyer is willing to pay for the auctioned subject. A nominal price may be used as the start price to begin the bidding at an auction. As the buyer desires a low price, the start price might not have any relationship at all to the buyer's actual perceived value of the auction subject, and the winning bid may be above, below, or equal to the start price.

If the buyer chooses not to set up a reserve price (No, Step 916), then he/she may be prompted to set up the time-frame for the reverse auction, including the start time and the end time and any other parameters for the auction (Step 918). The system can record a timestamp for the reverse auction listing with the unique index number to identify different listings. Once the time-frame begins, the system then accepts bids (Step 958) until the timeframe ends and the reverse auction closes (Step 960). The system records timestamps for bids received during the auction time-frame (Step 929). Once the reverse auction closes, the system processes all of the accepted bids, the auction ends (Step 960), and the system determines the winning bid (Step 962).

If the buyer does set up a reserve price (Yes, Step 916), then the buyer may be prompted to input a reserve price that is stored in the database (Step 920), which, in preferred embodiments, the reserve amount is not disclosed to bidders even though the bidders are made aware of the existence of a hidden reserve price at the beginning of the auction in order to avoid any confusion (Step 922). The system then begins the reverse auction with a set time-frame and records a time stamp for the auction beginning (Step 923), starts accepting bids from bidders (Step 928), and records timestamps for bids received during the auction time-frame (Step 929). Before the reverse auction request is officially listed in the online auction platform, the system can issue an index number for each listed reverse auction request or auctioned subject, and can issue or record a timestamp corresponding to the start time of the reverse auction. If at the close of the auction the reserve price is exceeded by all of the bids, then the reverse auction is subject to potential termination depending on terms preset by the buyer. The system continues to accept bids from bidders until the reverse auction closes or ends (Step 960). Once the reverse auction closes, the system processes all of the bids received to select or determine the winning bid (Step 962), and checks to see if the winning bids exceed the reserve price.

As shown in FIG. 9C, once bids have been accepted by the system and the auction closes or ends (Step 960, FIG. 9B), the system selects or determines the winning bid (Step 962). The winning bid selected in the reverse auction will preferably be the lowest bid received, but can be preset by the buyer in advance of the auction in the form of a ranking (e.g., the winning bid may be set as the second lowest bid, or the third lowest bid, and so on). The system, buyer, or a non-auction participant may establish, before a start of the auction and based on a set of predetermined rules, a ranking corresponding to which bid of the sealed bids will be selected as the winning bid (i.e., the winning bid will correspond to the lowest bid, the second lowest bid, the third lowest bid, the fourth lowest bid, the fifth lowest bid, or any other designated ranking). For example, the buyer may want a bid other than the lowest bid to win, and can indicate this in the auction request he/she submits to the system. As discussed above, the winning bid is subject to change depending on whether it is a Category 1 bid or a Category 2 bid. Therefore, the system determines whether the winning bid is a Category 1 or Category 2 bid (Step 964). If the winning bid is a Category 1 bid (Step 966), then the bidder-seller is entitled to provide the auction subject to the buyer for the winning bid amount (Step 968) and the reverse auction is completed (Step 984). In other embodiments, the ranking corresponding to which bid of the one or more sealed bids is selected as the winning bid can be established by the system by default.

If the winning bidder is determined to be a Category 2 bidder (Step 964, 970), then the system computes the final recalculated price using the price-protection formula (Step 972). The price-protection formula calculation (Step 974) is performed by subtracting the price-protection fee (Step 976) from the sum of (i) the lowest bid amount (assuming the lowest bid is the rank preset to be the winning bid in the reverse auction) (the Winning Bid) (Step 978) and (ii) a predetermined percentage of the difference between the winning bid amount and the next-lowest bid amount (Step 980). The price-protection fee in a preferred embodiment is a percentage of the winning bid amount. In this manner, the winning Category 2 bidder-seller will be entitled to provide the auction subject for an amount equal to the sum of his/her lowest winning bid and a percentage of the difference between his/her lowest winning bid and the next lowest bid, less a percentage of his/her lowest winning bid (Step 982).

Once the reverse auction is complete (Step 984), the winning Category 2 bidder provides the auction subject for the winning bid amount (if the winner is a Category 1 bidder-seller) or for the final recalculated amount (if the winner is a Category 2 bidder seller) with or without applicable additional costs, if any (Step 986). The buyer then pays for the auctioned subject (Step 988), which can be done before or after the bidder-seller provides the auction subject. Optionally, both parties can then rate one another (Step 990) and the overall transaction ends.

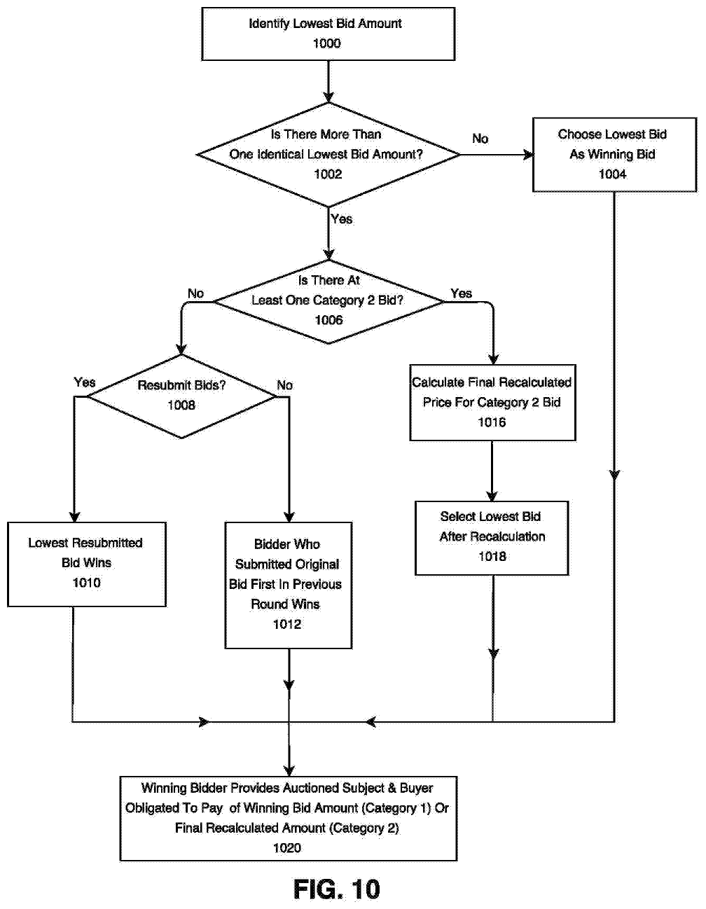

In a reverse auction, it is possible for there to be more than one identical winning bids at the close of the reverse auction. Referring to FIG. 10, shown is a flowchart depicting a process of determining the final winning bidder when there are more than one identical lowest winning bids from more than one bidder in the same or different categories. As shown, in a preferred embodiment, after the reverse auction closes, the system identifies the lowest bid amount (Step 1000), and determines whether there are more than one identical bid at this lowest bid amount (Step 1002). If there are no identical lowest bid amounts (No, Step 1002), then the system chooses the lowest bid as the winning bid (Step 1004). However, if the buyer desires a different ranking to be the winning bid in advance of the reverse auction (e.g., second lowest, third lowest, etc.), then he/she can input this setting in advance of the reverse auction, and the system can select the appropriate winning bid.

If there are two or more identical bids for the winning bid amount (Yes, Step 1002), then the system can determine whether at least one of the two or more identical bids for the winning bid amount is a Category 2 bid (Step 1006). If, for example, two or more identical bids for the lowest bid amount are from bidders of same category (Yes, Step 1006) or remain the same bid amount after recalculation, then the system can prompt the bidders to re-submit the bids (Step 1008) within a predetermined timeframe. If the bidders re-submit bids (Yes, Step 1008), then the lowest re-submitted bid wins the reverse auction (Step 1010). If the bidders re-submit identical bids again, the process can repeat itself until it determines a lowest re-submitted bid. Alternatively, the system may determine a maximum number of re-submissions allowed before canceling the auction or determining the first bidder to have submitted the initial bid to be the winning bid.

If the bidders choose not to re-submit the bids (No, Step 1008) within the predetermined timeframe, then the bidder who was first to submit the original bid in the previous round first wins (Step 1012). If the bids for identical amounts are in different categories (No, Step 1006), then the system can calculate a final recalculated price (Step 1016) for the Category 2 bid(s). In this embodiment, the bidder whose bid is the lowest following all final recalculations wins the reverse auction (Step 1018). In an alternative embodiment, a comparison between a final recalculated price of a potential winning Category 2 bid and a lowest one of the Category 1 bids may be made to determine a final winning bid. Once the winning bid, and by extension, the winning bidder, are selected, the winning bidder can provide the auction subject to the buyer, and the buyer is obligated to pay the winning bidder the final amount of the winning bid (Step 1020). The Category 1 bids do not undergo recalculation.

In yet another exemplary embodiment of the invention, a sealed bid online auction or reverse auction may be provided whereby the seller (the provider of an auction subject in an ascending sealed bid online auction) or the buyer (the requester of an auction subject in a reverse sealed bid online auction) are provided with an option to create and maintain a favorite's list and/or a blacklist of potential auction participants. A “favorite list” is a list of individuals or group of individuals with who a positive relationship has been established. The term “favorite” as used herein is meant to be broadly construed, and refers to anyone who is prioritized in the offering of an auction subject through an auction. It will be understood by one skilled in the art that the concept of a “favorite list” may alternatively be referenced as, for example, a“friend,” a “top”, a “priority”, or any other word used in auctions to define the concept of such list. Regardless of specific terminology, the intention as a top priority is to denote the concept of a positive buyer-seller relationship in an auction environment. In contrast to “favorite”, a “blacklist” as used herein refers to lists which can prevent an individual or group of individuals from access to an auction house or an auction subject in the future. It will be appreciated by one skilled in the art that other terms may be used to describe this concept, such as, for example, “block list,” “ban list,” “dislike list,” or the like. Regardless of specific terminology, the intention is to denote the concept of an individual or group of individuals from participating in an auction or from accessing an auction site or auction for a specific auction subject.

The blacklist and favorite list features may enable an auction host to make the auction subject open to or blocked from one or more people or groups of people based on categories, locations, names, regions, geolocation, etc. When an auction host indicates that he/she wants to add a user or a group of users his/her blacklist, the system may prompt the auction host to input reason(s). It will be appreciated that precluding blacklisted users may improve the efficiency of the auction and may minimize the occurrence of indecent bidding activities. It will also be appreciated that the blacklists will function as incentive tools for users to not engage in indecent bidding activity or else risk losing the opportunity to participate in future auctions. Also, an auction host may refer a user from his/her favorite list to another auction host. Database 104 may contain several data categories or groupings of blacklist or favorite list information relating to specific individuals, groups of individuals, locations such as streets, zip codes, town, city, borough, county, state, or any other region defining feature, or to names, or to any other defining characteristic.

A user may make additions to the favorite list and/or the blacklist after hosting or participating in an auction. For example, the auction host may be queried as to whether he/she was satisfied with the user. If the auction host was not happy with the user, then the auction host can add the user to the auction host's blacklist, in which case the user will be precluded from accessing the auction or auction subject in the future. If the auction host is satisfied with the user, then the auction host can ask the user to authorize addition of the user to the auction host's favorite list. In such embodiments, it may be up to the user to decide whether or not to accept this request. If the user denies the request, then the user is not added to the favorite list. If the user accepts this request, then he/she is added to the favorite list. The auction host may be queried about his/her satisfaction with a user at the end of each auction. If the auction host is not satisfied with the user, then he/she may choose to remove the user from the favorite list. Alternatively, the auction host may set predetermined parameters for identifying whether or not a particular user or group of users should be on the favorite list.

Auction hosts may also refer users from their blacklist to other auction hosts. Referring auction hosts can refer individual users, groups of users, or entire lists of blacklisted users to one or several other auction hosts. Auction hosts can also refer users from their favorite list to other auction hosts. Referring auction hosts can refer individual users, groups of users or entire favorite lists to one or several other auction hosts. An auction host may include one or more preset reasons or a note describing why he/she is referring the favorite user or users. The system may preclude a particular blacklisted bidder from viewing, gaining access to, or submitting a bid for the auction subject responsive to (i) the host requesting the particular bidder be placed on a host blacklist (ii) the particular bidder requesting the host be placed on a particular bidder blacklist, or (iii) at least one attribute pre-set by the host. The preset attribute may be a location of a respective remote computing device associated with a respective bidder. The location of the respective remote computing device may be verified using GPS technology.

The system may be configured to give auction hosts the option of adding users to their preset blacklists. Once a user has been added to the blacklist, the user is precluded from bidding on an auction subject, or may be precluded from even viewing an auction subject available in an auction, or may even be precluded from access to an entire auction site when searching for an auction subject. In order to avoid confrontation, the system can be configured such that it will not allow a blacklisted user to gain access to a certain auction or auction site, or merely not enable such user to bid on an auction subject. When a user is blacklisted, this precludes the same blacklisted user from being added to the favorite list. In other words, a blacklisted user cannot simultaneously be on both a blacklist and favorites list of an auction host. The “blacklist” is preferably essentially for “difficult” users who may have engaged in indecent bidding activities. However, it will be appreciated that a user can be blacklisted for any reason.

In yet another exemplary embodiment of the invention, one or more price evaluations of the auction subject may be employed. Any user of the system may serve as a price evaluator by offering a fair and reasonable valuation, either through submission of an actual bid with reasons why the bid is for the fair and reasonable value of the auction subject, or by offering the reasons without submitting an actual bid. Expert price evaluators may also be utilized who have, for example, certifications in a field, subject matter, or many years of experience appraising certain goods or services. As consideration for such user and/or expert evaluations, the system may use a portion of the price-protection fee or funds from another source to pay, after the close of an auction, the evaluator whose evaluation was closest to the winning bid, or was cited as the reason for the submission of the bid that became the winning bid, or both. During the online auction, all bidders may be able to view the evaluation of the auction subject and or reasons for the evaluation. In other embodiments, the bidders may not view the evaluation.

Users evaluating auction subjects may be assigned ratings or rankings to indicate the credibility of their evaluations. These rankings may be the result of crowdsourced and/or individual feedback relating to the specific evaluations. Feedback from users may include positive, neutral, or negative feedback. Positive and negative feedback may be provided in the form of preset positive/negative reasons, respectively, based on evaluation of an evaluator's evaluation of an auction subject. The evaluation may be provided either by anyone, including auction participants and non-participant alike. Neutral feedback or no feedback may not affect a credit score or ranking of an evaluator. Alternatively, negative feedback may be provided by preset negative reasons to rate an evaluator anonymously or openly. Notifications may be provided to an evaluator a certain time after any negative feedback is provided to inform them that they received negative feedback and/or why.

Based on the negative feedback, an evaluator's credit score or ranking may be decreased. Based on positive feedback, an evaluator's ranking may be increased. User's offering crowdsourced feedback may be rewarded (e.g., with credits) to build up their own credibility regarding the rating of information provided by evaluators. Such credits may be based on the number of times correct and accurate feedback is provided, the number of times the user offers feedback, the number of times the user submits actual bids, may be limited to a certain period of time, and the like.

The system may provide a rating system to give evaluators an incentive to offer credible information, including value, about an auction subject. Therefore, reported information may be subject to review and/or rating by the system administrator or other uses. The rating system may be implemented to rate all comments, suggestions, and other thoughts that users input into the system. The rating system may list comments from top to bottom according to their number of ratings from most positive to most negative. The user may be allowed to report to the system administrator any potentially inaccurate information with applicable proof to provide an explanation of the inaccuracies. In response, the system administrator may open a case requesting an employee and/or user to investigate the purported inaccurate information to verify the quality of the information reported. A reward may be provided for the user who may have assisted in the investigation.

The system may utilize an incentivizing method for information reporting since database 104 incorporates at least a method of crowdsourcing data from one or more users. Crowdsourcing relies on the participation of many people who are incentivized for participation. Basically, a user who posts and shares information about an evaluator or evaluator's postings may gain credits from the system, and with a predetermined threshold number of ratings the user may earn one or more rewards. With this method, a user may be rewarded based upon the user's proactive effort to report inaccurate information with efficiency, helpfulness, and accuracy. The system administrator may set the type and/or amount of the reward according to the amount of positive ratings received. The rewards may encourage users to inform the system about inaccurate or even fraudulent bidding activities in an online auction. A user who actively participates to supply crowdsourced information may consent to waive any reward expectations. Incentives help obtain both active participation from one or more users and accurate and truthful information for the auction. Active participation is important because statistical analysis depends upon a large group of data and it is important to continuously obtain real-time or close to real-time data of current situations especially from users who are privy to certain information relating to a specific auction subject.

Reported information may be subject to a review and/or rating by the system administrator and other users to provide a notification. The rating system may be implemented to rate all evaluation relevant data including, but not limited to, reasons for cited value of the auction subject, specific details relating to the auction subject, other thoughts or comments that users have relating to the auction subject, etc. The rating system may list comments from top to bottom according to their number of ratings from most positive to most negative. The reasons and or recommendations with the most positive ratings may be listed and displayed at the top for other users to view. These reasons may also be incorporated into notifications used to alert other users of the system. The user may be allowed to report to the system administrator any potentially inaccurate information with applicable proof to provide an explanation of the inaccuracies.

Ratings may continue to be collected until the ratings reach a predetermined number, which may be for negative ratings or for positive ratings. If the ratings (positive or negative) reach such a predetermined number, then database 104 may be modified or updated to reflect the valid information in the submission. If the predetermined number is not reached, the system may continue collecting ratings from users. Optionally, the predetermined number of ratings can either be a fixed number (e.g., 10, 25, or 35 ratings or submissions, etc.), or it may be based on a percentage of the total number of ratings (e.g., 25%, 10%, or 1%). The predetermined numbers may also be different based on the auction subject value, the number of auction participants, the number of evaluators, etc. For example, a higher volume of auction participants may mean a higher number of users sharing and rating the evaluation information. It is possible that once a user submission reaches a predetermined number of positive ratings, the user responsible for that submission may receive a reward. Alternatively, to better assure that the submitted data is indeed correct, the system may allow for the notification containing the data submitted by the user to be rated further before the reward is being issued.

Next, the user may rate the evaluation negatively (i.e., that the reasons and/or recommendations conveyed by such evaluation were inaccurate, fraudulent, etc., either in part or in whole). In this case, the user may provide new reasons and/or recommendations along with any proof of that evaluation's inaccuracy. The user may submit a negative rating to such evaluation because the reasons cited by the evaluator are in fact different from those substantiated by other evidence. The new reasons and/or recommendations are then subject to ratings by additional users, and the process continues. The system may also collect and/or sort the negative ratings. Once the number of such negative ratings reaches a predetermined number, information from that evaluation may be removed in part or in whole depending on whether only part of or the whole evaluation was rated negatively the predetermined number of times. Once the new reasons and/or recommendations submitted by the user reach a predetermined number of positive ratings, the data in the database may be updated, corrected, supplemented, or otherwise modified. If the number of negative ratings for an evaluation does not reach a predetermined number, the system may continue to collect and/or sort the negative ratings. All information provided by users may be subject to further ratings in order to determine what is accurate or inaccurate.

The system may offer a clickable icon (e.g., a check-mark for a positive rating or an “X” for a negative rating) to the user to indicate a positive or negative rating. Other symbols or words may also be used. In instances where the system might not have information about (or the reasons for) a certain evaluation, a user may be provided with an option to submit a portion or all of the missing information. This option may be in the form of an icon capable of suggesting or otherwise leading a user to a place to enter any missing information about a given location. The user may then be redirected to a ratings page in order to rate such evaluation as accurate or inaccurate, or may indicate that a portion of the information included in the notification might be inaccurate. Alternatively, for reasons of safety, the user may be sent, for example, an email having a link to the ratings page so that the user can rate the evaluation at some later time. After clicking on such an icon, the user may then be taken to a different display to enter, for example, a reason for the evaluation if he/she has information pertaining to such evaluation. If the user would like to submit information, the user might select one or more reasons from reasons drop-down menu, or enter one or more reasons in a free-text field. The reasons provided by users, if they reach a certain predetermined number of positive ratings, might dynamically update, correct, supplement, or otherwise modify database 104 accordingly.

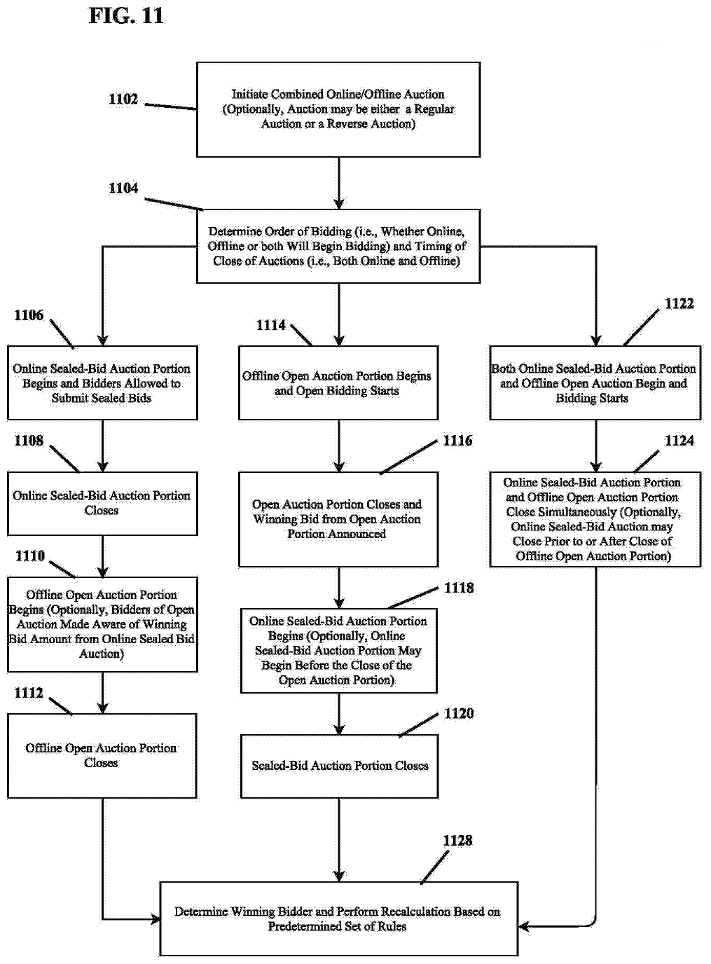

Yet another embodiment of the invention, as depicted in FIG. 11, provides for an auction platform that allows a combined offline (i.e., live) open auction and online sealed bid auction in order to further aid in minimizing or eliminating fraudulent bidding practices or any other type of behavior where a bidder may attempt to take advantage of the system. This system and method may also be used for reverse auctions. Preferably, the online sealed bid auction will utilize the online auction platform whereas the offline open auction can be held live on-site. Preferably, the seller (or buyer in a reverse auction) will specify which auction combination (e.g., either or both) he/she wishes to use before the beginning of the auction, and the format will be disclosed to all potential bidders. In such a combined auction, both the online and offline formats may be completed for the auction subject in order for the overall auction to close and a winning bidder to be determined.

In a preferred embodiment, the sealed bid online auction for an auction subject occurs first, followed by a live open auction for the same auction subject. In the first part of the auction, bidders offer their bids in a sealed bid format where the bidders' bid amounts are hidden from all others. After the specified online auction time has ended, the online sealed bid auction closes and no further sealed bids are taken.

Next, upon close of the online auction, a live or on-site auction for the same auction subject proceeds. Without knowing the bids from the online auction, bidders participate in a live open auction with each bidder attempting to outbid the existing open high bid by bidding a higher amount. During this phase of the auction, all bids are open to all bidders. Upon close of the live open auction (i.e., at the discretion of the auctioneer), the overall auction for the auction subject is deemed complete and the highest bids from each of the online and live auctions are compared to determine the winning bidder based on predetermined rules. Preferably, the highest bid amount among the two auctions is determined. Optionally, the sealed bid online part of the auction may overlap or be simultaneous with the live open part of the auction.

Alternatively, the offline (or live) open auction for an auction subject occurs first, followed by a sealed bid online auction for the same auction subject. In the first part of the auction, bidders participate in a live open auction with each bidder attempting to outbid the existing open high bid by bidding a higher amount. During this phase of the auction, all bids are open to all bidders. Upon close of the live open auction (i.e., at the discretion of the auctioneer), a tentative winner is decided by the last highest bidder. Next, a sealed bid online auction for the same auction subject proceeds, where bidders, having already known the highest bid amount that the live open auction ended on, offer their bids in a sealed bid format where the bidders' bid amounts are hidden from all others. After the specified online auction time has ended, the online sealed bid auction closes and no further sealed bids are taken. Upon close of the sealed bid online auction, the overall auction for the auction subject is deemed complete and the highest bids from the each of the online and live auctions are compared to determine the winning bidder based on predetermined rules. Preferably, the highest bid amount among the two auctions. Of course, it will be appreciated that any number of auction closing times may be used in accordance with the present invention (i.e., offline auction closes first, online auction closes first, both auctions close at the same time (either randomly, or at a predetermined time), both auctions close at the discretion of the auction host or auctioneer, etc.).

Referring specifically to FIG. 11, shown are alternate embodiments of a system and method for a combined online/offline auction in accordance with the present invention. The combined offline/online auction is preferably initiated as an online sealed bid auction followed by an offline open auction. In this embodiment, as illustrated in FIG. 11, the combined online/offline auction, which optionally may be either regular or ascending sealed bid auction or a reverse auction, is initiated by the auction host (i.e., either a buyer or a seller of an auction subject) (Step 1102). The auction host then determines the order in which the bidding will take place (i.e., whether online or offline bidding will begin first or whether both will begin at the same time) and the timing of the close of the auction portions (i.e., both online and offline) (Step 1104). Once the rules have been established, in a first embodiment, the online ascending sealed bid auction portion begins and online bidders are allowed to submit their sealed bids (Step 1106). At the designated closing time, the online ascending sealed bid auction portion closes (Step 1108). Next, the offline open auction portion begins (Step 1110). Optionally, the bidders of the offline open auction may or may not be made aware of the winning bid amount from the online sealed bid auction. Once there are no further offline bidders, the offline open auction portion closes (Step 1112), and the system determines a winning bidder and performs a recalculation of the winning bid amount using one or more formulas disclosed herein, based on a predetermined set of rules established by the auction host (Step 1128).

In a second embodiment of a combined online/offline auction, the combined live and online auctions may comprise an offline open bid auction followed by an online sealed bid auction. Again, the combined online/offline auction (either a regular ascending sealed bid auction or a reverse auction) is initiated by the auction host (Step 1102), who will then determine the order in which the bidding will take place (here, offline bidding begins first) as well as the timing of the close of the auction portions (Step 1104). In this embodiment, the offline open auction portion begins and open bidding starts (Step 1114). Once there are no further offline bidders, the offline open auction portion closes and the winning bid from the open auction portion is announced (Step 1116). The online sealed bid auction portion then begins (Step 1118). Optionally, the online sealed bid auction portion may begin before the close of the open auction portion. At the designated closing time the online sealed bid auction portion closes. (Step 1120). The system then determines a winning bidder using one or more formulas disclosed herein, based on a predetermined set of rules established by the auction host (Step 1128).

In a third embodiment of a combined online/offline auction, the combined online and offline auctions run simultaneously. Again, the combined online/offline auction (either a regular auction or a reverse auction) is initiated by the auction host (Step 1102), who will then determine the order in which the bidding will take place (here, that the offline bidding will begin first) as well as determine the timing of the close of the auction portions (Step 1104). In this embodiment, the online and offline open auction portions both begin and the open and sealed bidding starts (Step 1122). Once there are no further offline bidders, the offline open auction portion closes and according to preset rules the online sealed bid auction portion preferably also closes (Step 1124). Optionally, the preset rules may be such that the online sealed bid auction may close a predetermined time prior to or after the close of the offline open auction portion, or may close at the discretion of the auctioneer. The system then determines a winning bidder based on one or more formulas disclosed herein in accordance with a predetermined set of rules established by the auction host (Step 1128). It will be appreciated that in the embodiments of FIG. 11, recalculation of the winning bid amount may occur prior to step 1128 depending on alternative predetermined rules.

In certain embodiments, the reserve price may be set by the vendor or generated from the first part/portion of a combined auction. For example, in a combined auction (e.g., offline open bid then offline sealed bid, offline sealed bid then online open bid, or sealed bid online then sealed bid offline), the winning bid for the first portion of the combined auction may be used as the reserve price for the next portion of the combined auction. The bidder whose winning bid is used to set the reserve price for the next portion of the auction may be identified as a non-final winner or conditional winner (e.g., the winner if no other bidder beats the conditional winner's bid or recalculated payment amount in subsequent portion(s) of the combined auction. Such embodiments may be used for combined auction portions which comprise ascending online sealed bid or sealed bid online reverse auctions as described herein. Upon a close of the online auction portion, a live or on-site auction for the same auction subject may start. Upon a close of the combined auction, the bidder with the highest bid or the bidder with the predetermined designated winning rank (e.g., considering bids from both portions of the auction) may then be identified as the winner in the ascending sealed bid auction. Conversely, the lowest bidder or the bidder with the predetermined designated winning rank may be declared the winner in the reverse auction. In certain embodiments the reserve price resulting from the first portion of the combined auction may be communicated to the bidders. In other embodiments, the resulting reserve price may be hidden from every bidder, or may be hidden from every bidder except the bidder whose bid was used to determine it.

In the combined online/offline/sealed/open auction embodiments described herein, the fee may be allocated in any of the ways described above. It will be appreciated that multiple auction portions may run in series (e.g., one after the other), simultaneously, or staggered, and that any number of auction portions may be utilized. The results from all portions of the auction may be compared to determine the winning bidder based on predetermined rules. In the example above, the highest price from the offline open auction may be compared with the final price recalculated based on one of the 12 equations discussed above for the sealed bid ascending auction which follows it. The higher price may be deemed the final price of the auction subject for the combined auction.

In certain embodiments, when two portions of the combined auction occur simultaneously, the auction ending time may be set at a certain time, or there may be no predetermined ending time (e.g., the auction may end when the vendor decides to end it and/or if a reserve price is reached). Optionally, portions of the combined auction may repeat or alternate several times for one auction subject until the bidders do not wish to continue anymore. In other embodiments of combined auctions, the bidders may be given the option to quit the auction anytime during a sealed bid portion, or if they are not the highest bid at the end of a sealed bid portion prior to a new auction portion. In the embodiments discussed above with respect to the combined live and sealed bid auctions, both Category 1 and Category 2 bidders may be allowed to participate. Additionally, the same rules for Category 2 bidders in a regular ascending sealed bid auction also apply in the combination of auctions. That is, all submitted bids from Category 1 and Category 2 bidders are collected before they can be compared, and if a Category 2 bid is the winning bid, it will undergo the recalculation to compute the final price using one of the price-protection formulas discussed herein. Alternatively, once the recalculated amount has been determined for the Category 2 bidder, a winner is decided by comparing the recalculated amount with the highest Category 1 bid to determine the highest winning bid amount. Additionally, in certain embodiments, bidders in the open auction may be precluded from knowing which, if any, open auction participants also participated in the sealed bid portion of the auction. It will be appreciated that all embodiments described herein may be realized with a single category (e.g., Category 2 as described herein) without traditional Category 1 bidding.

Computer program logic implementing all or part of the functionality previously described herein may be embodied in various forms, including, but in no way limited to, a source code form, a computer executable form, and various intermediate forms (e.g., forms generated by an assembler, compiler, linker, or locator.) Source code may include a series of computer program instructions implemented in any of various programming languages (e.g., an object code, an assembly language, or a high-level language such as FORTRAN, C, C++, JAVA, or HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The invention may be described in the general context of computer-executable instructions, such as program modules, being executed by a computer. Generally, program modules include routines, programs, objects, components, data structures, etc., that perform particular tasks or implement particular abstract data types. The computer program and data may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed hard disk), an optical memory device (e.g., a CD-ROM or DVD), a PC card (e.g., PCMCIA card), or other memory device. The computer program and data may be fixed in any form in a signal that is transmittable to a computer using any of various communication technologies, including, but in no way limited to, analog technologies, digital technologies, optical technologies, wireless technologies, networking technologies, and internet technologies. The computer program and data may be distributed in any form as a removable storage medium with accompanying printed or electronic documentation (e.g., shrink wrapped software or a magnetic tape), preloaded with a computer system (e.g., on system ROM or fixed disk), or distributed from a server or electronic bulletin board over the communication system (e.g., the Internet or World Wide Web.) It is appreciated that any of the software components of the present invention may, if desired, be implemented in ROM (read-only memory) form. The software components may, generally, be implemented in hardware, if desired, using conventional techniques.

The invention may also be practiced in distributed computing environments where tasks are performed by remote processing devices that are linked through a communications network. In a distributed computing environment, program modules may be located in both local and remote computer storage media including memory storage devices. Practitioners of ordinary skill will recognize that the invention may be executed on one or more computer processors that are linked using a data network, including, for example, the Internet. In another embodiment, different steps of the process can be executed by one or more computers and storage devices geographically separated by connected by a data network in a manner so that they operate together to execute the process steps. In one embodiment, a user's computer can run an application that causes the user's computer to transmit a stream of one or more data packets across a data network to a second computer, referred to here as a server. The server, in turn, may be connected to one or more mass data storage devices where the database is stored.

The server can execute a program that receives the transmitted packet and interpret the transmitted data packets in order to extract database query information. The server can then execute the remaining steps of the invention by means of accessing the mass storage devices to derive the desired result of the query. Alternatively, the server can transmit the query information to another computer that is connected to the mass storage devices, and that computer can execute the invention to derive the desired result. The result can then be transmitted back to the user's computer by means of another stream of one or more data packets appropriately addressed to the user's computer.

Exemplary embodiments of the present invention may be also applicable in live auctions where sealed bids may be used in both online and live auctions to maximize the benefits for bidders and vendors. In live auctions, people are physically present or bid by proxy through phone call systems; the auctioneer and/or other related personnel may conduct the process of auctioning a property of value and the bidders may actively participate in bidding. Bidders in a live sealed bid auction may self-determine within two different categories, for example a bidding category one or a bidding category two bidder, prior to submitting their sealed bids. Bidders who are self-determined to be bidding category two bidders may commit to purchase the price-protection policy by submitting a check or paying a deposit in a sealed manner, for example, in a sealed envelope. The bidders would be required to submit their sealed bids through a machine that would automatically or manually assign each bidder a random ID number and a clock machine may issue a timestamp. The bidding category would be recorded together with the sealed bid amounts before the submission of the envelopes to the place designated by the vendors or auctioneer's, such as the envelope deposit box. The relevant rules in a live sealed bid auction may be preset for both vendors and bidders prior to the start of the auction.

The described embodiments of the invention are intended to be exemplary and numerous variations and modifications will be apparent to those skilled in the art. All such variations and modifications are intended to be within the scope of the present invention as defined in the appended claims. Although the present invention has been described and illustrated in detail, it is to be clearly understood that the same is by way of illustration and example only, and is not to be taken by way of limitation. It is appreciated that various features of the invention which are, for clarity, described in the context of separate embodiments may also be provided in combination in a single embodiment. Conversely, various features of the invention which are, for brevity, described in the context of a single embodiment may also be provided separately or in any suitable combination. It is appreciated that the particular embodiment described in the specification is intended only to provide an extremely detailed disclosure of the present invention and is not intended to be limiting. Modifications of the above disclosed apparatus and methods which fall within the scope of the invention will be readily apparent to those of ordinary skill in the art. Accordingly, while the present invention has been disclosed in connection with exemplary embodiments thereof, it should be understood that other embodiments may fall within the spirit and scope of the invention, as defined by the following claims.

What is claimed is:

1. A computer-implemented system for conducting a combined auction including a sealed bid online auction and an open bid offline auction performed in an electronic platform, the system comprising:
an auction server in communication with one or more remote computing devices associated with one or more remote bidders via a network, to one or more remote bidder computing devices associated with one or more bidders for a combined auction subject of the sealed bid online auction, wherein the server includes at least one non-transitory computer-readable storage medium with computer-readable instructions stored therein to remotely perform the sealed bid online auction based on one or more sets of predetermined rules, a database, and a processor for executing said computer-readable instructions to:
list the auction subject in the combined auction:
receive, from a plurality of bidders via a plurality of remote bidder computing devices, one or more sealed bids for one or more corresponding bid amounts respectively relating to the auction subject of the sealed bid online auction;
receive one or more open bid amounts relating to the auction subject from one or more additional bidders in the open bid offline auction;
assign a different identifier to each of the one or more bids;
receive one or more sets of commitment data, wherein each set of commitment data comprises a commitment to pay a committed amount for adjusting at least a part of a winning payment amount upon winning the auction;
transmit, during the auction, to the plurality of the remote bidder computing devices, a first representation of the auction including each different identifier, wherein at least one of the plurality remote bidder computing devices displays at least a portion of the first representation;
identify a winning bid amount and a second-rank bid amount next to the winning bid amount from the auction;
calculate the winning payment amount based on at least the winning bid amount and an adjustment amount, wherein the adjustment amount is computed based on at least a portion of the winning bid and the second-rank bid amount; and
transmit, upon a close of the sealed bid online auction, to at least a bidder computing device associated with the plurality of remote bidder computing devices, a second representation of the auction,
wherein the second representation includes at least a portion of the winning payment amount or winning bid amount.

2. The system according to claim 1, wherein the processor is further configured to:
determine, upon the close of the sealed bid online auction and a close of the open bid offline auction, the winning bid amount and the second-rank bid amount from the one or more sealed bids or the one or more open bids based on the one or more sets of predetermined rules.

3. The system according to claim 1, wherein the processor is further configured to:
receive all of the one or more sealed bids prior to receiving any of the one or more open bids;
receive all of the one or more open bids prior to receiving any of the one or more sealed bids; or
receive both the one or more sealed bids and the one or more open bids during a particular timeframe.

4. The system according to claim 1, wherein the processor is further configured to:
recognize, for each of the one of more bidders, only one valid bid corresponding to one bid amount in the sealed bid online auction for determining the winning bid amount or the second-rank bid amount.

5. The system according to claim 1, wherein the processor is further configured to:
identify the winning bid from sealed bid auction or from open bid offline auction, or identify the second-rank bid from sealed bid auction or open bid offline auction.

6. The system according to claim 1, wherein the winning payment amount is calculated based on a sum of the winning bid amount and a pre-determinate percentage of a difference between at least the winning bid amount and the second-rank bid amount based on the one or more set of the predetermined rules.

7. The system according to claim 6, wherein the winning bid amount is calculated by additionally subtracting or adding at least a portion of the committed amount to the sum based on the one or more set of the predetermined rules.

8. The system according to claim 1, wherein each set of bid data is accepted or rejected by the server according to one or more preset rules; and responsive to a set of bid data being rejected, not storing the set of rejected bid data in the server; or responsive to a set of bid data being accepted, storing the accepted set of bid data in the server.

9. The system according to claim 1, wherein at least a portion of the commitment amount is allocated to at least one of participants of the auction.

10. The system according to claim 1, wherein the processor is further configured to:
display at least the portion of the first representation related to the winning payment amount, wherein the winning payment amount is higher or lower than the winning bid amount.

11. A computer implemented method for conducting a combined auction including a sealed bid online auction and an open bid offline auction, the method comprising:
listing a combined auction subject in the combined auction;
receiving, by a server, from a plurality of bidders via a plurality of remote bidder computing devices, one or more sealed bids for one or more corresponding bid amounts respectively relating to the auction subject of the sealed bid online auction, through an auction platform;
receiving, by the server, one or more open bid amounts relating to the auction subject from one or more additional bidders in the open bid offline auction;
assigning, by the server, a different identifier to each of the one or more bids;
receiving, by the server, one or more sets of commitment data, wherein each set of commitment data comprises a commitment to pay a committed amount for adjusting at least a part of a winning payment amount upon winning the auction:
transmitting, during the sealed bid online auction, to the plurality of the remote bidder computing devices, a first representation of the sealed bid online auction including each different identifier, wherein at least one of the pluralities of remote bidder computing devices displays at least a portion of the first representation;
identifying, by the server, a winning bid amount and a second-rank bid amount next to the winning bid amount;
calculating, by the server, the winning payment amount based on at least the winning bid amount and an adjustment amount, wherein the adjustment amount is computed based on at least a portion of the winning bid amount, the second-rank bid amount and the committed amount; and
transmitting, by the server, upon a close of the sealed bid online auction, to at least a bidder computing device associated with the plurality of remote bidder computing devices, a second representation of the sealed bid online auction, the second representation includes at least a portion of the winning payment amount or winning bid amount.

12. The method according to claim 11, further comprising:
determining, upon a close of the sealed bid online auction and a close of the open bid offline auction, a winning bid from the one or more sealed bids or the one or more open bids based on the one or more sets of predetermined rules.

13. The method according to claim 11, further comprising one of:
receiving all of the one or more sealed bids prior to receiving any of the one or more open bids;
receiving all of the one or more open bids prior to receiving any of the one or more sealed bids;
or receiving both the one or more sealed bids and the one or more open bids during a particular timeframe.

14. The method according to claim 11, further comprising:
recognizing, for each of the one of more bidders, only one valid bid corresponding to one bid amount in the sealed bid online auction for determining the winning bid amount and second-rank bid amount.

15. The method according to claim 11, further comprising.
identifying the winning bid from sealed bid auction or from open bid offline auction, or identifying the second-rank bid from sealed bid auction or open bid offline auction.

16. The method according to claim 11, wherein the winning payment amount is calculated based on a sum of the winning bid amount and a pre-determinate percentage of a difference between at least the winning bid amount and the second-rank bid amount based on the one or more set of the predetermined rules.

17. The method according to claim 16, wherein the winning bid amount is calculated by additionally subtracting or adding at least a portion of the committed amount to the sum based on the one or more set of the predetermined rules.

18. The method according to claim 11, wherein each set of bid data is accepted or rejected by the server according to one or more preset rules; and responsive to a set of bid data being rejected, not storing the set of rejected bid data in the server; or responsive to a set of bid data being accepted, storing the accepted set of bid data in the server.

19. The method according to claim 11, wherein at least a portion of the commitment amount is allocated to at least one of participants of the auction.

20. The method according to claim 11, further comprising:
displaying at least the portion of the first representation related to the winning payment amount, wherein the winning payment amount is higher or lower than the winning bid amount.
